SEQUENCE LISTING (124 sequences)

SEQ ID NO: 1 - DNA, 285 bp, artificial sequence
  chemically synthesized
gagtctagagccaccatggagacagacacactcctgctatgggtactgctgctctgggttccaggttccactggtgactatgaggcccaggcggccggtaccgctagcggccaggccggccgcaatgctgtgggccaggacacgcaggaggtcatcgtggtgccacactccttgccctttaaggtggtggtgatctcagccatcctggccctggtggtgctcaccatcatctcccttatcatcctcatcatgctttggcagaagaagccacgttaggggcccgag

SEQ ID NO: 2 - protein, 339 aa, artificial sequence [sequence omitted]

SEQ ID NO: 3 - protein, 335 aa, artificial sequence
  chemically synthesized
METDTLLLWVLLLWVPGSTGDYEAQAAELVLTQPPSVSGAPGQRVTISCTGSSSNIGAGYDVHWYQQLPGTAPQLLIYGNINRPSGVPDRSSGSKSGTSASLAITGLRAEDEVDYYCQSYDRTLSGVIFGGGTQLTVLGGGSSRSSSSGGGGSGGGGQITLKESGGGVVQPGSSRTLSCEASGFSFSTYWMTWVRQAPGKGLEWVANIKQDGSEKYYVDSVKGRFTISRDNAKNSLYLQMNSLRAEDTAVYYCSRGFFYWGQGALVTVSSASTKGPSVTSGQAGRNAVGQDTQEVIVVPHSLPFKVVVISAILALVVLTIISLIILIMLWQKKPR

SEQ ID NO: 4 - protein, 349 aa, artificial sequence
  chemically synthesized
METDTLLLWVLLLWVPGSTGDYEAQAAELPSQSPSVSGSPGQSITISCTGTSSDFGGYKFVSWYQQHPGKAPKLIIFDVSRRPAGVSNRFSGSKSGNTASLTISGLQADDEAEYYCSSYKSGTTLYVFGTGTELTVLGGGSSRSSSSGGGGSGGGGEVQLVQSGPGLLKPSETLSLTCSVSGGSVASSSYYWSWIRQSPRKGLEWIGHIFYSGAAKYSPSLRSRATISVDTSRNQFNLKLSSVTAADTATYYCARDAHLIVVPIAGALGAFDVWGQGTVVAVSSASTKGPSVTSGQAGRNAVGQDTQEVIVVPHSLPFKVVVISAILALVVLTIISLIILIMLWQKKPR

SEQ ID NO: 5 - protein, 349 aa, artificial sequence
  chemically synthesized
METDTLLLWVLLLWVPGSTGDYEAQAAELLLTQPPSVSGAPGQRATISCTGSSSNIGAGYGVQWYQQLPGTAPKLLIFGNNNRPSGVPARFSASKSGTSASLTITGLQAEDEADYYCRSYRSGVSLSVFGTGTKLTVLGGGSSRSSSSGGGGSGGGGQVQLVQSGPGLVKPSETLSLTCSVSGGSVSDASYCWTWIRQPPGKGLEWIGHTIYSGKTSYNPSLKSRVAISLDTSQNHFSLRLTSVTAADTAVYYCARGACYRSNWYPLKHFFDYWGQGALVAVSSASTKGPSVTSGQAGRNAVGQDTQEVIVVPHSLPFKVVVISAILALVVLTIISLIILIMLWQKKPR

SEQ ID NO: 6 - protein, 199 aa, artificial sequence
  chemically synthesized
METDTLLLWVLLLWVPGSTGDYEAQAAELTLTQSPATLSVSPGESATLSCRASQSVRRNLAWYQQRPGQAPRLLIYGATTRATGVPVRISGSGSGTEFTLTISSLQSEDFVVYYCQQYNDWPGTFGQGTKVDIKGGSSRSSSSGGGGSGGGGEVQLVESGPGLVKPSGTLSLTCAVSGVSITSSNWWSWVRQPPGKGPE

SEQ ID NO: 7 - protein, 347 aa, artificial sequence
  chemically synthesized
METDTLLLWVLLLWVPGSTGDYEAQAAELQMTQSPSTLSASVGDRVTITCRASQGISSYLVWYQQKPGKAPKLLIYDSSTLQSGVPSRFSGSGSGTDFTLTISSLQPEDVAAYFCQQVYSYPRTFGQGTKVDIKGGSSRSSSSGGGGSGGGGQITLKESGGGLVKPGGSLRLSCVASGLSFKDAWMSWVRQAPGKGLEWVGRMKSRASGGTTEYGGLANGRFTISRDDSKNTLFLQINRLETEDTAVYYCTFAFCSGTSCYGQYTYYGLDVWGQGTTVIVSSASTKGPSVTSGQAGRNAVGQDTQEVIVVPHSLPFKVVVISAILALVVLTIISLIILIMLWQKKPR

SEQ ID NO: 8 - protein, 348 aa, artificial sequence
  chemically synthesized
METDTLLLWVLLLWVPGSTGDYEAQAAELGLTQPPSVSGAPGQRVTISCTGSSSNIGRFDVHWYQQLPGTAPKLLIYGNTNRPSGVPDRFSGSKSGSSASLAITGLQAEDEADYYCQSYDRSLSGVVFGGGTQLTVLGGGSSRSSSSGGGGSGGGGEVQLLESGPGLVKPSETLSLTCTVSGGSISSGNYYWSWIRQTPEKGLEWLGYVHYTGSSKLNPSLKSRVTISVDTYTNQFSLSLSSMTAADTAVYYCARGKNCANDICYIGSWFDPWGQGTLVTVSSASTKGPSVTSGQAGRNAVGQDTQEVIVVPHSLPFKVVVISAILALVVLTIISLIILIMLWQKKPR

SEQ ID NO: 9 - protein, 344 aa, artificial sequence
  chemically synthesized
METDTLLLWVLLLWVPGSTGDYEAQAAELVMTQSPSSLSASVGDRVTITCRASQGVSRALAWYQQKPGNPPKLLIYDASNLQSGVPSRFSGGGSGTEFILTISSLQPEDFATYYCQQYNAYPWTFGQGTKLEIKGGSSRSSSSGGGGSGGGGQVQLQESGPGLVKPSETLSLTCTVSGGSISSGNYYWSWIRQTPEKGLEWLGYVHYTGSSKLNPSLKSRVTISVDTYTNQFSLSLSSMTAADTAVYYCARGKNCANDICYIGSWFDPWGQGTLVTVSSASTKGPSVTSGQAGRNAVGQDTQEVIVVPHSLPFKVVVISAILALVVLTIISLIILIMLWQKKPR

SEQ ID NO: 10 - protein, 349 aa, artificial sequence
  chemically synthesized
METDTLLLWVLLLWVPGSTGDYEAQAAELVLTQPPSVSGAPGQRVTISCTGTSSNIGAGYAVHWYQQVPGTAPKLLIFGKTNRPSGVPGRFSGSKAGTSASLAITGLQPEDEAHYYCQSYDSNLSEVVFGGGTQLTVLGGGSSRSSSSGGGGSGGGGEVQLVQSGPGLVKPSETLSLTCTVSGGSISSGNYYWSWIRQTPEKGLEWLGYVHYTGSSKLNPSLKSRVTISVDTYTNQFSLSLSSMTAADTAVYYCARGKNCANDICYIGSWFDPWGQGTLVTVSSASTKGPSVTSGQAGRNAVGQDTQEVIVVPHSLPFKVVVISAILALVVLTIISLIILIMLWQKKPR

SEQ ID NO: 11 - protein, 347 aa, artificial sequence
  chemically synthesized
METDTLLLWVLLLWVPGSTGDYEAQAAELVLTQPPSVSGAPGQRVSISCTGSSSNIGARYDVHWYQQLPGTAPKLLIYGNTNRPSGVPDRFSGSKSGSSASLAITGLQAEDEADYYCQSYDRSLSGVVFGGGTKLTVLGGGSSRSSSSGGGGSGGGGEVQLVQSGPGLVKPSETLSLTCTVSGGSISSTSYSWGWIRQPPGKGLEWIATVSYSGRSYSNPSLKSRVTTSVDTSKNQFSLRLGSVTAADTAVYYCARLYYIWRSYHSGRFDYWGQGTLVPVSSASTKGPSVTSGQAGRNAVGQDTQEVIVVPHSLPFKVVVISAILALVVLTIISLIILIMLWQKKPR

SEQ ID NO: 12 - protein, 348 aa, artificial sequence
  chemically synthesized
METDTLLLWVLLLWVPGSTGDYEAQAAELVLTQPPSVSGLPGQSVTVSCTGTSSDVSHSNYVSWYQQLPGKAPKLIIYDVTKRPSGVPNRFSGSKSGNTASLTISGLQTEDEADYHCCSYAGGYTWVFGGGTQLTVLGGGSSRSSSSGGGGSGGGGEVQLVESGPGLVKPSETLSLTCTVSGGSISSGNYYWSWIRQTPEKGLEWLGYVHYTGSSKLNPSLKSRVTISVDTYTNQFSLSLSSMTAADTAVYYCARGKNCANDICYIGSWFDPWGQGTLVTVSSASTKGPSVTSGQAGRNAVGQDTQEVIVVPHSLPFKVVVISAILALVVLTIISLIILIMLWQKKPR

SEQ ID NO: 13 - protein, 349 aa, artificial sequence
  chemically synthesized
METDTLLLWVLLLWVPGSTGDYEAQAAELVLTQPPSMSGAPGQRVSISCTGSSSNIGARYDVHWYQQLPGTAPKLLIYGNTNRPSGVPDRFSGSKSGSSASLAITGLQAEDEADYYCQSYDRSLSGVVFGGGTKLTVLGGGSSRSSSSGGGGSGGGGQITLKESGPGLVKPSETLSLTCTVSGGFISSSSYYWGWIRQPPGKGLEWIGSSYYGGSTNYNPSLKSRVTILVDRSKNQFSLKLSSVTAADTAVYYCARSTVAVVSMAGPSGWFDPWGQGIMVTVSSASTKGPSVTSGQAGRNAVGQDTQEVIVVPHSLPFKVVVISAILALVVLTIISLIILIMLWQKKPR

SEQ ID NO: 14 - protein, 346 aa, artificial sequence
  chemically synthesized
METDTLLLWVLLLWVPGSTGDYEAQAAELVVTQEPSVSGAPGQSVTISCTGGSSNIGASYDVHWYKQLPGAAPILLIYANYIRPSGVPDRFSASKSGTSASLAITGLQAEDEADYYCQSYDSSLSGVVFGGGTKLTVLGGGSSRSSSSGGGGSGGGGQVQLQESGGGWVQSGGSLRLSCAASGFSFSSYAMSWVRQAPGKGLEWVSAMSPIGGSTFYADSVKGRFTISRDNSKNTLFLQMNSLRAEDTAVYYCAKDAVVTAVGLGRYFDLWGRGTLVSVSSASTKGPSVTSGQAGRNAVGQDTQEVIVVPHSLPFKVVVISAILALVVLTIISLIILIMLWQKKPR

SEQ ID NO: 15 - protein, 342 aa, artificial sequence
  chemically synthesized
METDTLLLWVLLLWVPGSTGDYEAQAAELTLTQSPSSLSASVGDRVILTCRAGQSISNYVNWYQQRPGKAPNLLIYGASSLQPGVPSRFSGSGSGTDFTLTISGLQPEDFAVYYCQQTYSTPRTFGQGTRLEIKGGSSRSSSSGGGGSGGGGEVQLVQSGPGLVKPSGTLSLTCAVSGVSITSSNWWSWVRQPPGKGPEWIGEVFHSGSINYNPSLKSRVTISVDKSKNQFSLRLNSVTAADTAVYYCAREFAGLIPHYYSYGMDVWGQGTTVTVSSASTKGPSVTSGQAGRNAVGQDTQEVIVVPHSLPFKVVVISAILALVVLTIISLIILIMLWQKKPR

SEQ ID NO: 16 - protein, 347 aa, artificial sequence
  chemically synthesized
METDTLLLWVLLLWVPGSTGDYEAQAAELELTQPPSVSGAPGQRVSISCTGSSSNIGARYDVHWYQQLPGTAPKLLIYGNTNRPSGVPDRFSGSKSGSSASLAITGLQAEDEADYYCQSYDRSLSGVVFGGGTKVTVLGGGSSRSSSSGGGGSGGGGQITLKESGPGLVRPSETLSLTCSVSGGSIDSTSYSWGWIRQPPGKGLEWIASIHYKGRTQYNPSLKSRLTISVDPSRSQFSLRLSSVTAADTAVYYCARLYYIWGSYQSGRFDYWGQGSLVTVSSASTKGPSVTSGQAGRNAVGQDTQEVIVVPHSLPFKVVVISAILALVVLTIISLIILIMLWQKKPR

SEQ ID NO: 17 - protein, 350 aa, artificial sequence
  chemically synthesized
METDTLLLWVLLLWVPGSTGDYEAQAAELELTQPPSVSGAPGQRVTISCTGSNSNIGAGYDVHWYQQLPGTAPKLLIYNNNNRPSGVPDRFSGSQSGTSASLAITGVQAEDEADYYCQSYDSSLSGVVFGGGTQLTVLGGGSSRSSSSGGGGSGGGGGVQLVESGPRLVKPSETLSLTCFVSGGSISSASYQWSWLRQRPGQGLEWIGYIYYSGSSNYNPSLKRRVSFSADASKNQFSMRLVSLTAADTAVYYCARQSHIIVVPTAGALGTFDIWGHGTMVTVSSASTKGPSVTSGQAGRNAVGQDTQEVIVVPHSLPFKVVVISAILALVVLTIISLIILIMLWQKKPR

SEQ ID NO: 18 - protein, 169 aa, artificial sequence
  chemically synthesized
METDTLLLWVLLLWVPGSTGDYEAQAAELVMTQSPATLSVSPGETATLSCRASQSVGSNLAWFQQKPGQAPRLLIYGASTRATGIPARFSGGGSGTEFTLTISSLQSEDFVVYYCHQYADWPRTFGQGTKVEIKGGSSRSSSSGGGGSGGGGQVQLQQWGEAWSSRGGP

SEQ ID NO: 19 - protein, 346 aa, artificial sequence
  chemically synthesized
METDTLLLWVLLLWVPGSTGDYEAQAAELVLTQPPSVSGAPGQRVTISCSGNSSNIGTRYDVHWYQQFPGTAPKLLIYGNTNRPSGVPDRFSGSTSGASASLAITGLQADDEADYYCQSYDSSLRATVFGGGTQLTVLGGGSSRSSSSGGGGSGGGGQVQLVQSGGGWVQSGGSLRLSCAASGFSFSSYAMSWVRQAPGKGLEWVSAMSPIGGSTFYADSVKGRFTISRDNSKNTLFLQMNSLRAEDTAVYYCAKDAVVTAVGLGWYFDLWGRGTLVSVSSASTKGPSATSGQAGRNAVGQDTQEVIVVPHSLPFKVVVISAILALVVLTIISLIILIMLWQKKPR

SEQ ID NO: 20 - protein, 350 aa, artificial sequence
  chemically synthesized
METDTLLLWVLLLWVPGSTGDYEAQAAELGQTQQLSVSGAPGQSVTISCTGGSSNIGASYDVHWYKQLPGAAPILLIYANYIRPSGVPDRFSASKSGTSASLAITGLQAEDEADYYCQSYDSSLSGVVFGGGTKLTVLGGGSSRSSSSGGGGSGGGGEVQLVQSGPGLVKPSQTLSITCTVSGGSVSDTSYYWAWVRQPPGKGLEWIAHAFYSGSANYNPSLKSRATISVDTSRNQFSLRLDSVTAADTAVYYCARETHLVVVPGAGALGAFDIWGQGTMVTVSPASTKGPSVTSGQAGRNAVGQDTQEVIVVPHSLPFKVVVISAILALVVLTIISLIILIMLWQKKPR

SEQ ID NO: 21 - protein, 343 aa, artificial sequence
  chemically synthesized
METDTLLLWVLLLWVPGSTGDYEAQAAELELTQPPSVSGSPGQSVTISCTGTSSNVGGYNYVSWYQQYPGKAPKLMIYDVTKRPSGVPDRFSGSKSGSTASLTISGLQSDDDADYYCCSYAGSYIWVFGGGTKLTVLGGGSSRSSSSGGGGSGGGGEVQLVQSGPGLVKPSETLSLTCTVSGVSVSSGSYHWSWIRQTPGKGLEWIGYIYYIGSTKYNPSLKSRATISINTSTNQFSLKLSSVTAADTAVYYCARESTSYGERRFDYWGQGTRVTVSSASTKGPSVTSGQAGRNAVGQDTQEVIVVPHSLPFKVVVISAILALVVLTIISLIILIMLWQKKPR

SEQ ID NO: 22 - protein, 526 aa, artificial sequence [sequence omitted]

SEQ ID NO: 23 - protein, 522 aa, artificial sequence
  chemically synthesized
METDTLLLWVLLLWVPGSTGDADPAQAAELVMTQSPSSLSASVGDRVTITCRASQGVSRALAWYQQKPGNPPKLLIYDASNLQSGVPSRFSGGGSGTEFILTISSLQPEDFATYYCQQYNAYPWTFGQGTKLEIKGGSSRSSSSGGGGSGGGGQVQLQESGPGLVKPSETLSLTCTVSGGSISSGNYYWSWIRQTPEKGLEWLGYVHYTGSSKLNPSLKSRVTISVDTYTNQFSLSLSSMTAADTAVYYCARGKNCANDICYIGSWFDPWGQGTLVTVSSASTKGPSVTSGQAGRKLTHTCPPCPAPEAEGAPSVFLFPPKPKDTLMISRTPEVTCVVVDVSHEDPEVKFNWYVDGVEVHNAKTKPREEQYNSTYRVVSVLTVLHQDWLNGKEYKCKVSNKALPASIEKTISKAKGQPREPQVYTLPPSRDELTKNQVSLTCLVKGFYPSDIAVEWESNGQPENNYKTTPPVLDSDGSFFLYSKLTVDKSRWQQGNVFSCSVMHEALHNHYTQKSLSLSPGK

SEQ ID NO: 24 - protein, 525 aa, artificial sequence [sequence omitted]

SEQ ID NO: 25 - protein, 524 aa, artificial sequence [sequence omitted]

SEQ ID NO: 26 - DNA, 69 bp, artificial sequence
  chemically synthesized
cctgctatgggtactgctgctctgggttccaggttccactggtgactatgaggcccaggcggccggtac

SEQ ID NO: 27 - DNA, 70 bp, artificial sequence
  chemically synthesized
cctcctgcgtgtcctggcccacagcattgcggccggcctggccgctagcggtaccggccgcctgggcctc

SEQ ID NO: 28 - DNA, 69 bp, artificial sequence
  chemically synthesized
ggccaggacacgcaggaggtcatcgtggtgccacactccttgccctttaaggtggtggtgatctcagcc

SEQ ID NO: 29 - DNA, 70 bp, artificial sequence
  chemically synthesized
catgatgaggatgataagggagatgatggtgagcaccaccagggccaggatggctgagatcaccaccacc

SEQ ID NO: 30 - DNA, 54 bp, artificial sequence
  chemically synthesized
gagtctagagccaccatggagacagacacactcctgctatgggtactgctgctc

SEQ ID NO: 31 - DNA, 55 bp, artificial sequence
  chemically synthesized
ctcgggcccctaacgtggcttcttctgccaaagcatgatgaggatgataagggag

SEQ ID NO: 32 - DNA, 57 bp, artificial sequence
  chemically synthesized
aagcagtggtaacaacgcagagtacttttttttttttttttttttttttttttttvn

SEQ ID NO: 33 - DNA, 30 bp, artificial sequence
  chemically synthesized
aagcagtggtaacaacgcagagtacgcggg

SEQ ID NO: 34 - DNA, 23 bp, artificial sequence
  chemically synthesized
aagcagtggtatcaacgcagagt

SEQ ID NO: 35 - DNA, 22 bp, artificial sequence
  chemically synthesized
acaaattggactaatcgatggc

SEQ ID NO: 36 - DNA, 20 bp, artificial sequence
  chemically synthesized
gagcaaaagagcattccaag

SEQ ID NO: 37 - DNA, 10309 bp, artificial sequence
  chemically synthesized
ggtaccatggagacagacacactcctgctatgggtactgctgctctgggttccaggttccactggtgacgcggatccggcccaggcggccttaattaaaggtttaaacggccaggccggccgcaagcttactcacacatgcccaccgtgcccagcacctgaagccgagggggcaccgtcagtcttcctcttccccccaaaacccaaggacaccctcatgatctcccggacccctgaggtcacatgcgtggtggtggacgtgagccacgaagaccctgaggtcaagttcaactggtacgtggacggcgtggaggtgcataatgccaagacaaagccgcgggaggagcagtacaacagcacgtaccgtgtggtcagcgtcctcaccgtcctgcaccaggactggctgaatggcaaggagtacaagtgcaaggtctccaacaaagccctcccagcctccatcgagaaaaccatctccaaagccaaagggcagccccgagaaccacaggtgtacaccctgcccccatcccgggatgagctgaccaagaaccaggtcagcctgacctgcctggtcaaaggcttctatcccagcgacatcgccgtggagtgggagagcaatgggcagccggagaacaactacaagaccacgcctcccgtgttggactccgacggctccttcttcctctacagcaagctcaccgtggacaagagcaggtggcagcaggggaacgtcttctcatgctccgtgatgcatgaggctctgcacaaccactacacgcagaagagcctctccctgtctccgggtaaatgactcgaggcccgaacaaaaactcatctcagaagaggatctgaatagcgccgtcgaccatcatcatcatcatcattgagtttaacgatccagacatgataagatacattgatgagtttggacaaaccacaactagaatgcagtgaaaaaaatgctttatttgtgaaatttgtgatgctattgctttatttgtaaccattataagctgcaataaacaagttaacaacaacaattgcattcattttatgtttcaggttcagggggaggtggggaggttttttaaagcaagtaaaacctctacaaatgtggtatggctgattatgatccggctgcctcgcgcgtttcggtgatgacggtgaaaacctctgacacatgcagctcccggagacggtcacagcttgtctgtaagcggatgccgggagcagacaagcccgtcagggcgcgtcagcgggtgttggcgggtgtcggggcgcagccatgaggtcgactctagaggatcgatccccgccgccggacgaactaaacctgactacggcatctctgccccttcttcgcggggcagtgcatgtaatcccttcagttggttggtacaacttgccaactgggccctgttccacatgtgacacggggggggaccaaacacaaaggggttctctgactgtagttgacatccttataaatggatgtgcacatttgccaacactgagtggctttcatcctggagcagactttgcagtctgtggactgcaacacaacattgcctttatgtgtaactcttggctgaagctcttacaccaatgctgggggacatgtacctcccaggggcccaggaagactacgggaggctacaccaacgtcaatcagaggggcctgtgtagctaccgataagcggaccctcaagagggcattagcaatagtgtttataaggcccccttgttaaccctaaacgggtagcatatgcttcccgggtagtagtatatactatccagactaaccctaattcaatagcatatgttacccaacgggaagcatatgctatcgaattagggttagtaaaagggtcctaaggaacagcgatatctcccaccccatgagctgtcacggttttatttacatggggtcaggattccacgagggtagtgaaccattttagtcacaagggcagtggctgaagatcaaggagcgggcagtgaactctcctgaatcttcgcctgcttcttcattctccttcgtttagctaatagaataactgctgagttgtgaacagtaaggtgtatgtgaggtgctcgaaaacaaggtttcaggtgacgcccccagaataaaatttggacggggggttcagtggtggcattgtgctatgacaccaatataaccctcacaaaccccttgggcaataaatactagtgtaggaatgaaacattctgaatatctttaacaatagaaatccatggggtggggacaagccgtaaagactggatgtccatctcacacgaatttatggctatgggcaacacataatcctagtgcaatatgatactggggttattaagatgtgtcccaggcagggaccaagacaggtgaaccatgttgttacactctatttgtaacaaggggaaagagagtggacgccgacagcagcggactccactggttgtctctaacacccccgaaaattaaacggggctccacgccaatggggcccataaacaaagacaagtggccactcttttttttgaaattgtggagtgggggcacgcgtcagcccccacacgccgccctgcggttttggactgtaaaataagggtgtaataacttggctgattgtaaccccgctaaccactgcggtcaaaccacttgcccacaaaaccactaatggcaccccggggaatacctgcataagtaggtgggcgggccaagataggggcgcgattgctgcgatctggaggacaaattacacacacttgcgcctgagcgccaagcacagggttgttggtcctcatattcacgaggtcgctgagagcacggtgggctaatgttgccatgggtagcatatactacccaaatatctggatagcatatgctatcctaatctatatctgggtagcataggctatcctaatctatatctgggtagcatatgctatcctaatctatatctgggtagtatatgctatcctaatttatatctgggtagcataggctatcctaatctatatctgggtagcatatgctatcctaatctatatctgggtagtatatgctatcctaatctgtatccgggtagcatatgctatcctaatagagattagggtagtatatgctatcctaatttatatctgggtagcatatactacccaaatatctggatagcatatgctatcctaatctatatctgggtagcatatgctatcctaatctatatctgggtagcataggctatcctaatctatatctgggtagcatatgctatcctaatctatatctgggtagtatatgctatcctaatttatatctgggtagcataggctatcctaatctatatctgggtagcatatgctatcctaatctatatctgggtagtatatgctatcctaatctgtatccgggtagcatatgctatcctcatgcatatacagtcagcatatgatacccagtagtagagtgggagtgctatcctttgcatatgccgccacctcccaagggggcgtgaattttcgctgcttgtccttttcctgcatgctggttgctcccattcttaggtgaatttaaggaggccaggctaaagccgtcgcatgtctgattgctcaccaggtaaatgtcgctaatgttttccaacgcgagaaggtgttgagcgcggagctgagtgacgtgacaacatgggtatgcccaattgccccatgttgggaggacgaaaatggtgacaagacagatggccagaaatacaccaacagcacgcatgatgtctactggggatttattctttagtgcgggggaatacacggcttttaatacgattgagggcgtctcctaacaagttacatcactcctgcccttcctcaccctcatctccatcacctccttcatctccgtcatctccgtcatcaccctccgcggcagccccttccaccataggtggaaaccagggaggcaaatctactccatcgtcaaagctgcacacagtcaccctgatattgcaggtaggagcgggctttgtcataacaaggtccttaatcgcatccttcaaaacctcagcaaatatatgagtttgtaaaaagaccatgaaataacagacaatggactcccttagcgggccaggttgtgggccgggtccaggggccattccaaaggggagacgactcaatggtgtaagacgacattgtggaatagcaagggcagttcctcgccttaggttgtaaagggaggtcttactacctccatatacgaacacaccggcgacccaagttccttcgtcggtagtcctttctacgtgactcctagccaggagagctcttaaaccttctgcaatgttctcaaatttcgggttggaacctccttgaccacgatgctttccaaaccaccctccttttttgcgcctgcctccatcaccctgaccccggggtccagtgcttgggccttctcctgggtcatctgcggggccctgctctatcgctcccgggggcacgtcaggctcaccatctgggccaccttcttggtggtattcaaaataatcggcttcccctacagggtggaaaaatggccttctacctggagggggcctgcgcggtggagacccggatgatgatgactgactactgggactcctgggcctcttttctccacgtccacgacctctccccctggctctttcacgacttccccccctggctctttcacgtcctctaccccggcggcctccactacctcctcgaccccggcctccactacctcctcgaccccggcctccactgcctcctcgaccccggcctccacctcctgctcctgcccctcctgctcctgcccctcctcctgctcctgcccctcctgcccctcctgctcctgcccctcctgcccctcctgctcctgcccctcctgcccctcctgctcctgcccctcctgcccctcctcctgctcctgcccctcctgcccctcctcctgctcctgcccctcctgcccctcctgctcctgcccctcctgcccctcctgctcctgcccctcctgcccctcctgctcctgcccctcctgctcctgcccctcctgctcctgcccctcctgctcctgcccctcctgcccctcctgcccctcctcctgctcctgcccctcctgctcctgcccctcctgcccctcctgcccctcctgctcctgcccctcctcctgctcctgcccctcctgcccctcctgcccctcctcctgctcctgcccctcctgcccctcctcctgctcctgcccctcctcctgctcctgcccctcctgcccctcctgcccctcctcctgctcctgcccctcctgcccctcctcctgctcctgcccctcctcctgctcctgcccctcctgcccctcctgcccctcctcctgctcctgcccctcctcctgctcctgcccctcctgcccctcctgcccctcctgcccctcctcctgctcctgcccctcctcctgctcctgcccctcctgctcctgcccctcccgctcctgctcctgctcctgttccaccgtgggtccctttgcagccaatgcaacttggacgtttttggggtctccggacaccatctctatgtcttggccctgatcctgagccgcccggggctcctggtcttccgcctcctcgtcctcgtcctcttccccgtcctcgtccatggttatcaccccctcttctttgaggtccactgccgccggagccttctggtccagatgtgtctcccttctctcctaggccatttccaggtcctgtacctggcccctcgtcagacatgattcacactaaaagagatcaatagacatctttattagacgacgctcagtgaatacagggagtgcagactcctgccccctccaacagcccccccaccctcatccccttcatggtcgctgtcagacagatccaggtctgaaaattccccatcctccgaaccatcctcgtcctcatcaccaattactcgcagcccggaaaactcccgctgaacatcctcaagatttgcgtcctgagcctcaagccaggcctcaaattcctcgtccccctttttgctggacggtagggatggggattctcgggacccctcctcttcctcttcaaggtcaccagacagagatgctactggggcaacggaagaaaagctgggtgcggcctgtgaggatcagcttatcgatgataagctgtcaaacatgagaattcttgaagacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtgttgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgcagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctgcgccgcgtgcggctgctggagatggcggacgcgatggatatgttctgccaagggttggtttgcgcattcacagttctccgcaagaattgattggctccaattcttggagtggtgaatccgttagcgaggccatccagcctcgcgtcgaactagatgatccgctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcggcctctgagctattccagaagtagtgaggaggcttttttggagggtgaccgccacgaggtgccgccaccatcccctgacccacgcccctgacccctcacaaggagacgaccttccatgaccgagtacaagcccacggtgcgcctcgccacccgcgacgacgtcccccgggccgtacgcaccctcgccgccgcgttcgccgactaccccgccacgcgccacaccgtcgaccccgaccgccacatcgaacgcgtcaccgagctgcaagaactcttcctcacgcgcgtcgggctcgacatcggcaaggtgtgggtcgcggacgacggcgccgcggtggcggtctggaccacgccggagagcgtcgaagcgggggcggtgttcgccgagatcggcccgcgcatggccgagttgagcggttcccggctggccgcgcagcaacagatggaaggcctcctggcgccgcaccggcccaaggagcccgcgtggttcctggccaccgtcggcgtctcgcccgaccaccagggcaagggtctgggcagcgccgtcgtgctccccggagtggaggcggccgagcgcgccggggtgcccgccttcctggagacctccgcgccccgcaacctccccttctacgagcggctcggcttcaccgtcaccgccgacgtcgagtgcccgaaggaccgcgcgacctggtgcatgacccgcaagcccggtgcctgacgcccgccccacgacccgcagcgcccgaccgaaaggagcgcacgacccggtccgacggcggcccacgggtcccaggggggtcgacctcgaaacttgtttattgcagcttataatggttacaaataaagcaatagcatcacaaatttcacaaataaagcatttttttcactgcattctagttgtggtttgtccaaactcatcaatgtatcttatcatgtctggatcgatccgaaccccttcctcgaccaattctcatgtttgacagcttatcatcgcagatccgggcaacgttgttgcattgctgcaggcgcagaactggtaggtatggaagatctatacattgaatcaatattggcaattagccatattagtcattggttatatagcataaatcaatattggctattggccattgcatacgttgtatctatatcataatatgtacatttatattggctcatgtccaatatgaccgccatgttgacattgattattgactagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtccgccccctattgacgtcaatgacggtaaatggcccgcctggcattatgcccagtacatgaccttacgggactttcctacttggcagtacatctacgtattagtcatcgctattaccatggtgatgcggttttggcagtacaccaatgggcgtggatagcggtttgactcacggggatttccaagtctccaccccattgacgtcaatgggagtttgttttggcaccaaaatcaacgggactttccaaaatgtcgtaataaccccgccccgttgacgcaaatgggcggtaggcgtgtacggtgggaggtctatataagcagagctcgtttagtgaaccgtcagatctctagaagctg

SEQ ID NO: 38 - DNA, 10215 bp, artificial sequence
  chemically synthesized
gagctcgtatggacatattgtcgttagaacgcggctacaattaatacataaccttatgtatcatacacatacgatttaggggacactatagattgacggcgtagtacacactattgaatcaaacagccgaccaattgcactaccatcacaatggagaagccagtagtaaacgtagacgtagacccccagagtccgtttgtcgtgcaactgcaaaaaagcttcccgcaatttgaggtagtagcacagcaggtcactccaaatgaccatgctaatgccagagcattttcgcatctggccagtaaactaatcgagctggaggttcctaccacagcgacgatcttggacataggcagcgcaccggctcgtagaatgttttccgagcaccagtatcattgtgtctgccccatgcgtagtccagaagacccggaccgcatgatgaaatacgccagtaaactggcggaaaaagcgtgcaagattacaaacaagaacttgcatgagaagattaaggatctccggaccgtacttgatacgccggatgctgaaacaccatcgctctgctttcacaacgatgttacctgcaacatgcgtgccgaatattccgtcatgcaggacgtgtatatcaacgctcccggaactatctatcatcaggctatgaaaggcgtgcggaccctgtactggattggcttcgacaccacccagttcatgttctcggctatggcaggttcgtaccctgcgtacaacaccaactgggccgacgagaaagtccttgaagcgcgtaacatcggactttgcagcacaaagctgagtgaaggtaggacaggaaaattgtcgataatgaggaagaaggagttgaagcccgggtcgcgggtttatttctccgtaggatcgacactttatccagaacacagagccagcttgcagagctggcatcttccatcggtgttccacttgaatggaaagcagtcgtacacttgccgctgtgatacagtggtgagttgcgaaggctacgtagtgaagaaaatcaccatcagtcccgggatcacgggagaaaccgtgggatacgcggttacacacaatagcgagggcttcttgctatgcaaagttactgacacagtaaaaggagaacgggtatcgttccctgtgtgcacgtacatcccggccaccatatgcgatcagatgactggtataatggccacggatatatcacctgacgatgcacaaaaacttctggttgggctcaaccagcgaattgtcattaacggtaggactaacaggaacaccaacaccatgcaaaattaccttctgccgatcatagcacaagggttcagcaaatgggctaaggagcgcaaggatgatcttgataacgagaaaatgctgggtactagagaacgcaagcttacgtatggctgcttgtgggcgtttcgcactaagaaagtacattcgttttatcgcccacctggaacgcagacctgcgtaaaagtcccagcctcttttagcgcttttcccatgtcgtccgtatggacgacctctttgcccatgtcgctgaggcagaaattgaaactggcattgcaaccaaagaaggaggaaaaactgctgcaggtctcggaggaattagtcatggaggccaaggctgcttttgaggatgctcaggaggaagccagagcggagaagctccgagaagcacttccaccattagtggcagacaaaggcatcgaggcagccgcagaagttgtctgcgaagtggaggggctccaggcggacatcggagcagcattagttgaaaccccgcgcggtcacgtaaggataatacctcaagcaaatgaccgtatgatcggacagtatatcgttgtctcgccaaactctgtgctgaagaatgccaaactcgcaccagcgcacccgctagcagatcaggttaagatcataacacactccggaagatcaggaaggtacgcggtcgaaccatacgacgctaaagtactgatgccagcaggaggtgccgtaccatggccagaattcctagcactgagtgagagcgccacgttagtgtacaacgaaagagagtttgtgaaccgcaaactataccacattgccatgcatggccccgccaagaatacagaagaggagcagtacaaggttacaaaggcagagcttgcagaaacagagtacgtgtttgacgtggacaagaagcgttgcgttaagaaggaagaagcctcaggtctggtcctctcgggagaactgaccaaccctccctatcatgagctagctctggagggactgaagacccgacctgcggtcccgtacaaggtcgaaacaataggagtgataggcacaccggggtcgggcaagtcagctattatcaagtcaactgtcacggcacgagatcttgttaccagcggaaagaaagaaaattgtcgcgaaattgaggccgacgtgctaagactgaggggtatgcagattacgtcgaagacagtagattcggttatgctcaacggatgccacaaagccgtagaagtgctgtacgttgacgaagcgttcgcgtgccacgcaggagcactacttgccttgattgctatcgtcaggccccgcaagaaggtagtactatgcggagaccccatgcaatgcggattcttcaacatgatgcaactaaaggtacatttcaatcaccctgaaaaagacatatgcaccaagacattctacaagtatatctcccggcgttgcacacagccagttacagctattgtatcgacactgcattacgatggaaagatgaaaaccacgaacccgtgcaagaagaacattgaaatcgatattacaggggccacaaagccgaagccaggggatatcatcctgacatgtttccgcgggtgggttaagcaattgcaaatcgactatcccggacatgaagtaatgacagccgcggcctcacaagggctaaccagaaaaggagtgtatgccgtccggcaaaaagtcaatgaaaacccactgtacgcgatcacatcagagcatgtgaacgtgttgctcacccgcactgaggacaggctagtgtggaaaaccttgcagggcgacccatggattaagcagcccactaacatacctaaaggaaactttcaggctactatagaggactgggaagctgaacacaagggaataattgctgcaataaacagccccactccccgtgccaatccgttcagctgcaagaccaacgtttgctgggcgaaagcattggaaccgatactagccacggccggtatcgtacttaccggttgccagtggagcgaactgttcccacagtttgcggatgacaaaccacattcggccatttacgccttagacgtaatttgcattaagtttttcggcatggacttgacaagcggactgttttctaaacagagcatcccactaacgtaccatcccgccgattcagcgaggccggtagctcattgggacaacagcccaggaacccgcaagtatgggtacgatcacgccattgccgccgaactctcccgtagatttccggtgttccagctagctgggaagggcacacaacttgatttgcagacggggagaaccagagttatctctgcacagcataacctggtcccggtgaaccgcaatcttcctcacgccttagtccccgagtacaaggagaagcaacccggcccggtcaaaaaattcttgaaccagttcaaacaccactcagtacttgtggtatcagaggaaaaaattgaagctccccgtaagagaatcgaatggatcgccccgattggcatagccggtgcagataagaactacaacctggctttcgggtttccgccgcaggcacggtacgacctggtgttcatcaacattggaactaaatacagaaaccaccactttcagcagtgcgaagaccatgcggcgaccttaaaaaccctttcgcgttcggccctgaattgccttaacccaggaggcaccctcgtggtgaagtcctatggctacgccgaccgcaacagtgaggacgtagtcaccgctcttgccagaaagtttgtcagggtgtctgcagcgagaccagattgtgtctcaagcaatacagaaatgtacctgattttccgacaactagacaacagccgtacacggcaattcaccccgcaccatctgaattgcgtgatttcgtccgtgtatgagggtacaagagatggagttggagccgcgccgtcataccgcaccaaaagggagaatattgctgactgtcaagaggaagcagttgtcaacgcagccaatccgctgggtagaccaggcgaaggagtctgccgtgccatctataaacgttggccgaccagttttaccgattcagccacggagacaggcaccgcaagaatgactgtgtgcctaggaaagaaagtgatccacgcggtcggccctgatttccggaagcacccagaagcagaagccttgaaattgctacaaaacgcctaccatgcagtggcagacttagtaaatgaacataacatcaagtctgtcgccattccactgctatctacaggcatttacgcagccggaaaagaccgccttgaagtatcacttaactgcttgacaaccgcgctagacagaactgacgcggacgtaaccatctattgcctggataagaagtggaaggaaagaatcgacgcggcactccaacttaaggagtctgtaacagagctgaaggatgaagatatggagatcgacgatgagttagtatggattcatccagacagttgcttgaagggaagaaagggattcagtactacaaaaggaaaattgtattcgtacttcgaaggcaccaaattccatcaagcagcaaaagacatggcggagataaaggtcctgttccctaatgaccaggaaagtaatgaacaactgtgtgcctacatattgggtgagaccatggaagcaatccgcgaaaagtgcccggtcgaccataacccgtcgtctagcccgcccaaaacgttgccgtgcctttgcatgtatgccatgacgccagaaagggtccacagacttagaagcaataacgtcaaagaagttacagtatgctcctccaccccccttcctaagcacaaaattaagaatgttcagaaggttcagtgcacgaaagtagtcctgtttaatccgcacactcccgcattcgttcccgcccgtaagtacatagaagtgccagaacagcctaccgctcctcctgcacaggctgaggaagcccccgaagttgtagcgacaccgtcaccatctacagctgataacacctcgcttgatgtcacagacatctcactggatatggatgacagtagcgaaggctcacttttttcgagctttagcggatcggacaactctattactagtatggacagttggtcgtcaggacctagttcactagagatagtagaccgaaggcaggtggtggtggctgacgttcatgccgtccaagagcctgcccctattccaccgccaaggctaaagaagatggcccgcctggcagcggcaagaaaagagcccactccaccggcaagcaatagctctgagtccctccacctctcttttggtggggtatccatgtccctcggatcaattttcgacggagagacggcccgccaggcagcggtacaacccctggcaacaggccccacggatgtgcctatgtctttcggatcgttttccgacggagagattgatgagctgagccgcagagtaactgagtccgaacccgtcctgtttggatcatttgaaccgggcgaagtgaactcaattatatcgtcccgatcagccgtatcttttccactacgcaagcagagacgtagacgcaggagcaggaggactgaatactgactaaccggggtaggtgggtacatattttcgacggacacaggccctgggcacttgcaaaagaagtccgttctgcagaaccagcttacagaaccgaccttggagcgcaatgtcctggaaagaattcatgccccggtgctcgacacgtcgaaagaggaacaactcaaactcaggtaccagatgatgcccaccgaagccaacaaaagtaggtaccagtctcgtaaagtagaaaatcagaaagccataaccactgagcgactactgtcaggactacgactgtataactctgccacagatcagccagaatgctataagatcacctatccgaaaccattgtactccagtagcgtaccggcgaactactccgatccacagttcgctgtagctgtctgtaacaactatctgcatgagaactatccgacagtagcatcttatcagattactgacgagtacgatgcttacttggatatggtagacgggacagtcgcctgcctggatactgcaaccttctgccccgctaagcttagaagttacccgaaaaaacatgagtatagagccccgaatatccgcagtgcggttccatcagcgatgcagaacacgctacaaaatgtgctcattgccgcaactaaaagaaattgcaacgtcacgcagatgcgtgaactgccaacactggactcagcgacattcaatgtcgaatgctttcgaaaatatgcatgtaatgacgagtattgggaggagttcgctcggaagccaattaggattaccactgagtttgtcaccgcatatgtagctagactgaaaggccctaaggccgccgcactatttgcaaagacgtataatttggtcccattgcaagaagtgcctatggatagattcgtcatggacatgaaaagagacgtgaaagttacaccaggcacgaaacacacagaagaaagaccgaaagtacaagtgatacaagccgcagaacccctggcgactgcttacttatgcgggattcaccgggaattagtgcgtaggcttacggccgtcttgcttccaaacattcacacgctttttgacatgtcggcggaggattttgatgcaatcatagcagaacacttcaagcaaggcgacccggtactggagacggatatcgcatcattcgacaaaagccaagacgacgctatggcgttaaccggtctgatgatcttggaggacctgggtgtggatcaaccactactcgacttgatcgagtgcgcctttggagaaatatcatccacccatctacctacgggtactcgttttaaattcggggcgatgatgaaatccggaatgttcctcacactttttgtcaacacagttttgaatgtcgttatcgccagcagagtactagaagagcggcttaaaacgtccagatgtgcagcgttcattggcgacgacaacatcatacatggagtagtatctgacaaagaaatggctgagaggtgcgccacctggctcaacatggaggttaagatcatcgacgcagtcatcggtgagagaccaccttacttctgcggcggatttatcttgcaagattcggttacttccacagcgtgccgcgtggcggatcccctgaaaaggctgtttaagttgggtaaaccgctcccagccgacgacgagcaagacgaagacagaagacgcgctctgctagatgaaacaaaggcgtggtttagagtaggtataacaggcactttagcagtggccgtgacgacccggtatgaggtagacaatattacacctgtcctactggcattgagaacttttgcccagagcaaaagagcattccaagccatcagaggggaaataaagcatctctacggtggtcctaaatagtcagcatagtacatttcatctgactaatactacaacaccaccacctctagagccaccatggagacagacacactcctgctatgggtactgctgctctgggttccaggttccactggtgactatgaggcccaggcggccggtaccgctagcggccaggccggccgcaatgctgtgggccaggacacgcaggaggtcatcgtggtgccacactccttgccctttaaggtggtggtgatctcagccatcctggccctggtggtgctcaccatcatctcccttatcatcctcatcatgctttggcagaagaagccacgttaggggcccgccatcgattagtccaatttgttggcccaatgatccgaccagcaaaactcgatgtacttccgaggaactgatgtgcataatgcatcaggctggtacattagatccccgcttaccgcgggcaatatagcaacactaaaaactcgatgtacttccgaggaagcgcagtgcataatgctgcgcagtgttgccacataaccactatattaaccatttatctagcggacgccaaaaactcaatgtatttctgaggaagcgtggtgcataatgccacgcagcgtctgcataacttttattatttcttttattaatcaacaaaattttgtttttaacatttcaaaaaaaaaaaaaaaaaaaaaaaaaaaaaaaaaaaaagggaattcctcgattaattaagcggccgctcgaggggaattaattcttgaagacgaaagggccaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtgttgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagcattgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgc

SEQ ID NO: 39 - DNA, 10245 bp, artificial sequence
  chemically synthesized
gagctcgtatggacatattgtcgttagaacgcggctacaattaatacataaccttatgtatcatacacatacgatttaggggacactatagattgacggcgtagtacacactattgaatcaaacagccgaccaattgcactaccatcacaatggagaagccagtagtaaacgtagacgtagacccccagagtccgtttgtcgtgcaactgcaaaaaagcttcccgcaatttgaggtagtagcacagcaggtcactccaaatgaccatgctaatgccagagcattttcgcatctggccagtaaactaatcgagctggaggttcctaccacagcgacgatcttggacataggcagcgcaccggctcgtagaatgttttccgagcaccagtatcattgtgtctgccccatgcgtagtccagaagacccggaccgcatgatgaaatacgccagtaaactggcggaaaaagcgtgcaagattacaaacaagaacttgcatgagaagattaaggatctccggaccgtacttgatacgccggatgctgaaacaccatcgctctgctttcacaacgatgttacctgcaacatgcgtgccgaatattccgtcatgcaggacgtgtatatcaacgctcccggaactatctatcatcaggctatgaaaggcgtgcggaccctgtactggattggcttcgacaccacccagttcatgttctcggctatggcaggttcgtaccctgcgtacaacaccaactgggccgacgagaaagtccttgaagcgcgtaacatcggactttgcagcacaaagctgagtgaaggtaggacaggaaaattgtcgataatgaggaagaaggagttgaagcccgggtcgcgggtttatttctccgtaggatcgacactttatccagaacacagagccagcttgcagagctggcatcttccatcggtgttccacttgaatggaaagcagtcgtacacttgccgctgtgatacagtggtgagttgcgaaggctacgtagtgaagaaaatcaccatcagtcccgggatcacgggagaaaccgtgggatacgcggttacacacaatagcgagggcttcttgctatgcaaagttactgacacagtaaaaggagaacgggtatcgttccctgtgtgcacgtacatcccggccaccatatgcgatcagatgactggtataatggccacggatatatcacctgacgatgcacaaaaacttctggttgggctcaaccagcgaattgtcattaacggtaggactaacaggaacaccaacaccatgcaaaattaccttctgccgatcatagcacaagggttcagcaaatgggctaaggagcgcaaggatgatcttgataacgagaaaatgctgggtactagagaacgcaagcttacgtatggctgcttgtgggcgtttcgcactaagaaagtacattcgttttatcgcccacctggaacgcagacctgcgtaaaagtcccagcctcttttagcgcttttcccatgtcgtccgtatggacgacctctttgcccatgtcgctgaggcagaaattgaaactggcattgcaaccaaagaaggaggaaaaactgctgcaggtctcggaggaattagtcatggaggccaaggctgcttttgaggatgctcaggaggaagccagagcggagaagctccgagaagcacttccaccattagtggcagacaaaggcatcgaggcagccgcagaagttgtctgcgaagtggaggggctccaggcggacatcggagcagcattagttgaaaccccgcgcggtcacgtaaggataatacctcaagcaaatgaccgtatgatcggacagtatatcgttgtctcgccaaactctgtgctgaagaatgccaaactcgcaccagcgcacccgctagcagatcaggttaagatcataacacactccggaagatcaggaaggtacgcggtcgaaccatacgacgctaaagtactgatgccagcaggaggtgccgtaccatggccagaattcctagcactgagtgagagcgccacgttagtgtacaacgaaagagagtttgtgaaccgcaaactataccacattgccatgcatggccccgccaagaatacagaagaggagcagtacaaggttacaaaggcagagcttgcagaaacagagtacgtgtttgacgtggacaagaagcgttgcgttaagaaggaagaagcctcaggtctggtcctctcgggagaactgaccaaccctccctatcatgagctagctctggagggactgaagacccgacctgcggtcccgtacaaggtcgaaacaataggagtgataggcacaccggggtcgggcaagtcagctattatcaagtcaactgtcacggcacgagatcttgttaccagcggaaagaaagaaaattgtcgcgaaattgaggccgacgtgctaagactgaggggtatgcagattacgtcgaagacagtagattcggttatgctcaacggatgccacaaagccgtagaagtgctgtacgttgacgaagcgttcgcgtgccacgcaggagcactacttgccttgattgctatcgtcaggccccgcaagaaggtagtactatgcggagaccccatgcaatgcggattcttcaacatgatgcaactaaaggtacatttcaatcaccctgaaaaagacatatgcaccaagacattctacaagtatatctcccggcgttgcacacagccagttacagctattgtatcgacactgcattacgatggaaagatgaaaaccacgaacccgtgcaagaagaacattgaaatcgatattacaggggccacaaagccgaagccaggggatatcatcctgacatgtttccgcgggtgggttaagcaattgcaaatcgactatcccggacatgaagtaatgacagccgcggcctcacaagggctaaccagaaaaggagtgtatgccgtccggcaaaaagtcaatgaaaacccactgtacgcgatcacatcagagcatgtgaacgtgttgctcacccgcactgaggacaggctagtgtggaaaaccttgcagggcgacccatggattaagcagcccactaacatacctaaaggaaactttcaggctactatagaggactgggaagctgaacacaagggaataattgctgcaataaacagccccactccccgtgccaatccgttcagctgcaagaccaacgtttgctgggcgaaagcattggaaccgatactagccacggccggtatcgtacttaccggttgccagtggagcgaactgttcccacagtttgcggatgacaaaccacattcggccatttacgccttagacgtaatttgcattaagtttttcggcatggacttgacaagcggactgttttctaaacagagcatcccactaacgtaccatcccgccgattcagcgaggccggtagctcattgggacaacagcccaggaacccgcaagtatgggtacgatcacgccattgccgccgaactctcccgtagatttccggtgttccagctagctgggaagggcacacaacttgatttgcagacggggagaaccagagttatctctgcacagcataacctggtcccggtgaaccgcaatcttcctcacgccttagtccccgagtacaaggagaagcaacccggcccggtcaaaaaattcttgaaccagttcaaacaccactcagtacttgtggtatcagaggaaaaaattgaagctccccgtaagagaatcgaatggatcgccccgattggcatagccggtgcagataagaactacaacctggctttcgggtttccgccgcaggcacggtacgacctggtgttcatcaacattggaactaaatacagaaaccaccactttcagcagtgcgaagaccatgcggcgaccttaaaaaccctttcgcgttcggccctgaattgccttaacccaggaggcaccctcgtggtgaagtcctatggctacgccgaccgcaacagtgaggacgtagtcaccgctcttgccagaaagtttgtcagggtgtctgcagcgagaccagattgtgtctcaagcaatacagaaatgtacctgattttccgacaactagacaacagccgtacacggcaattcaccccgcaccatctgaattgcgtgatttcgtccgtgtatgagggtacaagagatggagttggagccgcgccgtcataccgcaccaaaagggagaatattgctgactgtcaagaggaagcagttgtcaacgcagccaatccgctgggtagaccaggcgaaggagtctgccgtgccatctataaacgttggccgaccagttttaccgattcagccacggagacaggcaccgcaagaatgactgtgtgcctaggaaagaaagtgatccacgcggtcggccctgatttccggaagcacccagaagcagaagccttgaaattgctacaaaacgcctaccatgcagtggcagacttagtaaatgaacataacatcaagtctgtcgccattccactgctatctacaggcatttacgcagccggaaaagaccgccttgaagtatcacttaactgcttgacaaccgcgctagacagaactgacgcggacgtaaccatctattgcctggataagaagtggaaggaaagaatcgacgcggcactccaacttaaggagtctgtaacagagctgaaggatgaagatatggagatcgacgatgagttagtatggattcatccagacagttgcttgaagggaagaaagggattcagtactacaaaaggaaaattgtattcgtacttcgaaggcaccaaattccatcaagcagcaaaagacatggcggagataaaggtcctgttccctaatgaccaggaaagtaatgaacaactgtgtgcctacatattgggtgagaccatggaagcaatccgcgaaaagtgcccggtcgaccataacccgtcgtctagcccgcccaaaacgttgccgtgcctttgcatgtatgccatgacgccagaaagggtccacagacttagaagcaataacgtcaaagaagttacagtatgctcctccaccccccttcctaagcacaaaattaagaatgttcagaaggttcagtgcacgaaagtagtcctgtttaatccgcacactcccgcattcgttcccgcccgtaagtacatagaagtgccagaacagcctaccgctcctcctgcacaggctgaggaagcccccgaagttgtagcgacaccgtcaccatctacagctgataacacctcgcttgatgtcacagacatctcactggatatggatgacagtagcgaaggctcacttttttcgagctttagcggatcggacaactctattactagtatggacagttggtcgtcaggacctagttcactagagatagtagaccgaaggcaggtggtggtggctgacgttcatgccgtccaagagcctgcccctattccaccgccaaggctaaagaagatggcccgcctggcagcggcaagaaaagagcccactccaccggcaagcaatagctctgagtccctccacctctcttttggtggggtatccatgtccctcggatcaattttcgacggagagacggcccgccaggcagcggtacaacccctggcaacaggccccacggatgtgcctatgtctttcggatcgttttccgacggagagattgatgagctgagccgcagagtaactgagtccgaacccgtcctgtttggatcatttgaaccgggcgaagtgaactcaattatatcgtcccgatcagccgtatcttttccactacgcaagcagagacgtagacgcaggagcaggaggactgaatactgactaaccggggtaggtgggtacatattttcgacggacacaggccctgggcacttgcaaaagaagtccgttctgcagaaccagcttacagaaccgaccttggagcgcaatgtcctggaaagaattcatgccccggtgctcgacacgtcgaaagaggaacaactcaaactcaggtaccagatgatgcccaccgaagccaacaaaagtaggtaccagtctcgtaaagtagaaaatcagaaagccataaccactgagcgactactgtcaggactacgactgtataactctgccacagatcagccagaatgctataagatcacctatccgaaaccattgtactccagtagcgtaccggcgaactactccgatccacagttcgctgtagctgtctgtaacaactatctgcatgagaactatccgacagtagcatcttatcagattactgacgagtacgatgcttacttggatatggtagacgggacagtcgcctgcctggatactgcaaccttctgccccgctaagcttagaagttacccgaaaaaacatgagtatagagccccgaatatccgcagtgcggttccatcagcgatgcagaacacgctacaaaatgtgctcattgccgcaactaaaagaaattgcaacgtcacgcagatgcgtgaactgccaacactggactcagcgacattcaatgtcgaatgctttcgaaaatatgcatgtaatgacgagtattgggaggagttcgctcggaagccaattaggattaccactgagtttgtcaccgcatatgtagctagactgaaaggccctaaggccgccgcactatttgcaaagacgtataatttggtcccattgcaagaagtgcctatggatagattcgtcatggacatgaaaagagacgtgaaagttacaccaggcacgaaacacacagaagaaagaccgaaagtacaagtgatacaagccgcagaacccctggcgactgcttacttatgcgggattcaccgggaattagtgcgtaggcttacggccgtcttgcttccaaacattcacacgctttttgacatgtcggcggaggattttgatgcaatcatagcagaacacttcaagcaaggcgacccggtactggagacggatatcgcatcattcgacaaaagccaagacgacgctatggcgttaaccggtctgatgatcttggaggacctgggtgtggatcaaccactactcgacttgatcgagtgcgcctttggagaaatatcatccacccatctacctacgggtactcgttttaaattcggggcgatgatgaaatccggaatgttcctcacactttttgtcaacacagttttgaatgtcgttatcgccagcagagtactagaagagcggcttaaaacgtccagatgtgcagcgttcattggcgacgacaacatcatacatggagtagtatctgacaaagaaatggctgagaggtgcgccacctggctcaacatggaggttaagatcatcgacgcagtcatcggtgagagaccaccttacttctgcggcggatttatcttgcaagattcggttacttccacagcgtgccgcgtggcggatcccctgaaaaggctgtttaagttgggtaaaccgctcccagccgacgacgagcaagacgaagacagaagacgcgctctgctagatgaaacaaaggcgtggtttagagtaggtataacaggcactttagcagtggccgtgacgacccggtatgaggtagacaatattacacctgtcctactggcattgagaacttttgcccagagcaaaagagcattccaagccatcagaggggaaataaagcatctctacggtggtcctaaatagtcagcatagtacatttcatctgactaatactacaacaccaccacctctagagccaccatggagacagacacactcctgctatgggtactgctgctctgggttccaggttccactggtgactatgaggcccaggcggccggtaccgctagcggccaggccggccgctatccttacgacgtgccagattatgcctctaatgctgtgggccaggacacgcaggaggtcatcgtggtgccacactccttgccctttaaggtggtggtgatctcagccatcctggccctggtggtgctcaccatcatctcccttatcatcctcatcatgctttggcagaagaagccacgttaggggcccgccatcgattagtccaatttgttggcccaatgatccgaccagcaaaactcgatgtacttccgaggaactgatgtgcataatgcatcaggctggtacattagatccccgcttaccgcgggcaatatagcaacactaaaaactcgatgtacttccgaggaagcgcagtgcataatgctgcgcagtgttgccacataaccactatattaaccatttatctagcggacgccaaaaactcaatgtatttctgaggaagcgtggtgcataatgccacgcagcgtctgcataacttttattatttcttttattaatcaacaaaattttgtttttaacatttcaaaaaaaaaaaaaaaaaaaaaaaaaaaaaaaaaaaaagggaattcctcgattaattaagcggccgctcgaggggaattaattcttgaagacgaaagggccaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtgttgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagcattgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgc

SEQ ID NO: 40 - DNA, 315 bp, artificial sequence
  chemically synthesized
gagtctagagccaccatggagacagacacactcctgctatgggtactgctgctctgggttccaggttccactggtgactatgaggcccaggcggccggtaccgctagcggccaggccggccgctatccttacgacgtgccagattatgcctctaatgctgtgggccaggacacgcaggaggtcatcgtggtgccacactccttgccctttaaggtggtggtgatctcagccatcctggccctggtggtgctcaccatcatctcccttatcatcctcatcatgctttggcagaagaagccacgttaggggcccgag

SEQ ID NO: 41 - DNA, 100 bp, artificial sequence
  chemically synthesized
cctcctgcgtgtcctggcccacagcattagaggcataatctggcacgtcgtaaggatagcggccggcctggccgctagcggtaccggccgcctgggcctc

SEQ ID NO: 42 - DNA, 77 bp, artificial sequence
  chemically synthesized
ggtggttcctctagatcttcctcctctggtggcggtggctcgggcggtggtgggcaggtgcagctggtgcagtctgg

SEQ ID NO: 43 - DNA, 77 bp, artificial sequence
  chemically synthesized
ggtggttcctctagatcttcctcctctggtggcggtggctcgggcggtggtgggcagatcaccttgaaggagtctgg

SEQ ID NO: 44 - DNA, 76 bp, artificial sequence
  chemically synthesized
ggtggttcctctagatcttcctcctctggtggcggtggctcgggcggtggtggggaggtgcagctgktggagtctg

SEQ ID NO: 45 - DNA, 77 bp, artificial sequence
  chemically synthesized
ggtggttcctctagatcttcctcctctggtggcggtggctcgggcggtggtgggcaggtgcagctacagcagtgggg

SEQ ID NO: 46 - DNA, 77 bp, artificial sequence
  chemically synthesized
ggtggttcctctagatcttcctcctctggtggcggtggctcgggcggtggtgggcaggtgcagctgcaggagtcggg

SEQ ID NO: 47 - DNA, 77 bp, artificial sequence
  chemically synthesized
ggtggttcctctagatcttcctcctctggtggcggtggctcgggcggtggtggggaggtgcagctggtgsagtctgg

SEQ ID NO: 48 - DNA, 46 bp, artificial sequence
  chemically synthesized
cctggccggcctggccactagtgaccgatgggcccttggtggargc

SEQ ID NO: 49 - DNA, 37 bp, artificial sequence
  chemically synthesized
gggcccaggcggccgagctccagatgacccagtctcc

SEQ ID NO: 50 - DNA, 37 bp, artificial sequence
  chemically synthesized
gggcccaggcggccgagctcgtgatgacycagtctcc

SEQ ID NO: 51 - DNA, 37 bp, artificial sequence
  chemically synthesized
gggcccaggcggccgagctcgtgwtgacrcagtctcc

SEQ ID NO: 52 - DNA, 37 bp, artificial sequence
  chemically synthesized
gggcccaggcggccgagctcacactcacgcagtctcc

SEQ ID NO: 53 - DNA, 42 bp, artificial sequence
  chemically synthesized
ggaagatctagaggaaccacctttgatytccaccttggtccc

SEQ ID NO: 54 - DNA, 42 bp, artificial sequence
  chemically synthesized
ggaagatctagaggaaccacctttgatctccagcttggtccc

SEQ ID NO: 55 - DNA, 42 bp, artificial sequence
  chemically synthesized
ggaagatctagaggaaccacctttgatatccactttggtccc

SEQ ID NO: 56 - DNA, 42 bp, artificial sequence
  chemically synthesized
ggaagatctagaggaaccacctttaatctccagtcgtgtccc

SEQ ID NO: 57 - DNA, 40 bp, artificial sequence
  chemically synthesized
gggcccaggcggccgagctcgtgbtgacgcagccgccctc

SEQ ID NO: 58 - DNA, 40 bp, artificial sequence
  chemically synthesized
gggcccaggcggccgagctcgtgctgactcagccaccctc

SEQ ID NO: 59 - DNA, 43 bp, artificial sequence
  chemically synthesized
gggcccaggcggccgagctcgccctgactcagcctccctccgt

SEQ ID NO: 60 - DNA, 46 bp, artificial sequence
  chemically synthesized
gggcccaggcggccgagctcgagctgactcagccaccctcagtgtc

SEQ ID NO: 61 - DNA, 40 bp, artificial sequence
  chemically synthesized
gggcccaggcggccgagctcgtgctgactcaatcgccctc

SEQ ID NO: 62 - DNA, 40 bp, artificial sequence
  chemically synthesized
gggcccaggcggccgagctcatgctgactcagccccactc

SEQ ID NO: 63 - DNA, 40 bp, artificial sequence
  chemically synthesized
gggcccaggcggccgagctcgtggtgacycaggagccmtc

SEQ ID NO: 64 - DNA, 40 bp, artificial sequence
  chemically synthesized
gggcccaggcggccgagctcgtgctgactcagccaccttc

SEQ ID NO: 65 - DNA, 40 bp, artificial sequence
  chemically synthesized
gggcccaggcggccgagctcgggcagactcagcagctctc

SEQ ID NO: 66 - DNA, 45 bp, artificial sequence
  chemically synthesized
ggaagatctagaggaaccaccgcctaggacggtcascttggtscc

SEQ ID NO: 67 - DNA, 45 bp, artificial sequence
  chemically synthesized
ggaagatctagaggaaccaccgcctaaaatgatcagctgggttcc

SEQ ID NO: 68 - DNA, 45 bp, artificial sequence
  chemically synthesized
ggaagatctagaggaaccaccgccgaggacggtcagctsggtscc

SEQ ID NO: 69 - DNA, 41 bp, artificial sequence
  chemically synthesized
gaggaggaggaggaggaggcggggcccaggcggccgagctc

SEQ ID NO: 70 - DNA, 41 bp, artificial sequence
  chemically synthesized
gaggaggaggaggaggagcctggccggcctggccactagtg

SEQ ID NO: 71 - DNA, 4625 bp, artificial sequence
  chemically synthesized
atgcattagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctggtttagtgaaccgtcagatccgctagcgattacgccaagctcgaaattaaccctcactaaagggaacaaaagctggagctggctagcgccaccatggacatgagggtccccgctcagctcctggggctcctgctactctggctccgaggtgccagatgtgacatcgagctcctgcaggaattcgatatcaaacgaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgacgctgagcaaagcagactacgagaaacacaaagtctacgcctgcgaagtcacccatcagggcctgagttcgcccgtcacaaagagcttcaacaggggagagtgttaggtttaaacggtaccaggtaagtgtacccaattcgccctatagtgagtcgtattacaattcactcgatcgcccttcccaacagttgcgcagcctgaatggcgaatggagatccaatttttaagtgtataatgtgttaaactactgattctaattgtttgtgtattttagattcacagtcccaaggctcatttcaggcccctcagtcctcacagtctgttcatgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttaacgcgtaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcaggtggcacttttcggggaaatgtgcgcggaacccctatttgtttatttttctaaatacattcaaatatgtatccgctcatgagacaataaccctgataaatgcttcaataatattgaaaaaggaagaatcctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggaggcctaggcttttgcaaagatcgatcaagagacaggatgaggatcgtttcgcatgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagaacatcaggggctcgcgccagccgaactgttcgccaggctcaaggcgagcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagaacttggcggcgaatgggctgaccgcttcctcgtgctttacggtatcgccgctcccgattcgcagcgcatcgccttctatcgccttcttgacgagttcttctgagcgggactctggggttcgaaatgaccgaccaagcgacgcccaacctgccatcacgagatttcgattccaccgccgccttctatgaaaggttgggcttcggaatcgttttccgggacgccggctggatgatcctccagcgcggggatctcatgctggagttcttcgcccaccctagggggaggctaactgaaacacggaaggagacaataccggaaggaacccgcgctatgacggcaataaaaagacagaataaaacgcacggtgttgggtcgtttgttcataaacgcggggttcggtcccagggctggcactctgtcgataccccaccgagaccccattggggccaatacgcccgcgtttcttccttttccccaccccaccccccaagttcgggtgaaggcccagggctcgcagccaacgtcggggcggcaggccctgccatagcctcaggttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcc

SEQ ID NO: 72 - DNA, 49 bp, artificial sequence
  chemically synthesized
ggctagcgccaccatggacatgagggtccccgctcagctcctggggctc

SEQ ID NO: 73 - DNA, 47 bp, artificial sequence
  chemically synthesized
caggagctgagcggggaccctcatgtccatggtggcgctagccagct

SEQ ID NO: 74 - DNA, 47 bp, artificial sequence
  chemically synthesized
ctgctactctggctccgaggtgccagatgtgacatcgagctcctgca

SEQ ID NO: 75 - DNA, 49 bp, artificial sequence
  chemically synthesized
ggagctcgatgtcacatctggcacctcggagccagagtagcaggagccc

SEQ ID NO: 76 - DNA, 35 bp, artificial sequence
  chemically synthesized
gaggaggatatcaaacgaactgtggctgcaccatc

SEQ ID NO: 77 - DNA, 68 bp, artificial sequence
  chemically synthesized
gaggagggtaccgtttaaacctaacactctcccctgttgaagctctttgtgacgggcgaactcaggcc

SEQ ID NO: 78 - DNA, 5257 bp, artificial sequence
  chemically synthesized
atgcattagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctggtttagtgaaccgtcagatccgctagcgattacgccaagctcgaaattaaccctcactaaagggaacaaaagctggagctcggcgcgccaccatggactggacctggaggatcctcttcttggtggcagcagccacaggagcccactcccagatgcaactgctcgaggcctccaccaagggcccatcggtcttccccctggcgccctgctccaggagcacctccgagagcacagcggccctgggctgcctggtcaaggactacttccccgaaccggtgacggtgtcgtggaactcaggcgctctgaccagcggcgtgcacaccttcccagctgtcctacagtcctcaggactctactccctcagcagcgtggtgaccgtgccctccagcaacttcggcacccagacctacacctgcaacgtagatcacaagcccagcaacaccaaggtggacaagacagttgagcgcaaatgttgtgtcgagtgcccaccgtgcccagcaccacctgtggcaggaccgtcagtcttcctcttccccccaaaacccaaggacaccctcatgatctcccggacccctgaggtcacgtgcgtggtggtggacgtgagccacgaagaccccgaggtccagttcaactggtacgtggacggcgtggaggtgcataatgccaagacaaagccacgggaggagcagttcaacagcacgttccgtgtggtcagcgtcctcaccgttgtgcaccaggactggctgaacggcaaggagtacaagtgcaaggtctccaacaaaggcctcccagcccccatcgagaaaaccatctccaaaaccaaagggcagccccgagaaccacaggtgtacaccctgcccccatcccgggaggagatgaccaagaaccaggtcagcctgacctgcctggtcaaaggcttctaccccagcgacatcgccgtggagtgggagagcaatgggcagccggagaacaactacaagaccacacctcccatgctggactccgacggctccttcttcctctacagcaagctcaccgtggacaagagcaggtggcagcaggggaacgtcttctcatgctccgtgatgcatgaggctctgcacaaccactacacgcagaagagcctgtccctgtctccgggtaaatgattaattaaggtaccaggtaagtgtacccaattcgccctatagtgagtcgtattacaattcactcgatcgcccttcccaacagttgcgcagcctgaatggcgaatggagatccaatttttaagtgtataatgtgttaaactactgattctaattgtttgtgtattttagattcacagtcccaaggctcatttcaggcccctcagtcctcacagtctgttcatgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttaacgcgtaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcaggtggcacttttcggggaaatgtgcgcggaacccctatttgtttatttttctaaatacattcaaatatgtatccgctcatgagacaataaccctgataaatgcttcaataatattgaaaaaggaagaatcctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggaggcctaggcttttgcaaagatcgatcaagagacaggatgaggatcgtttcgcatgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagaacatcaggggctcgcgccagccgaactgttcgccaggctcaaggcgagcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagaacttggcggcgaatgggctgaccgcttcctcgtgctttacggtatcgccgctcccgattcgcagcgcatcgccttctatcgccttcttgacgagttcttctgagcgggactctggggttcgaaatgaccgaccaagcgacgcccaacctgccatcacgagatttcgattccaccgccgccttctatgaaaggttgggcttcggaatcgttttccgggacgccggctggatgatcctccagcgcggggatctcatgctggagttcttcgcccaccctagggggaggctaactgaaacacggaaggagacaataccggaaggaacccgcgctatgacggcaataaaaagacagaataaaacgcacggtgttgggtcgtttgttcataaacgcggggttcggtcccagggctggcactctgtcgataccccaccgagaccccattggggccaatacgcccgcgtttcttccttttccccaccccaccccccaagttcgggtgaaggcccagggctcgcagccaacgtcggggcggcaggccctgccatagcctcaggttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcc

SEQ ID NO: 79 - DNA, 38 bp, artificial sequence
  chemically synthesized
cggcgcgccaccatggactggacctggaggatcctctt

SEQ ID NO: 80 - DNA, 48 bp, artificial sequence
  chemically synthesized
accaagaagaggatcctccaggtccagtccatggtggcgcgccgagct

SEQ ID NO: 81 - DNA, 44 bp, artificial sequence
  chemically synthesized
cttggtggcagcagccacaggagcccactcccagatgcaactgc

SEQ ID NO: 82 - DNA, 42 bp, artificial sequence
  chemically synthesized
tcgagcagttgcatctgggagtgggctcctgtggctgctgcc

SEQ ID NO: 83 - DNA, 69 bp, artificial sequence
  chemically synthesized
gaggagctcgaggcctccaccaagggcccatcggtcttccccctggcgccctgctccaggagcacctcc

SEQ ID NO: 84 - DNA, 42 bp, artificial sequence
  chemically synthesized
gaggagggtaccttaattaatcatttacccggagacagggag

SEQ ID NO: 85 - DNA, 4582 bp, artificial sequence
  chemically synthesized
atgcattagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctggtttagtgaaccgtcagatccgctagcgattacgccaagctcgaaattaaccctcactaaagggaacaaaagctggagctcggcgcgccaccatggactggacctggaggatcctcttcttggtggcagcagccacaggagcccactcccagatgcaactgctcgaggcctccaccaagggcccatcggtcttccccctggcgccctgctccaggagcacctccgagagcacagcggccctgggctgcctggtcaaggactacttccccgaaccggtgacggtgtcgtggaactcaggcgctctgaccagcggcgtgcacaccttcccagctgtcctacagtcctcaggactctactccctcagcagcgtggtgaccgtgccctccagcaacttcggcacccagacctacacctgcaacgtagatcacaagcccagcaacaccaaggtggacaagacagttgagcgcaaatgattaattaaggtaccaggtaagtgtacccaattcgccctatagtgagtcgtattacaattcactcgatcgcccttcccaacagttgcgcagcctgaatggcgaatggagatccaatttttaagtgtataatgtgttaaactactgattctaattgtttgtgtattttagattcacagtcccaaggctcatttcaggcccctcagtcctcacagtctgttcatgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttaacgcgtaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcaggtggcacttttcggggaaatgtgcgcggaacccctatttgtttatttttctaaatacattcaaatatgtatccgctcatgagacaataaccctgataaatgcttcaataatattgaaaaaggaagaatcctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggaggcctaggcttttgcaaagatcgatcaagagacaggatgaggatcgtttcgcatgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagaacatcaggggctcgcgccagccgaactgttcgccaggctcaaggcgagcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagaacttggcggcgaatgggctgaccgcttcctcgtgctttacggtatcgccgctcccgattcgcagcgcatcgccttctatcgccttcttgacgagttcttctgagcgggactctggggttcgaaatgaccgaccaagcgacgcccaacctgccatcacgagatttcgattccaccgccgccttctatgaaaggttgggcttcggaatcgttttccgggacgccggctggatgatcctccagcgcggggatctcatgctggagttcttcgcccaccctagggggaggctaactgaaacacggaaggagacaataccggaaggaacccgcgctatgacggcaataaaaagacagaataaaacgcacggtgttgggtcgtttgttcataaacgcggggttcggtcccagggctggcactctgtcgataccccaccgagaccccattggggccaatacgcccgcgtttcttccttttccccaccccaccccccaagttcgggtgaaggcccagggctcgcagccaacgtcggggcggcaggccctgccatagcctcaggttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcc

SEQ ID NO: 86 - DNA, 33 bp, artificial sequence
  chemically synthesized
gaggagctcgaggcctccaccaagggcccatcg

SEQ ID NO: 87 - DNA, 44 bp, artificial sequence
  chemically synthesized
gaggagggtaccttaattaatcatttgcgctcaactgtcttgtc

SEQ ID NO: 88 - DNA, 5269 bp, artificial sequence
  chemically synthesized
atgcattagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctggtttagtgaaccgtcagatccgctagcgattacgccaagctcgaaattaaccctcactaaagggaacaaaagctggagctcggcgcgccaccatggactggacctggaggatcctcttcttggtggcagcagccacaggagcccactcccagatgcaactgctcgaggcctccaccaagggcccatcggtcttccccctggcaccctcctccaagagcacctctgggggcacagcggccctgggctgcctggtcaaggactacttccccgaaccggtgacggtgtcgtggaactcaggcgccctgaccagcggcgtgcacaccttcccggctgtcctacagtcctcaggactctactccctcagcagcgtggtgaccgtgccctccagcagcttgggcacccagacctacatctgcaacgtgaatcacaagcccagcaacaccaaggtggacaagaaagttgagcccaaatcttgtgacaaaactcacacatgcccaccgtgcccagcacctgaactcctggggggaccgtcagtcttcctcttccccccaaaacccaaggacaccctcatgatctcccggacccctgaggtcacatgcgtggtggtggacgtgagccacgaagaccctgaggtcaagttcaactggtacgtggacggcgtggaggtgcataatgccaagacaaagccgcgggaggagcagtacaacagcacgtaccgtgtggtcagcgtcctcaccgtcctgcaccaggactggctgaatggcaaggagtacaagtgcaaggtctccaacaaagccctcccagcccccatcgagaaaaccatctccaaagccaaagggcagccccgagaaccacaggtgtacaccctgcccccatcccgggatgagctgaccaagaaccaggtcagcctgacctgcctggtcaaaggcttctatcccagcgacatcgccgtggagtgggagagcaatgggcagccggagaacaactacaagaccacgcctcccgtgctggactccgacggctccttcttcctctacagcaagctcaccgtggacaagagcaggtggcagcaggggaacgtcttctcatgctccgtgatgcatgaggctctgcacaaccactacacgcagaagagcctctccctgtctccgggtaaatgattaattaaggtaccaggtaagtgtacccaattcgccctatagtgagtcgtattacaattcactcgatcgcccttcccaacagttgcgcagcctgaatggcgaatggagatccaatttttaagtgtataatgtgttaaactactgattctaattgtttgtgtattttagattcacagtcccaaggctcatttcaggcccctcagtcctcacagtctgttcatgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttaacgcgtaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcaggtggcacttttcggggaaatgtgcgcggaacccctatttgtttatttttctaaatacattcaaatatgtatccgctcatgagacaataaccctgataaatgcttcaataatattgaaaaaggaagaatcctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggaggcctaggcttttgcaaagatcgatcaagagacaggatgaggatcgtttcgcatgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagaacatcaggggctcgcgccagccgaactgttcgccaggctcaaggcgagcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagaacttggcggcgaatgggctgaccgcttcctcgtgctttacggtatcgccgctcccgattcgcagcgcatcgccttctatcgccttcttgacgagttcttctgagcgggactctggggttcgaaatgaccgaccaagcgacgcccaacctgccatcacgagatttcgattccaccgccgccttctatgaaaggttgggcttcggaatcgttttccgggacgccggctggatgatcctccagcgcggggatctcatgctggagttcttcgcccaccctagggggaggctaactgaaacacggaaggagacaataccggaaggaacccgcgctatgacggcaataaaaagacagaataaaacgcacggtgttgggtcgtttgttcataaacgcggggttcggtcccagggctggcactctgtcgataccccaccgagaccccattggggccaatacgcccgcgtttcttccttttccccaccccaccccccaagttcgggtgaaggcccagggctcgcagccaacgtcggggcggcaggccctgccatagcctcaggttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcc

SEQ ID NO: 89 - DNA, 33 bp, artificial sequence
  chemically synthesized
caagggcccatcggtcttccccctggcaccctc

SEQ ID NO: 90 - DNA, 5273 bp, artificial sequence
  chemically synthesized
atgcattagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctggtttagtgaaccgtcagatccgctagcgattacgccaagctcgaaattaaccctcactaaagggaacaaaagctggagctcggcgcgccaccatggactggacctggaggatcctcttcttggtggcagcagccacaggagcccactcccagatgcaactgctcgaggcctccaccaagggcccatcggtcttccccctggcgccctgctccaggagcacctccgagagcacagcggccctgggctgcctggtcaaggactacttccccgaaccggtgacggtgtcgtggaactcaggcgccctgaccagcggcgtgcacaccttcccggctgtcctacagtcctcaggactctactccctcagcagcgtggtgaccgtgccctccagcagcttgggcacgaagacctacacctgcaatgtagatcacaagcccagcaacaccaaggtggacaagagagttgagtccaaatatggtcccccatgcccatcatgcccagcacctgagttcctggggggaccatcagtcttcctgttccccccaaaacccaaggacactctcatgatctcccggacccctgaggtcacgtgcgtggtggtggacgtgagccaggaagaccccgaggtccagttcaactggtacgtggatggcgtggaggtgcataatgccaagacaaagccgcgggaggagcagttcaacagcacgtaccgtgtggtcagcgtcctcaccgtcgtgcaccaggactggctgaacggcaaggagtacaagtgcaaggtctccaacaaaggcctcccgtcctccatcgagaaaaccatctccaaagccaaagggcagccccgagagccacaggtgtacaccctgcccccatcccaggaggagatgaccaagaaccaggtcagcctgacctgcctggtcaaaggcttctaccccagcgacatcgccgtggagtgggagagcaatgggcagccggagaacaactacaagaccacgcctcccgtgctggactccgacggctccttcttcctctacagcaggctaaccgtggacaagagcaggtggcaggaggggaatgtcttctcatgctccgtgatgcatgaggctctgcacaaccactacacgcagaagagcctctccctgtctctgggtaaatgagtgccagggccggttaattaaggtaccaggtaagtgtacccaattcgccctatagtgagtcgtattacaattcactcgatcgcccttcccaacagttgcgcagcctgaatggcgaatggagatccaatttttaagtgtataatgtgttaaactactgattctaattgtttgtgtattttagattcacagtcccaaggctcatttcaggcccctcagtcctcacagtctgttcatgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttaacgcgtaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcaggtggcacttttcggggaaatgtgcgcggaacccctatttgtttatttttctaaatacattcaaatatgtatccgctcatgagacaataaccctgataaatgcttcaataatattgaaaaaggaagaatcctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggaggcctaggcttttgcaaagatcgatcaagagacaggatgaggatcgtttcgcatgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagaacatcaggggctcgcgccagccgaactgttcgccaggctcaaggcgagcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagaacttggcggcgaatgggctgaccgcttcctcgtgctttacggtatcgccgctcccgattcgcagcgcatcgccttctatcgccttcttgacgagttcttctgagcgggactctggggttcgaaatgaccgaccaagcgacgcccaacctgccatcacgagatttcgattccaccgccgccttctatgaaaggttgggcttcggaatcgttttccgggacgccggctggatgatcctccagcgcggggatctcatgctggagttcttcgcccaccctagggggaggctaactgaaacacggaaggagacaataccggaaggaacccgcgctatgacggcaataaaaagacagaataaaacgcacggtgttgggtcgtttgttcataaacgcggggttcggtcccagggctggcactctgtcgataccccaccgagaccccattggggccaatacgcccgcgtttcttccttttccccaccccaccccccaagttcgggtgaaggcccagggctcgcagccaacgtcggggcggcaggccctgccatagcctcaggttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcc

SEQ ID NO: 91 - DNA, 44 bp, artificial sequence
  chemically synthesized
gaggagggtaccttaattaaccggccctggcactcatttaccca

SEQ ID NO: 92 - DNA, 28 bp, artificial sequence
  chemically synthesized
gcggccgagatcgagctcacncagwctc

SEQ ID NO: 93 - DNA, 23 bp, artificial sequence
  chemically synthesized
acctttgatatccagtcgtgtcc

SEQ ID NO: 94 - DNA, 23 bp, artificial sequence
  chemically synthesized
acctttgatatccasyttggtcc

SEQ ID NO: 95 - DNA, 27 bp, artificial sequence
  chemically synthesized
caggcggccgagatcgagctcabncar

SEQ ID NO: 96 - DNA, 27 bp, artificial sequence
  chemically synthesized
caggcggccgagatcgagctcabdcag

SEQ ID NO: 97 - DNA, 29 bp, artificial sequence
  chemically synthesized
caggcggccgagatcgagctcaykcagcc

SEQ ID NO: 98 - DNA, 27 bp, artificial sequence
  chemically synthesized
caggcggccgagatcgagctcacycar

SEQ ID NO: 99 - DNA, 28 bp, artificial sequence
  chemically synthesized
caggcggccgagatcgagctcactcagc

SEQ ID NO: 100 - DNA, 24 bp, artificial sequence
  chemically synthesized
accgccgaggatatccagctgggt

SEQ ID NO: 101 - DNA, 24 bp, artificial sequence
  chemically synthesized
accgcctaggatatcsascttggt

SEQ ID NO: 102 - DNA, 23 bp, artificial sequence
  chemically synthesized
saggtgcagctgctcgagtckgg

SEQ ID NO: 103 - DNA, 21 bp, artificial sequence
  chemically synthesized
gccactagtgaccgatgggcc

SEQ ID NO: 104 - DNA, 15920 bp, artificial sequence
  chemically synthesized
cgcgttttgagatttctgtcgccgactaaattcatgtcgcgcgatagtggtgtttatcgccgatagagatggcgatattggaaaaatcgatatttgaaaatatggcatattgaaaatgtcgccgatgtgagtttctgtgtaactgatatcgccatttttccaaaagtgatttttgggcatacgcgatatctggcgatagcgcttatatcgtttacgggggatggcgatagacgactttggtgacttgggcgattctgtgtgtcgcaaatatcgcagtttcgatataggtgacagacgatatgaggctatatcgccgatagaggcgacatcaagctggcacatggccaatgcatatcgatctatacattgaatcaatattggccattagccatattattcattggttatatagcataaatcaatattggctattggccattgcatacgttgtatccatatcataatatgtacatttatattggctcatgtccaacattaccgccatgttgacattgattattgactagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctcgtttagtgaaccgtcagatcgcctggagacgccatccacgctgttttgacctccatagaagacaccgggaccgatccagcctccgcggccgggaacggtgcattggaacgcggattccccgtgccaagagtgacgtaagtaccgcctatagagtctataggcccacccccttggcttcttatgcatgctatactgtttttggcttggggtctatacacccccgcttcctcatgttataggtgatggtatagcttagcctataggtgtgggttattgaccattattgaccactcccctattggtgacgatactttccattactaatccataacatggctctttgccacaactctctttattggctatatgccaatacactgtccttcagagactgacacggactctgtatttttacaggatggggtctcatttattatttacaaattcacatatacaacaccaccgtccccagtgcccgcagtttttattaaacataacgtgggatctccacgcgaatctcgggtacgtgttccggacatgggctcttctccggtagcggcggagcttctacatccgagccctgctcccatgcctccagcgactcatggtcgctcggcagctccttgctcctaacagtggaggccagacttaggcacagcacgatgcccaccaccaccagtgtgccgcacaaggccgtggcggtagggtatgtgtctgaaaatgagctcggggagcgggcttgcaccgctgacgcatttggaagacttaaggcagcggcagaagaagatgcaggcagctgagttgttgtgttctgataagagtcagaggtaactcccgttgcggtgctgttaacggtggagggcagtgtagtctgagcagtactcgttgctgccgcgcgcgccaccagacataatagctgacagactaacagactgttcctttccatgggtcttttctgcagtcaccgtccttgacacgaagctgtcgcgagtcgctagcaaggtttaaacgaattcattgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttatcatgtctggcggccgccgatatttgaaaatatggcatattgaaaatgtcgccgatgtgagtttctgtgtaactgatatcgccatttttccaaaagtgatttttgggcatacgcgatatctggcgatagcgcttatatcgtttacgggggatggcgatagacgactttggtgacttgggcgattctgtgtgtcgcaaatatcgcagtttcgatataggtgacagacgatatgaggctatatcgccgatagaggcgacatcaagctggcacatggccaatgcatatcgatctatacattgaatcaatattggccattagccatattattcattggttatatagcataaatcaatattggctattggccattgcatacgttgtatccatatcataatatgtacatttatattggctcatgtccaacattaccgccatgttgacattgattattgactagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctcgtttagtgaaccgtcagatcgcctggagacgccatccacgctgttttgacctccatagaagacaccgggaccgatccagcctccgcggccgggaacggtgcattggaacgcggattccccgtgccaagagtgacgtaagtaccgcctatagagtctataggcccacccccttggcttcttatgcatgctatactgtttttggcttggggtctatacacccccgcttcctcatgttataggtgatggtatagcttagcctataggtgtgggttattgaccattattgaccactcccctattggtgacgatactttccattactaatccataacatggctctttgccacaactctctttattggctatatgccaatacactgtccttcagagactgacacggactctgtatttttacaggatggggtctcatttattatttacaaattcacatatacaacaccaccgtccccagtgcccgcagtttttattaaacataacgtgggatctccacgcgaatctcgggtacgtgttccggacatgggctcttctccggtagcggcggagcttctacatccgagccctgctcccatgcctccagcgactcatggtcgctcggcagctccttgctcctaacagtggaggccagacttaggcacagcacgatgcccaccaccaccagtgtgccgcacaaggccgtggcggtagggtatgtgtctgaaaatgagctcggggagcgggcttgcaccgctgacgcatttggaagacttaaggcagcggcagaagaagatgcaggcagctgagttgttgtgttctgataagagtcagaggtaactcccgttgcggtgctgttaacggtggagggcagtgtagtctgagcagtactcgttgctgccgcgcgcgccaccagacataatagctgacagactaacagactgttcctttccatgggtcttttctgcagtcaccgtccttgacacgaagcttggcgcgccctttaattaagactcgagcaattcattgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttatcatgtctggatcctctagaattcagcaaggtcgccacgcacaagatcaatattaacaatcagtcatctctctttagcaataaaaaggtgaaaaattacattttaaaaatgacaccatagacgatgtatgaaaataatctacttggaaataaatctaggcaaagaagtgcaagactgttacccagaaaacttacaaattgtaaatgagaggttagtgaagatttaaatgaatgaagatctaaataaacttataaattgtgagagaaattaatgaatgtctaagttaatgcagaaacggagagacatactatattcatgaactaaaagacttaatattgtgaaggtatactttcttttcacataaatttgtagtcaatatgttcaccccaaaaaagctgtttgttaacttgtcaacctcatttcaaaatgtatatagaaagcccaaagacaataacaaaaatattcttgtagaacaaaatgggaaagaatgttccactaaatatcaagatttagagcaaagcatgagatgtgtggggatagacagtgaggctgataaaatagagtagagctcagaaacagacccattgatatatgtaagtgacctatgaaaaaaatatggcattttacaatgggaaaatgatgatctttttcttttttagaaaaacagggaaatatatttatatgtaaaaaataaaagggaacccatatgtcataccatacacacaaaaaaattccagtgaattataagtctaaatggagaaggcaaaactttaaatcttttagaaaataatatagaagcatgccatcatgacttcagtgtagagaaaaatttcttatgactcaaagtcctaaccacaaagaaaagattgttaattagattgcatgaatattaagacttatttttaaaattaaaaaaccattaagaaaagtcaggccatagaatgacagaaaatatttgcaacaccccagtaaagagaattgtaatatgcagattataaaaagaagtcttacaaatcagtaaaaaataaaactagacaaaaatttgaacagatgaaagagaaactctaaataatcattacacatgagaaactcaatctcagaaatcagagaactatcattgcatatacactaaattagagaaatattaaaaggctaagtaacatctgtggcaatattgatggtatataaccttgatatgatgtgatgagaacagtactttaccccatgggcttcctccccaaacccttaccccagtataaatcatgacaaatatactttaaaaaccattaccctatatctaaccagtactcctcaaaactgtcaaggtcatcaaaaataagaaaagtctgaggaactgtcaaaactaagaggaacccaaggagacatgagaattatatgtaatgtggcattctgaatgagatcccagaacagaaaaagaacagtagctaaaaaactaatgaaatataaataaagtttgaactttagttttttttaaaaaagagtagcattaacacggcaaagtcattttcatatttttcttgaacattaagtacaagtctataattaaaaattttttaaatgtagtctggaacattgccagaaacagaagtacagcagctatctgtgctgtcgcctaactatccatagctgattggtctaaaatgagatacatcaacgctcctccatgttttttgttttctttttaaatgaaaaactttattttttaagaggagtttcaggttcatagcaaaattgagaggaaggtacattcaagctgaggaagttttcctctattcctagtttactgagagattgcatcatgaatgggtgttaaattttgtcaaatgctttttctgtgtctatcaatatgaccatgtgattttcttctttaacctgttgatgggacaaattacgttaattgattttcaaacgttgaaccacccttacatatctggaataaattctacttggttgtggtgtatattttttgatacattcttggattctttttgctaatattttgttgaaaatgtttgtatctttgttcatgagagatattggtctgttgttttcttttcttgtaatgtcattttctagttccggtattaaggtaatgctggcctagttgaatgatttaggaagtattccctctgcttctgtcttctgaaagagattgtagaaagttgatacaatttttttttctttaaatatcttgatagaattctagaggatcgatccccgccgccggacgaactaaacctgactacggcatctctgccccttcttcgcggggcagtgcatgtaatcccttcagttggttggtacaacttgccaactgggccctgttccacatgtgacacggggggggaccaaacacaaaggggttctctgactgtagttgacatccttataaatggatgtgcacatttgccaacactgagtggctttcatcctggagcagactttgcagtctgtggactgcaacacaacattgcctttatgtgtaactcttggctgaagctcttacaccaatgctgggggacatgtacctcccaggggcccaggaagactacgggaggctacaccaacgtcaatcagaggggcctgtgtagctaccgataagcggaccctcaagagggcattagcaatagtgtttataaggcccccttgttaaccctaaacgggtagcatatgcttcccgggtagtagtatatactatccagactaaccctaattcaatagcatatgttacccaacgggaagcatatgctatcgaattagggttagtaaaagggtcctaaggaacagcgatatctcccaccccatgagctgtcacggttttatttacatggggtcaggattccacgagggtagtgaaccattttagtcacaagggcagtggctgaagatcaaggagcgggcagtgaactctcctgaatcttcgcctgcttcttcattctccttcgtttagctaatagaataactgctgagttgtgaacagtaaggtgtatgtgaggtgctcgaaaacaaggtttcaggtgacgcccccagaataaaatttggacggggggttcagtggtggcattgtgctatgacaccaatataaccctcacaaaccccttgggcaataaatactagtgtaggaatgaaacattctgaatatctttaacaatagaaatccatggggtggggacaagccgtaaagactggatgtccatctcacacgaatttatggctatgggcaacacataatcctagtgcaatatgatactggggttattaagatgtgtcccaggcagggaccaagacaggtgaaccatgttgttacactctatttgtaacaaggggaaagagagtggacgccgacagcagcggactccactggttgtctctaacacccccgaaaattaaacggggctccacgccaatggggcccataaacaaagacaagtggccactcttttttttgaaattgtggagtgggggcacgcgtcagcccccacacgccgccctgcggttttggactgtaaaataagggtgtaataacttggctgattgtaaccccgctaaccactgcggtcaaaccacttgcccacaaaaccactaatggcaccccggggaatacctgcataagtaggtgggcgggccaagataggggcgcgattgctgcgatctggaggacaaattacacacacttgcgcctgagcgccaagcacagggttgttggtcctcatattcacgaggtcgctgagagcacggtgggctaatgttgccatgggtagcatatactacccaaatatctggatagcatatgctatcctaatctatatctgggtagcataggctatcctaatctatatctgggtagcatatgctatcctaatctatatctgggtagtatatgctatcctaatttatatctgggtagcataggctatcctaatctatatctgggtagcatatgctatcctaatctatatctgggtagtatatgctatcctaatctgtatccgggtagcatatgctatcctaatagagattagggtagtatatgctatcctaatttatatctgggtagcatatactacccaaatatctggatagcatatgctatcctaatctatatctgggtagcatatgctatcctaatctatatctgggtagcataggctatcctaatctatatctgggtagcatatgctatcctaatctatatctgggtagtatatgctatcctaatttatatctgggtagcataggctatcctaatctatatctgggtagcatatgctatcctaatctatatctgggtagtatatgctatcctaatctgtatccgggtagcatatgctatcctcatgcatatacagtcagcatatgatacccagtagtagagtgggagtgctatcctttgcatatgccgccacctcccaagggggcgtgaattttcgctgcttgtccttttcctgcatgctggttgctcccattcttaggtgaatttaaggaggccaggctaaagccgtcgcatgtctgattgctcaccaggtaaatgtcgctaatgttttccaacgcgagaaggtgttgagcgcggagctgagtgacgtgacaacatgggtatgcccaattgccccatgttgggaggacgaaaatggtgacaagacagatggccagaaatacaccaacagcacgcatgatgtctactggggatttattctttagtgcgggggaatacacggcttttaatacgattgagggcgtctcctaacaagttacatcactcctgcccttcctcaccctcatctccatcacctccttcatctccgtcatctccgtcatcaccctccgcggcagccccttccaccataggtggaaaccagggaggcaaatctactccatcgtcaaagctgcacacagtcaccctgatattgcaggtaggagcgggctttgtcataacaaggtccttaatcgcatccttcaaaacctcagcaaatatatgagtttgtaaaaagaccatgaaataacagacaatggactcccttagcgggccaggttgtgggccgggtccaggggccattccaaaggggagacgactcaatggtgtaagacgacattgtggaatagcaagggcagttcctcgccttaggttgtaaagggaggtcttactacctccatatacgaacacaccggcgacccaagttccttcgtcggtagtcctttctacgtgactcctagccaggagagctcttaaaccttctgcaatgttctcaaatttcgggttggaacctccttgaccacgatgctttccaaaccaccctccttttttgcgcctgcctccatcaccctgaccccggggtccagtgcttgggccttctcctgggtcatctgcggggccctgctctatcgctcccgggggcacgtcaggctcaccatctgggccaccttcttggtggtattcaaaataatcggcttcccctacagggtggaaaaatggccttctacctggagggggcctgcgcggtggagacccggatgatgatgactgactactgggactcctgggcctcttttctccacgtccacgacctctccccctggctctttcacgacttccccccctggctctttcacgtcctctaccccggcggcctccactacctcctcgaccccggcctccactacctcctcgaccccggcctccactgcctcctcgaccccggcctccacctcctgctcctgcccctcctgctcctgcccctcctcctgctcctgcccctcctgcccctcctgctcctgcccctcctgcccctcctgctcctgcccctcctgcccctcctgctcctgcccctcctgcccctcctcctgctcctgcccctcctgcccctcctcctgctcctgcccctcctgcccctcctgctcctgcccctcctgcccctcctgctcctgcccctcctgcccctcctgctcctgcccctcctgctcctgcccctcctgctcctgcccctcctgctcctgcccctcctgcccctcctgcccctcctcctgctcctgcccctcctgctcctgcccctcctgcccctcctgcccctcctgctcctgcccctcctcctgctcctgcccctcctgcccctcctgcccctcctcctgctcctgcccctcctgcccctcctcctgctcctgcccctcctcctgctcctgcccctcctgcccctcctgcccctcctcctgctcctgcccctcctgcccctcctcctgctcctgcccctcctcctgctcctgcccctcctgcccctcctgcccctcctcctgctcctgcccctcctcctgctcctgcccctcctgcccctcctgcccctcctgcccctcctcctgctcctgcccctcctcctgctcctgcccctcctgctcctgcccctcccgctcctgctcctgctcctgttccaccgtgggtccctttgcagccaatgcaacttggacgtttttggggtctccggacaccatctctatgtcttggccctgatcctgagccgcccggggctcctggtcttccgcctcctcgtcctcgtcctcttccccgtcctcgtccatggttatcaccccctcttctttgaggtccactgccgccggagccttctggtccagatgtgtctcccttctctcctaggccatttccaggtcctgtacctggcccctcgtcagacatggtaaatcgatggccatggtggccacgtgttcacgacacctgaaatggaagaaaaaaactttgaaccactgtctgaggcttgagaatgaaccaagatccaaactcaaaaaggccaaattccaaggagaattacatcaagtgccaagctggcctaacttcagtctccacccactcagtgtggggaaactccatcgcataaaacccctccccccaacctaaagacgacgtactccaaaagctccagaactaatcgaggtgcctggacggcgcccggtactccgtggagtcacatgaagcgacggctgaggacggaaaggcccttttcctttgtgtgggtgactcacccgcccgctctcccgagcgccgcgtcctccattttgagccccctggagcagggccgggaagcggccatctttccgctcacgcaactggtgccgaccgggccagccttgccgcccagggcggggcgatacacggcggcgcgaggccaggcaccagagcaggccggccagcttgagactacccccgtccgattctcggtggccgcgctcgcaggccccgcctcgccgaacatgtgcgctgggacgcacgggccccgtcgccggccgcgggcccaaaaaccgaaataccagtgtgcagatcctggcccgcatttacaagactatcttgccagaaaaaaagcgtcgcagcaggtcatcaaaaattttaaatggctagagacttatcgaaagcagcgagacaggcgcgaaggtgccaccagattcgcacgcggcggccccagcgcccaggccaggcctcaactcaagcacgaggcgaaggggctcctaaagcgcaaggcccgcccctggctccagctcgggatcaagaatcacgtactggagccaggtggaagtaattcaaggcacgcaagggccataacccgtaaagaggccaggcccgcgggaaccacacacggcacttacctgtgttctggcggcaaacccgttgcgaaaaagaacgttcacggcgactactgcacttatatacggttctcccccaccctcgggaaaaaggcggagccagtacacgacatcactttcccagtttaccccgcgccaccttctctaggcaccggttcaattgccgacccctccccccaacttctcggggactgtgggcgatgtgcgctctgcccactgacgggcaccggagcctcacgaagcttgaattcggtaccatcgatgataagctgtcaaacatgagaattcttgaagacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtgttgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgcagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctgcgccgcgtgcggctgctggagatggcggacgcgatggatatgttctgccaagggttggtttgcgcattcacagttctccgcaagaattgattggctccaattcttggagtggtgaatccgttagcgaggccatccagcctcgcgtcgaactagatgatccgctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggagggtgaccgccacgaggtgccgccaccatcccctgacccacgcccctgacccctcacaaggagacgaccttccatgaccgagtacaagcccacggtgcgcctcgccacccgcgacgacgtcccccgggccgtacgcaccctcgccgccgcgttcgccgactaccccgccacgcgccacaccgtcgaccccgaccgccacatcgaacgcgtcaccgagctgcaagaactcttcctcacgcgcgtcgggctcgacatcggcaaggtgtgggtcgcggacgacggcgccgcggtggcggtctggaccacgccggagagcgtcgaagcgggggcggtgttcgccgagatcggcccgcgcatggccgagttgagcggttcccggctggccgcgcagcaacagatggaaggcctcctggcgccgcaccggcccaaggagcccgcgtggttcctggccaccgtcggcgtctcgcccgaccaccagggcaagggtctgggcagcgccgtcgtgctccccggagtggaggcggccgagcgcgccggggtgcccgccttcctggagacctccgcgccccgcaacctccccttctacgagcggctcggcttcaccgtcaccgccgacgtcgagtgcccgaaggaccgcgcgacctggtgcatgacccgcaagcccggtgcctgacgcccgccccacgacccgcagcgcccgaccgaaaggagcgcacgacccggtccgacggcggcccacgggtcccaggggggtcgacctcgaaacttgtttattgcagcttataatggttacaaataaagcaatagcatcacaaatttcacaaataaagcatttttttcactgcattctagttgtggtttgtccaaactcatcaatgtatcttatcatgtctggatcgatccgaaccccttcctcgaccaattctcatgtttgacagcttatcatcgcagatccgggcaacgttgttgcattgctgcaggcgcagaactggtaggtatggaagatctgggg

SEQ ID NO: 105 - protein, 21 aa, Mus musculus
METDTLLLWVLLLWVPGSTGD

SEQ ID NO: 106 - protein, 51 aa, Homo sapiens
RNAVGQDTQEVIVVPHSLPFKVVVISAILALVVLTIISLIILIMLWQKKPR

SEQ ID NO: 107 - protein, 18 aa, artificial sequence
  chemically synthesized
GGSSRSSSSGGGGSGGGG

SEQ ID NO: 108 - protein, 10 aa, artificial sequence
  chemically synthesized
YPYDVPDYAS

SEQ ID NO: 109 - protein, 225 aa, artificial sequence
  chemically synthesized
THTCPPCPAPEAEGAPSVFLFPPKPKDTLMISRTPEVTCVVVDVSHEDPEVKFNWYVDGVEVHNAKTKPREEQYNSTYRVVSVLTVLHQDWLNGKEYKCKVSNKALPASIEKTISKAKGQPREPQVYTLPPSRDELTKNQVSLTCLVKGFYPSDIAVEWESNGQPENNYKTTPPVLDSDGSFFLYSKLTVDKSRWQQGNVFSCSVMHEALHNHYTQKSLSLSPGK

SEQ ID NO: 110 - DNA, 4613 bp, artificial sequence
  chemically synthesized
gagctggctagcgccaccatggcctgggctctgctcctcctcaccctcctcactcagggcacagggtcctgggcccagtctgagctcctgcaggaattcgatatcctaggtcagcccaaggctgccccctcggtcactctgttcccgccctcctctgaggagcttcaagccaacaaggccacactggtgtgtctcataagtgacttctacccgggagccgtgacagtggcctggaaggcagatagcagccccgtcaaggcgggagtggagaccaccacaccctccaaacaaagcaacaacaagtacgcggccagcagctatctgagcctgacgcctgagcagtggaagtcccacagaagctacagctgccaggtcacgcatgaagggagcaccgtggagaagacagtggcccctacagaatgttcataggtttaaacggtaccaggtaagtgtacccaattcgccctatagtgagtcgtattacaattcactcgatcgcccttcccaacagttgcgcagcctgaatggcgaatggagatccaatttttaagtgtataatgtgttaaactactgattctaattgtttgtgtattttagattcacagtcccaaggctcatttcaggcccctcagtcctcacagtctgttcatgatcataatcagccataccacatttgtagaggttttacttgctttaaaaaacctcccacacctccccctgaacctgaaacataaaatgaatgcaattgttgttgttaacttgtttattgcagcttataatggttacaaataaagcaatagcatcacaaatttcacaaataaagcatttttttcactgcattctagttgtggtttgtccaaactcatcaatgtatcttaacgcgtaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcaggtggcacttttcggggaaatgtgcgcggaacccctatttgtttatttttctaaatacattcaaatatgtatccgctcatgagacaataaccctgataaatgcttcaataatattgaaaaaggaagaatcctgaggcggaaagaaccagctgtggaatgtgtgtcagttagggtgtggaaagtccccaggctccccagcaggcagaagtatgcaaagcatgcatctcaattagtcagcaaccaggtgtggaaagtccccaggctccccagcaggcagaagtatgcaaagcatgcatctcaattagtcagcaaccatagtcccgcccctaactccgcccatcccgcccctaactccgcccagttccgcccattctccgccccatggctgactaattttttttatttatgcagaggccgaggccgcctcggcctctgagctattccagaagtagtgaggaggcttttttggaggcctaggcttttgcaaagatcgatcaagagacaggatgaggatcgtttcgcatgattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaagacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagaacatcaggggctcgcgccagccgaactgttcgccaggctcaaggcgagcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagaacttggcggcgaatgggctgaccgcttcctcgtgctttacggtatcgccgctcccgattcgcagcgcatcgccttctatcgccttcttgacgagttcttctgagcgggactctggggttcgaaatgaccgaccaagcgacgcccaacctgccatcacgagatttcgattccaccgccgccttctatgaaaggttgggcttcggaatcgttttccgggacgccggctggatgatcctccagcgcggggatctcatgctggagttcttcgcccaccctagggggaggctaactgaaacacggaaggagacaataccggaaggaacccgcgctatgacggcaataaaaagacagaataaaacgcacggtgttgggtcgtttgttcataaacgcggggttcggtcccagggctggcactctgtcgataccccaccgagaccccattggggccaatacgcccgcgtttcttccttttccccaccccaccccccaagttcgggtgaaggcccagggctcgcagccaacgtcggggcggcaggccctgccatagcctcaggttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgccatgcattagttattaatagtaatcaattacggggtcattagttcatagcccatatatggagttccgcgttacataacttacggtaaatggcccgcctggctgaccgcccaacgacccccgcccattgacgtcaataatgacgtatgttcccatagtaacgccaatagggactttccattgacgtcaatgggtggagtatttacggtaaactgcccacttggcagtacatcaagtgtatcatatgccaagtacgccccctattgacgtcaatgacggtaaatggcccgcctggcattatgcccagtacatgaccttatgggactttcctacttggcagtacatctacgtattagtcatcgctattaccatggtgatgcggttttggcagtacatcaatgggcgtggatagcggtttgactcacggggatttccaagtctccaccccattgacgtcaatgggagtttgttttggcaccaaaatcaacgggactttccaaaatgtcgtaacaactccgccccattgacgcaaatgggcggtaggcgtgtacggtgggaggtctatataagcagagctggtttagtgaaccgtcagatccgctagcgattacgccaagctcgaaattaaccctcactaaagggaacaaaagctg

SEQ ID NO: 111 - DNA, 45 bp, artificial sequence
  chemically synthesized
ggctagcgccaccatggcctgggctctgctcctcctcaccctcct

SEQ ID NO: 112 - DNA, 43 bp, artificial sequence
  chemically synthesized
gtgaggaggagcagagcccaggccatggtggcgctagccagct

SEQ ID NO: 113 - DNA, 42 bp, artificial sequence
  chemically synthesized
cactcagggcacagggtcctgggcccagtctgagctcctgca

SEQ ID NO: 114 - DNA, 44 bp, artificial sequence
  chemically synthesized
ggagctcagactgggcccaggaccctgtgccctgagtgaggagg

SEQ ID NO: 115 - DNA, 35 bp, artificial sequence
  chemically synthesized
gaggaggatatcctaggtcagcccaaggctgcccc

SEQ ID NO: 116 - DNA, 41 bp, artificial sequence
  chemically synthesized
gaggagggtaccgtttaaacctatgaacattctgtaggggc

SEQ ID NO: 117 - DNA, 1075 bp, artificial sequence
  chemically synthseized
ggcgcgccaccatggactggacctggaggatcctcttcttggtggcagcagccacaggagcccactcccagatgcaactgctcgaggcctccaccaagggcccatcggtcttccccctggcgccctgctccaggagcacctccgagagcacagcggccctgggctgcctggtcaaggactacttccccgaaccggtgacggtgtcgtggaactcaggcgctctgaccagcggcgtgcacaccttcccagctgtcctacagtcctcaggactctactccctcagcagcgtggtgaccgtgccctccagcaacttcggcacccagacctacacctgcaacgtagatcacaagcccagcaacaccaaggtggacaagacagttgagcgcaaatgttgtgtcgagtgcccaccgtgcccagcaccacctgtggcaggaccgtcagtcttcctcttccccccaaaacccaaggacaccctcatgatctcccggacccctgaggtcacgtgcgtggtggtggacgtgagccacgaagaccccgaggtccagttcaactggtacgtggacggcgtggaggtgcataatgccaagacaaagccacgggaggagcagttcaacagcacgttccgtgtggtcagcgtcctcaccgttgtgcaccaggactggctgaacggcaaggagtacaagtgcaaggtctccaacaaaggcctcccagcccccatcgagaaaaccatctccaaaaccaaagggcagccccgagaaccacaggtgtacaccctgcccccatcccgggaggagatgaccaagaaccaggtcagcctgacctgcctggtcaaaggcttctaccccagcgacatcgccgtggagtgggagagcaatgggcagccggagaacaactacaagaccacacctcccatgctggactccgacggctccttcttcctctacagcaagctcaccgtggacaagagcaggtggcagcaggggaacgtcttctcatgctccgtgatgcatgaggctctgcacaaccactacacgcagaagagcctgtccctgtctccgggtaaatgattaattaa

SEQ ID NO: 118 - DNA, 1087 bp, artificial sequence
  chemically synthesized
ggcgcgccaccatggactggacctggaggatcctcttcttggtggcagcagccacaggagcccactcccagatgcaactgctcgaggcctccaccaagggcccatcggtcttccccctggcaccctcctccaagagcacctctgggggcacagcggccctgggctgcctggtcaaggactacttccccgaaccggtgacggtgtcgtggaactcaggcgccctgaccagcggcgtgcacaccttcccggctgtcctacagtcctcaggactctactccctcagcagcgtggtgaccgtgccctccagcagcttgggcacccagacctacatctgcaacgtgaatcacaagcccagcaacaccaaggtggacaagaaagttgagcccaaatcttgtgacaaaactcacacatgcccaccgtgcccagcacctgaactcctggggggaccgtcagtcttcctcttccccccaaaacccaaggacaccctcatgatctcccggacccctgaggtcacatgcgtggtggtggacgtgagccacgaagaccctgaggtcaagttcaactggtacgtggacggcgtggaggtgcataatgccaagacaaagccgcgggaggagcagtacaacagcacgtaccgtgtggtcagcgtcctcaccgtcctgcaccaggactggctgaatggcaaggagtacaagtgcaaggtctccaacaaagccctcccagcccccatcgagaaaaccatctccaaagccaaagggcagccccgagaaccacaggtgtacaccctgcccccatcccgggatgagctgaccaagaaccaggtcagcctgacctgcctggtcaaaggcttctatcccagcgacatcgccgtggagtgggagagcaatgggcagccggagaacaactacaagaccacgcctcccgtgctggactccgacggctccttcttcctctacagcaagctcaccgtggacaagagcaggtggcagcaggggaacgtcttctcatgctccgtgatgcatgaggctctgcacaaccactacacgcagaagagcctctccctgtctccgggtaaatgattaattaa

SEQ ID NO: 119 - DNA, 1091 bp, artificial sequence
  chemically synthesized
ggcgcgccaccatggactggacctggaggatcctcttcttggtggcagcagccacaggagcccactcccagatgcaactgctcgaggcctccaccaagggcccatcggtcttccccctggcgccctgctccaggagcacctccgagagcacagcggccctgggctgcctggtcaaggactacttccccgaaccggtgacggtgtcgtggaactcaggcgccctgaccagcggcgtgcacaccttcccggctgtcctacagtcctcaggactctactccctcagcagcgtggtgaccgtgccctccagcagcttgggcacgaagacctacacctgcaatgtagatcacaagcccagcaacaccaaggtggacaagagagttgagtccaaatatggtcccccgtgcccatcatgcccagcacctgaattcctggggggaccatcagtcttcctgttccccccaaaacccaaggacaccctcatgatctcccggacccctgaggtcacgtgcgtggtggtggacgtgagccaggaagaccccgaggtccagttcaactggtacgtggatggcgtggaggtgcataatgccaagacaaagccgcgggaggagcagttcaacagcacgtaccgtgtggtcagcgtcctcaccgtcgtgcaccaggactggctgaacggcaaggagtacaagtgcaaggtctccaacaaaggcctcccgtcctccatcgagaaaaccatctccaaagccaaagggcagccccgagagccacaggtgtacaccctgcccccatcccaggaggagatgaccaagaaccaggtcagcctgacctgcctggtcaaaggcttctaccccagcgacatcgccgtggagtgggagagcaatgggcagccggagaacaactacaagaccacgcctcccgtgctggactccgacggctccttcttcctctacagcaggctaaccgtggacaagagcaggtggcaggaggggaatgtcttctcatgctccgtgatgcatgaggctctgcacaaccactacacgcagaagagcctctccctgtctctgggtaaatgagtgccagggccggttaattaa

SEQ ID NO: 120 - DNA, 400 bp, artificial sequence
  chemically synthesized
ggcgcgccaccatggactggacctggaggatcctcttcttggtggcagcagccacaggagcccactcccagatgcaactgctcgaggcctccaccaagggcccatcggtcttccccctggcgccctgctccaggagcacctccgagagcacagcggccctgggctgcctggtcaaggactacttccccgaaccggtgacggtgtcgtggaactcaggcgctctgaccagcggcgtgcacaccttcccagctgtcctacagtcctcaggactctactccctcagcagcgtggtgaccgtgccctccagcaacttcggcacccagacctacacctgcaacgtagatcacaagcccagcaacaccaaggtggacaagacagttgagcgcaaatgattaattaa

SEQ ID NO: 121 - DNA, 443 bp, artificial sequence
  chemically synthesized
gctagcgccaccatggacatgagggtccccgctcagctcctggggctcctgctactctggctccgaggtgccagatgtgacatcgagctcctgcaggaattcgatatcaaacgaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgacgctgagcaaagcagactacgagaaacacaaagtctacgcctgcgaagtcacccatcagggcctgagttcgcccgtcacaaagagcttcaacaggggagagtgttaggtttaaac

SEQ ID NO: 122 - DNA, 431 bp, artificial sequence
  chemically synthesized
gctagcgccaccatggcctgggctctgctcctcctcaccctcctcactcagggcacagggtcctgggcccagtctgagctcctgcaggaattcgatatcctaggtcagcccaaggctgccccctcggtcactctgttcccgccctcctctgaggagcttcaagccaacaaggccacactggtgtgtctcataagtgacttctacccgggagccgtgacagtggcctggaaggcagatagcagccccgtcaaggcgggagtggagaccaccacaccctccaaacaaagcaacaacaagtacgcggccagcagctatctgagcctgacgcctgagcagtggaagtcccacagaagctacagctgccaggtcacgcatgaagggagcaccgtggagaagacagtggcccctacagaatgttcataggtttaaac

SEQ ID NO: 123 - DNA, 21 bp, artificial sequence
  chemically synthesized
agcgggggcttgccggccctg

SEQ ID NO: 124 - protein, 27 aa, artificial sequence
  chemically synthesized
PLGFFPDHQLDPAFRANTANPDWDFNP

(19) United States
(12) Patent Application Publication
(10) Pub. No.: US 2010/0292089 A1
(43) Pub. Date: Nov. 18, 2010

(54) SELECTION OF HUMAN MONOCLONAL ANTIBODIES BY MAMMALIAN CELL DISPLAY

(75) Inventors: Martin F. Bachmann, Seuzach (CH); Monika Bauer, Zurich (CH); Roger Beerli, Adlikon (CH)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: Cytos Biotechnology AG, Zurich-Schlieren (CH)

(21) Appl. No.: 12/312,372

(22) PCT Filed: Oct. 26, 2007
(86) PCT No.: PCT/EP2007/061570

§ 371 Date: Dec. 18, 2009

(30) Foreign Application Priority Data
Nov. 7, 2006 (EP) 06123620.4

(51) Int. Cl. C40B 30/04

(52) U.S. Cl. 506/9

(57) ABSTRACT

The application provides a method of isolating a eukaryotic cell expressing an antibody of desired specificity, preferably a monoclonal single chain antibody (scFv). The application further provides methods which allow to clone the variable regions of said antibody from that isolated eukaryotic cell and to recombinantly produce antibodies comprising said variable regions as fusion protein with a purification tag, eg. as Fc-fusion, as a Fab fragment, or as whole antibodies, such as IgG, IgE, IgD, IgA and IgM. Said methods also allows to recombinantly produce antibodies with desired specificity in a fully species specific form, preferably as fully human antibodies.

### FIELD OF THE INVENTION

The present invention is related to the fields of vaccinology, monoclonal antibodies and medicine. The invention provides methods for generating and selecting a eukaryotic cell expressing and displaying on its surface an antibody, preferably a single chain monoclonal antibody (e.g. scFv) which is capable of specifically binding an antigen of interest. Said cell is selected from a populations of eukaryotic, preferably mammalian, cells expressing a library of the variable regions of immunoglobulins derived from B cells which were pre-selected for their specificity towards said antigen of interest. The variable regions of the antibody with the desired specificity can be (i) cloned from the selected eukaryotic cell, (ii) reassembled to a species specific, preferably to a fully human, recombinant monoclonal antibody (mAb), and (iii) produced in large scale by expression in vitro. Recombinant antibodies comprising said variable regions can be expressed in various forms, including scFv fusions, Fab fragments, and whole antibodies such as IgG, IgE, IgD, IgA and IgM. Monoclonal antibodies produced by the method of the invention may be used for research purposes, diagnostic purposes or the treatment of diseases.

### RELATED ART

Monoclonal antibodies (mAbs) have proven their usefulness as tools for a wide spectrum of research and diagnostic applications as well as in therapeutic applications. Monoclonal antibodies generated by the conventional hybridoma technology comprise mouse sequences, giving rise to an undesired immune response against the foreign sequence when administered to humans. Such an anti-immunoglobuline responses can interfere with therapy (Miller et al. 1983, Blood 62:988-995) or cause allergic or immune complex hypersensitivity (Ratner B., Allergy, Anaphylaxis and Immunotherapy, Basic Principles and Practice, William & Wilkins Company, Baltimore, 1943).

Humanized antibodies (GB 2188638 B, 1987; Riechmann et al. 1988 Nature 332:323-327; Foote and Winter 1992 Mol. Biol. 224:487-499) or fully human antibodies (Mendez 1997, Nat Genet. 15:146-156) are therefore becoming increasingly important for the treatment of a growing number of diseases, including cancer, heart disease, infection and immune disorders.

Given the usefulness of mAbs in general, and the enormous therapeutic and commercial potential of human mAbs in particular, a lot of effort has been put into the development of screening platforms allowing for the isolation of mAbs with predetermined selectivity.

The numerous strategies available for production of recombinant antibodies have been reviewed recently (Hoogenboom 2005, Nature Biotechnol. 23:1105-1116). In each case, a number of consecutive steps are involved: (1) cloning of the immunological diversity contained in the antibodies' variable regions by recombinant DNA technology; (2) expression of such antibody libraries using a suitable expression system, thereby coupling phenotype (i.e. the expressed antibody) with genotype (i.e. the nucleic acid encoding it); (3) application of an appropriate selective pressure, typically selection for binding to antigen; and (4) amplification of the selected antibody-encoding clones, leading to an enrichment of specific binders. Typically, antibody libraries are enriched by several such rounds of selection before individual clones are analyzed.

The most frequently used screening methods for the isolation of recombinant antibodies are phage display (Hoogenboom 2002, Methods Mol. Biol. 178:1-37), ribosome/mRNA display (Lipovsek and Plückthun 2004, J. Immunol. Method 290:51-67) and microbial cell display (Boder and Wittrup 1997, Nat. Biotechnol. 15:553-557). While each of these screening platforms has its specific advantages, they share the same drawback: they are all based on expression of antibodies in an unnatural environment, namely in bacteria (phage display), in vitro in a test tube (ribosome/mRNA display), or in yeast (microbial cell display). It is important to remember that the chemical and physical properties of antibodies are very variable due to the sequence variability inherent to this class of proteins. Therefore, every screening method involving the expression of antibodies under such unnatural conditions is likely to lead to a strongly biased set of antibodies, by selecting not only for the desired binding properties, but also for chemical and physical properties advantageous under the respective screening conditions. In contrast, a selection platform based on the expression of antibodies in their natural environment, i.e. the secretory pathway of mammalian cells, ensures that all the cellular components normally involved in antibody synthesis and processing (folding, disulfide bond formation, glycosylation etc.) are available in a physiological form and concentration. Therefore, screening for antibodies in a mammalian expression/selection system is likely to yield a set of antibodies much less biased by properties other than binding to the desired antigen.

Currently, there are two reports of screening systems based on cell surface expression of antibodies in mammalian cells. One screening system is based on Vaccinia virus-mediated expression of whole antibodies in mammalian cells (US2002/0123057A1). With this method, antibody heavy and light chain libraries are expressed from separate vectors, by consecutive infection and transfection: the heavy chains are expressed in target cells using a high-titer vaccinia virus heavy chain library, such that each cell produces in average one heavy chain; the light chains are shortly after expressed in these infected cells by transfection of a light chain plasmid library. This leads to libraries of cells, each expressing one heavy chain paired with an undefined number of different light chains, which can be screened for binding to antigen. However, there are significant drawbacks to this method: Two separate libraries need to be constructed and transferred to target cells for expression and screening. In addition, the method initially selects only for a specific heavy chain, and the matching light chain has to be isolated in a second screen. Finally, similar to phage and ribosome/mRNA display, multiple selection rounds have to be carried out, both for the initial isolation of the heavy chain, as well as for the identification of the matching light chain.

A second screening system based on cell surface expression of antibodies in mammalian cells has been described recently (Ho et al. 2006, Proc. Natl. Acad. Sci. USA 103:9637-9642). In this method, a scFv library is expressed in HEK-293T cells via transfection of plasmid DNA. This leads to pools of transfected cells expressing pools of scFv antibodies on their surface (i.e. more than one antibody per cell is displayed), which can be screened for binding to antigen. The scFv display method described by Ho et al. suffers from two main disadvantages. First, transfection is not the optimal method to introduce an antibody expression library into cells, since all transfection methods lead to the delivery of an undefined number of plasmid molecules to each cell. Thus, each transfected cell expresses an undefined number of different antibodies, further increasing the selective disadvantage of poorly expressed or otherwise problematic antibodies. Second, since the enrichment was reported to be only about 240-fold, also this method requires multiple rounds of selection to be carried out in order to isolate an antibody of interest from a complex library.

One major drawback of performing antibody screens in mammalian cells is the limited number of antibodies that can be screened. This is in part due to the relatively small numbers of cells that can be handled at a time.

Thus, whereas phage display routinely allows for the screening of 10¹² to even 10¹³ clones in a single panning round (Barbas III et al. (eds.), Phage Display—A Laboratory manual, Cold Spring Harbour Press, 2001), the throughput of a mammalian screening procedure in a one antibody per cell formant is limited to the concomitant analysis of about 10⁶ to 10⁷ clones.

### SUMMARY OF THE INVENTION

We herein describe for the first time a screening platform for the isolation of species specific, preferably human, antibodies specifically binding an antigen of interest, that profits from the advantages of a mammalian cell-based expression system, while circumventing the disadvantages specific to the methods described above. A particular advantage of the screening platform described herein is the fact that it can be performed in a “one antibody per cell” format, which is preferred because it allows the screen to be completed in one single round of selection.

The invention provides a method of generating, selecting and isolating a cell expressing an antibody of desired specificity, preferably a monoclonal single chain antibody, most preferably a scFv. The invention also provides methods which allow to clone the variable regions of said antibody from that isolated cell and to recombinantly produce antibodies comprising said variable regions as fusion protein with a purification tag, eg. as Fc-fusion, as Fab fragment. The invention further provides methods which allow to clone the variable regions of said antibody from that isolated cell and to recombinantly produce whole antibodies comprising said variable regions, preferably as IgG1, IgG2 or IgG4. Said methods also allows to recombinantly produce antibodies with desired specificity in a fully species specific form, preferably as fully human antibodies.

It has surprisingly been found that the combination of pre-selection of antigen specific B cells with eukaryotic, preferably mammalian cell display of antibodies in a one antibody per cell format allows to set up an antibody screen which is complete after only one single round of screening.

Thus, one aspect of the invention is a method of isolating a cell expressing an antibody specifically binding an antigen of interest, said method comprising the steps of: (a) providing a population of B cells; (b) selecting from said population of B cells a sub-population of B cells by selecting B cells for their capability of specifically binding said antigen of interest; (c) generating an expression library, wherein each member of said expression library encodes an antibody comprising at least one variable region (VR), by (i) generating a multitude of DNA molecules, wherein said generating comprises the step of amplifying a pool of DNA molecules from said sub-population of B cells, wherein each of said DNA molecules of said pool of DNA molecules encodes one of said at least one variable region (VR); and (ii) cloning said multitude of DNA molecules into an expression vector; (d) introducing said expression library into a first population of eukaryotic, preferably mammalian cells; (c) displaying antibodies of said expression library on the surface of said eukaryotic, preferably mammalian cells; and (f) isolating from said first population of eukaryotic, preferably mammalian cells a cell, wherein said cell is selected for the capability of the antibody displayed on its surface of specifically binding said antigen of interest or a fragment or antigenic determinant thereof.

A further aspect of the invention is a method of isolating a cell expressing an antibody specifically binding an antigen of interest, said method comprising the steps of: (a) selecting from a population of isolated B cells a sub-population of B cells by selecting B cells for their capability of specifically binding said antigen of interest; (b) generating an expression library, wherein each member of said expression library encodes an antibody comprising at least one variable region (VR), by (i) generating a multitude of DNA molecules, wherein said generating comprises the step of amplifying a pool of DNA molecules from said sub-population of B cells, wherein each of said DNA molecules of said pool of DNA molecules encodes one of said at least one variable region (VR); and (ii) cloning said multitude of DNA molecules into an expression vector; (c) introducing said expression library into a first population of eukaryotic, preferably mammalian cells; (d) displaying antibodies of said expression library on the surface of said eukaryotic, preferably mammalian cells; and (e) isolating from said first population of eukaryotic, preferably mammalian cells a cell, wherein said cell is selected for the capability of the antibody displayed on its surface of specifically binding said antigen of interest or a fragment or antigenic determinant thereof.

The use of alphaviral expression libraries allows for an extraordinarily high screening efficiency. Thus, a further aspect of the invention is a method of isolating a cell expressing an antibody specifically binding an antigen of interest, said method comprising the steps of: (a) selecting from a population of isolated B cells a sub-population of B cells by selecting B cells for their capability of specifically binding said antigen of interest; (b) generating an alphaviral expression library, wherein each member of said alphaviral expression library encodes an antibody comprising at least one variable region (VR), by (i) generating a multitude of DNA molecules, wherein said generating comprises the step of amplifying a pool of DNA molecules from said sub-population of B cells, wherein each of said DNA molecules of said pool of DNA molecules encodes one of said at least one variable region (VR); and (ii) cloning said multitude of DNA molecules into an alphaviral expression vector; (c) introducing said alphaviral expression library into a first population of eukaryotic, preferably mammalian cells; (d) displaying antibodies of said alphaviral expression library on the surface of said eukaryotic, preferably mammalian cells; and (e) isolating from said first population of eukaryotic, preferably mammalian cells a cell, wherein said cell is selected for the capability of the antibody displayed on its surface of specifically binding said antigen of interest or a fragment or antigenic determinant thereof.

A further aspect of the invention is a method of isolating a cell expressing an antibody specifically binding an antigen of interest, said method comprising the steps of: (a) selecting from a population of isolated B cells a sub-population of B cells by selecting B cells for their capability of specifically binding said antigen of interest; (b) generating an alphaviral expression library, said generating comprising the steps of (i) generating a multitude of DNA molecules encoding antibodies, said generating a multitude of DNA molecules comprising the steps of: (1) amplifying from said sub-population of B cells a first pool of DNA molecules encoding HCVRs; (2) amplifying from said sub-population of B cells a second pool of DNA molecules encoding LCVRs; and (3) linking specimens of said first and of said second pool of DNA molecules to each other by a DNA encoding a linker region (LR); (ii) cloning a specimen of said multitude of DNA molecules into an alphaviral expression vector; wherein each member of said alphaviral expression library encodes an antibody comprising a signal peptide, a HCVR, a LCVR and a transmembrane region, wherein said HCVR and said LCVR are linked to each other by said linker region; (c) introducing said alphaviral expression library into a first population of eukaryotic, preferably mammalian cells; (d) displaying antibodies of said alphaviral expression library on the surface of said eukaryotic, preferably mammalian cells; and (e) isolating from said first population of eukaryotic, preferably mammalian cells a cell, wherein said cell is selected for the capability of the antibody displayed on its surface of specifically binding said antigen of interest or a fragment or antigenic determinant thereof.

A further aspect of the invention is a method of isolating a cell expressing an antibody specifically binding an antigen of interest, said method comprising the steps of (a) selecting from a population of isolated B cells a sub-population of B cells by selecting B cells for their capability of specifically binding said antigen of interest; (b) generating an alphaviral expression library, said generating comprising the steps of: (i) generating a multitude of DNA molecules encoding antibodies, said generating comprising the steps of: (1) isolating RNA from said sub-population of B cells; (2) transcribing said RNA to cDNA; (3) amplifying from said cDNA said first pool of DNA molecules using a first mixture of oligonucleotides comprising at least two oligonucleotides capable of amplifying HCVR coding regions; (4) amplifying from said cDNA said second pool of DNA molecules using a second mixture of oligonucleotides comprising at least two oligonucleotides capable of amplifying LCVR coding regions; and (5) linking specimens of said first and said second pool of DNA molecules to each other by a DNA encoding said linker region; (ii) cloning a specimen of said multitude of DNA molecules into an alphaviral expression vector; wherein each member of said alphaviral expression library encodes an antibody comprising a signal peptide, a HCVR, a LCVR and a transmembrane region, wherein said HCVR and said LCVR are linked to each other by said linker region; (c) introducing said alphaviral expression library into a first population of eukaryotic, preferably mammalian cells; (d) displaying antibodies of said alphaviral expression library on the surface of said eukaryotic, preferably mammalian cells; and (e) isolating from said first population of eukaryotic, preferably mammalian cells a cell, wherein said cell is selected for the capability of the antibody displayed on its surface of specifically binding said antigen of interest or a fragment or antigenic determinant thereof.

A further aspect of the invention is a method of producing an antibody specifically binding an antigen of interest, said method comprising the steps of: (a) isolating a cell expressing an antibody according to any one of the methods above; (b) obtaining RNA from said isolated cell; (c) synthesizing cDNA encoding said antibody from said RNA; (d) cloning said cDNA into an expression vector, preferably an alphaviral expression vector; (e) generating a fusion construct encoding a fusion product comprising said antibody and said purification tag; (f) expressing said fusion product in a cell, preferably a mammalian cell; and (g) purifying said fusion product.

A further aspect of the invention is a method of producing an antibody specifically binding an antigen of interest, said method comprising the steps of: (a) isolating a cell expressing an antibody according to any one of the methods above; (b) obtaining RNA from said cell; (c) synthesizing cDNA form said RNA; (d) amplifying from said cDNA a DNA encoding VRs of said antibody expressed by said cell; (e) generating an expression construct comprising said DNA, wherein said expression construct is encoding at least one VR of said antibody expressed by said cell; (f) expressing said expression construct in a cell.

The invention also relates to an expression vector for displaying polypeptides, preferably antibodies, on the surface of a eukaryotic, preferably mammalian cell. A further aspect of the invention is therefore an expression vector, preferably an alphaviral expression vector, wherein said expression vector comprises DNA elements encoding a signal peptide, a transmembrane region and, preferably, a detection tag, and wherein further preferably said expression vector, preferably said alphaviral expression vector, comprises a restriction site allowing the cloning, preferably the orientation specific cloning, of DNA molecules encoding said polypeptides, preferably said antibody variable regions, into said expression vector.

A further aspect of the invention is an expression library comprising said expression vector, wherein preferably said expression library is an alphaviral expression library and said expression vector is an alphaviral expression vector.

A further aspect of the invention is a eukaryotic, preferably mammalian, cell comprising said expression vector, preferably said alphaviral expression vector, or comprising at least one specimen of said expression library, preferably of said alphaviral expression library.

All embodiments described herein shall refer to all aspects of the invention and may be combined in any possible combination.

### DETAILED DESCRIPTION OF THE INVENTION

“Animal”: As used herein, the term “animal” refers to any organism comprising an immune system capable of producing antibodies. Preferred animals in the context of the invention are fish, amphibians, birds, reptiles, and mammals, preferably artiodactyls, rodents and primates. In a preferred embodiment said animal is selected from the group consisting of sheep, elk, deer, donkey, mule deer, mink, horse, cattle, pig, goat, dog, cat, rat, hamster, guinea pig, and mouse. In a further preferred embodiment said animal is a mouse, a rat or, most preferably, a primate. In a further preferred embodiment said animal is a non-human primate or a human, most preferably a human. In a further preferred embodiment said animal is a humanized mouse, e.g. as described as a source for humanized antibodies in (Lonberg (2005), Nature Biotechnology 23(9):1117-1125). In a further preferred embodiment the animal is a humanized mouse or a human, preferably a human.

“Antibody”: As used herein, the term “antibody” refers to a molecule, preferably a protein, which is capable of specifically binding an antigen, typically and preferably by binding an epitope or antigenic determinant or said antigen. The term antibody refers to whole antibodies, preferably of the IgG, IgA, IgE, IgM, or IgD class, more preferably of the IgG class, most preferably IgG1, IgG2, IgG3, and IgG4, and antigen-binding fragments thereof, including single chain antibodies, wherein further preferably said whole antibodies comprise either a kappa or a lambda light chain. The term “antibody” also refers to antigen binding antibody fragments, preferably to proteolytic fragments and their recombinant analogues, most preferably to Fab, Fab′ and F(ab′)2, Fd, and Fv. The term “antibody” further encompasses proteins comprising at least one, preferably two variable regions. Preferred antibodies are single chain antibodies, preferably scFvs, disulfide-linked Fvs (sdFv) and fragments comprising either a light chain variable region (LCVR) or a heavy chain variable region (HCVR). In the context of the invention the term “antibody” also refers to recombinant antibodies, preferably to recombinant proteins consisting of a single polypeptide, wherein said polypeptide comprises at least one variable region, preferably two variable regions, most preferably at least one, preferably one, HCVR and at least one, preferably one LCVR. In the context of the invention recombinant antibodies may further comprise functional elements, such as, for example, a linker region, a transmembrane region, a signal peptide or hydrophobic leader sequence, a detection tag and/or a purification tag.

“Fv”: The term Fv refers to the smallest proteolytic fragment of an antibody capable of binding an antigen and to recombinant analogues of said fragment.

“single chain antibody”: A single chain antibody is an antibody consisting of a single polypeptide. Preferred single chain antibodies consist of a polypeptide comprising a single VR, preferably a single HCVR. More preferred single chain antibodies are scFv, wherein said scFv consist of a single polypeptide comprising exactly one HCVR and exactly one LCVR, wherein said HCVR and said LCVR are linked to each other by a linker region, wherein preferably said linker region consists of at least 15, preferably of 15 to 20 amino acids (Bird et al. (1988) Science, 242(4877):423-426). Further preferred single chain antibodies are scFv, wherein said scFv are encoded by a coding region, wherein said coding region, in 5′ to 3′ direction, comprises in the following order: (1) a light chain variable region (LCVR) consisting of light chain framework (LFR) 1, complementary determining region (LCDR) 1, LFR 2, LCDR 2, LFR3, LCDR3 and LFR4 from a κ or λ light chain; (2) a flexible linker (L), and (3) a heavy chain variable region (HCVR) consisting of framework (HFR) 1, complementary determining region (HCDR) 1, HFR 2, HCDR 2, HFR3, HCDR3 and HFR4. Alternatively, single chain antibodies are scFv, wherein said scFv are encoded by a coding region, wherein said coding region, in 5′ to 3′ direction, comprises in the following order: (1) a heavy chain variable region (HCVR) consisting of framework (HFR) 1, complementary determining region (HCDR) 1, HFR 2, HCDR 2, HFR3, HCDR3 and HFR4; (2) a flexible linker (L), and (3) a light chain variable region (LCVR) consisting of light chain framework (LFR) 1, complementary determining region (LCDR) 1, LFR 2, LCDR 2, LFR3, LCDR3 and LFR4 from a κ or λ light chain.

“diabody”: The term “diabody” refers to an antibody comprising two polypeptide chains, preferably two identical polypeptide chains, wherein each polypeptide chain comprises a HCVR and a LCVR, wherein said HCVR and said LCVR are linked to each other by a linker region, wherein preferably said linker region comprises at most 10 amino acids (Huston et al. (1988), PNAS 85(16):587958-83; Holliger et al. (1993), PNAS 90(14):6444-6448, Hollinger & Hudson, 2005, Nature Biotechnology 23(9):1126-1136; Arndt et al. (2004) FEBS Letters 578(3):257-261). Preferred linker regions of diabodies comprise 0, 1, 2, 3, 4, 5, 6, 7, 8, 9, or 10 amino acids.

“species specific antibody”: The term “species specific antibody” refers to an antibody, preferably to a recombinant antibody, comprising variable and preferably also constant regions of only one single animal species. Preferred species specific antibodies are mouse antibodies, rat antibodies and human antibodies, most preferably human antibodies.

“human antibodies” and “fully human antibodies”: As used herein, the term “human antibody” refers to an antibody, preferably a recombinant antibody, essentially having the amino acid sequence of a human immunoglobulin, or a fragment thereof, and includes antibodies isolated from human immunoglobulin libraries. In the context of the invention “human antibodies” may comprise a limited number of amino acid exchanges as compared to the sequence of a native human antibody. Such amino acid exchanges can, for example, be caused by cloning procedures. However, the number of such amino acid exchanges in human antibodies of the invention is preferably minimized; most preferably, the amino acid sequence of human antibodies is at least 95%, more preferably at least 96%, still more preferably 97%, still more preferably 98%, still more preferably 99% and most preferably 100% identical to that of native human antibodies. Preferred recombinant human antibodies differ from native human antibodies in at most 20, 15, 10, 9, 8, 7, 6, 5, 4, 3, 2, or 1 amino acid. Very preferably, differences in the amino acid sequence of recombinant human antibodies and native human antibodies are eliminated my means of molecular cloning, and thus, most preferably, the amino acid sequence of recombinant human antibodies and native human antibodies are identical. Such antibodies are also referred to as “fully human antibodies”.

Preferred recombinant human antibodies comprise at least one, preferably one, heavy chain variable region and at least one, preferably one, heavy chain constant region, wherein said at least one heavy chain variable region is at least 95%, more preferably at least 96%, still more preferably 97%, still more preferably 98%, still more preferably 99% and most preferably 100% identical to a native human heavy chain variable region; and wherein said at least one heavy chain constant region is at least 95%, more preferably at least 96%, still more preferably 97%, still more preferably 98%, still more preferably 99% and most preferably 100% identical to a native human heavy chain constant region.

Further preferred recombinant human antibodies comprise at least one, preferably one, light chain variable region and at least one, preferably one, light chain constant region, wherein said at least one light chain variable region is at least 95%, more preferably at least 96%, still more preferably 97%, still more preferably 98%, still more preferably 99% and most preferably 100% identical to a native human light chain variable region; and wherein said at least one light chain constant region is at least 95%, more preferably at least 96%, still more preferably 97%, still more preferably 98%, still more preferably 99% and most preferably 100% identical to a native human light chain constant region.

Preferred human antibodies comprise least one, preferably one, heavy chain variable region and at least one, preferably one, heavy chain constant region, at least one, preferably one, light chain variable region and at least one, preferably one, light chain constant region, wherein said at least one light chain variable region is at least 95%, more preferably at least 96%, still more preferably 97%, still more preferably 98%, still more preferably 99% and most preferably 100% identical to a native human light chain variable region; and wherein said at least one heavy chain variable region, said at least one heavy chain constant region, said at least one light chain constant region and said at least one light chain constant region is at least 95%, more preferably at least 96%, still more preferably 97%, still more preferably 98%, still more preferably 99% and most preferably 100% identical to the respective native human regions.

“humanized antibodies”: As used herein, the term “humanized antibody” refers to antibodies wherein the antigen-binding parts of the antibody are derived from a non-human species and the remaining parts of the humanized antibody comprise or preferably entirely consist of a human amino acid sequence. The generation of humanized antibodies is within the skill of the artisan. The basic technology for the generation of humanized antibodies is, for example, disclosed in GB 2188638 B, Riechmann et al. (1988) Nature 332:323-327, and Foote and Winter (1992) Mol. Biol. 224:487-499. Preferred humanized antibodies are mouse antibodies, wherein the constant regions, more preferably the constant regions and the VR framework regions are exchanged by the corresponding human sequences (“CDR grafting”).

“monoclonal antibody”: As used herein, the term “monoclonal antibody” refers to an antibody population comprising only one single antibody species, i.e. antibodies having an identical amino acid sequence.

“constant region (CR)”: The term “constant region” refers to a light chain constant region (LCCR) or a heavy chain constant region (HCCR) of an antibody. Typically and preferably, said CR comprises one to four immunoglobulin domains characterized by disulfide stabilized loop structures. Preferred CRs are CRs, preferably kappa CRs or lambda CRs, of immunoglobulins, preferably of human immunoglobulins, wherein further preferably said immunoglobulins, preferably said human immunoglobulins, are selected from the group consisting of IgG1, IgG2, IgG3, IgG4, IgA, IgE, IgM, and IgD. Very preferred CRs are human CRs comprising or consisting of an amino acid sequence available from public databases, including, for example the Immunogenetic Information System (http://imgt.cines.fr/).

light chain constant region (LCCR): The LCCR, more specifically the kappa LCCR or the lambda LCCR, typically represents the C-terminal half of a native kappa or lambda light chain of an native antibody. A LCCR typically comprises about 110 amino acids representing one immunoglobulin domain.

heavy chain constant region (HCCR): The constant region of a heavy chain comprises about three quarters or more of the heavy chain of an antibody and is situated at its C-terminus. Typically the HCCR comprises either three or four immunoglobulin domains.

“variable region (VR)”: Refers to the variable region or variable domain of an antibody, more specifically to the heavy chain variable region (HCVR) or to the light chain variable region (LCVR). Typically and preferably, a VR comprises a single immunoglobulin domain. Preferred VRs are VRs of immunoglobulins, preferably of human immunoglobulins, wherein further preferably said immunoglobulins, preferably said human immunoglobulins, are selected from the group consisting of IgG1, IgG2, IgG3, IgG4, IgA, IgE, IgM, and IgD. VRs of various species are known in the art. Preferred VRs are human VRs, wherein said human VRs exhibit at least 80%, preferably at least 90%, more preferably at least 95%, most preferably at least 99% sequence identity with any known human VR sequence, preferably with any human VR sequence available from public databases, most preferably with any human VR available from the Immunogenetics Information System (http://imgt.cines fr/).

“light chain variable region (LCVR)”: Light chain variable regions are encoded by rearranged nucleic acid molecules and are either a kappa LCVR or a lambda LCVR. In the context of the invention preferred kappa LCVRs are human kappa LCVRs, preferably human kappa LCVRs which are encoded by a DNA which can be amplified from human B cells using a primer combination of any one of SEQ ID NO:49 to 52 with any one of SEQ ID NO:53 to 56, and further preferably, PCR conditions described in Example 3.

In the context of the invention preferred lambda LCVRs are human lambda LCVRs, preferably human lambda LCVRs which are encoded by a DNA which can be amplified from human B cells using a primer combination of any one of SEQ ID NO:57 to 65 with any one of SEQ ID NO:66 to 68, and further preferably, PCR conditions described in Example 3.

“heavy chain variable region (HCVR)”: Heavy chain variable regions are encoded by rearranged nucleic acid molecules. In the context of the invention preferred HCVRs are human HCVRs, preferably human HCVRs which are encoded by a DNA which can be amplified from human B cells using a primer combination of any one of SEQ ID NO:42 to 47 with SEQ ID NO:48 and, further preferably, PCR conditions described in Example 3.

“antibody coding region”: As used herein, the term “antibody coding region” refers to any DNA encoding an antibody or an element thereof. Preferably, “antibody coding regions” refers to a DNA encoding a CR, preferably a HCCR or LCCR, or a VR, preferably a HCVR or a LCVR, of an antibody. Very preferred antibody coding regions are DNA fragments representing human antibody coding regions, preferably human VR coding regions, most preferably human VR coding regions which can be amplified from human B cells using any combination of primers of SEQ ID NO:42 to 68 and, further preferably, PCR conditions described in Example 3.

Preferred antibody coding regions are human kappa LCVR coding regions, preferably human kappa LCVR coding regions which can be amplified from human B cells using a primer combination of any one of SEQ ID NO:49 to 52 with any one of SEQ ID NO:53 to 56, and further preferably, PCR conditions described in Example 3.

Further preferred antibody coding regions are human lambda LCVR coding regions, preferably human lambda LCVR coding regions which can be amplified from human B cells using a primer combination of any one of SEQ ID NO:57 to 65 with any one of SEQ ID NO:66 to 68, and further preferably, PCR conditions described in Example 3.

Further preferred antibody coding regions are human HCVR coding regions, preferably human HCVR coding regions which can be amplified from human B cells using a primer combination of any one of SEQ ID NO:42 to 47 with SEQ ID NO:48 and, further preferably, PCR conditions described in Example 3.

“antigen”: As used herein, the term “antigen” refers to a molecule which is bound by an antibody. Typically, an antigen is recognized by the immune system and/or by a humoral immune response and can have one or more epitopes, preferably B-cell epitopes, or antigenic determinants. The term antigen refers to protein and non-protein antigens. In the context of the invention, the term antigen shall also refer to haptens.

“hapten”: The term hapten refers to a small molecule which is not recognized by the immune system in free form but which is recognized by the immune system when bound to a carrier, preferably to an immunogenic carrier. Preferred haptens are peptides, preferably peptides of protein antigens, wherein said peptides of protein antigens most preferably consist of 2 to 200, preferably 2 to 100, and most preferably of 2 to 50 amino acids. In a preferred embodiment said peptides of protein antigens consist of about 6 to about 30 amino acids. Further preferred haptens are selected from (a) opioids; (b) morphine derivatives, preferably selected from codeine, fentanyl, heroin, morphium and opium; (c) stimulants, preferably selected from amphetamine, cocaine, MDMA (methylenedioxymethamphetamine), methamphetamine, methylphenidate and nicotine; (d) hallucinogens, preferably LSD, mescaline, psilocybin, and cannabinoids.

“antigen of interest”: The application provides methods for the selection of cells expressing antibodies with a desired specificity and to methods of producing such antibodies, i.e. the antibodies of the invention are capable of binding an antigen of interest. Typically and preferably, said antigen of interest is a protein antigen, a non-protein antigen or a hapten. The antigen of interest is preferably selected from the group consisting of (a) antigen of a microorganism or of a pathogen, (b) tumor antigen, (c) self antigen, and (d) allergen. Very preferably, said antigen of interest is a hapten.

“fragment of the antigen of interest”: The term “fragment of an antigen of interest” refers to a fragment of an antigen, preferably of a polypeptide, comprising at least one antigenic determinant of said antigen. In a preferred embodiment a fragment of the antigen of interest is a polypeptide consisting of a stretch, preferably a consecutive stretch, of amino acids derived from said antigen of interest, wherein said polypeptide can be bound by an antibody. Typically and preferably, said fragment comprises at least 80, preferably at least 90, more preferably at least 95, still more preferably at least 99 and most preferably 100% sequence identity with said antigen of interest. Typically and preferably, a fragment of the antigen of interest is a polypeptide consisting of 6 to 1000, preferably 6 to 500, more preferably 6 to 300, still more preferably 6 to 200, still more preferably 6 to 100 amino acids. Very preferred are fragments consisting of about 10, 20, 30, 40, 50, 60, 70, 80, 90 or 100 amino acids.

“antigen of a microorganisms or pathogen”: An antigen of a microorganism or pathogen preferably is an antigen of infectious virus, infectious bacteria, parasites or infectious fungi. Such antigens include the intact microorganism or pathogen as well as natural isolates and fragments or derivatives thereof and also synthetic or recombinant compounds which are identical to or similar to natural microorganism antigens and induce an immune response specific for that microorganism. A compound is similar to an antigen of a microorganism or pathogen if it induces an immune response (humoral and/or cellular) to a natural microorganism antigen. Examples of infectious viruses, bacteria, and infectious fungi that are microbial antigen as used herein, are described in WO03/024481 (page 23 last paragraph to page 25 third paragraph), the disclosure of which is incorporated herein by reference.

“tumor antigen”: A tumor antigen is a compound, such as a peptide, associated with a tumor or cancer and which can be bound by an antibody. Tumor antigens can be prepared from cancer cells either by preparing crude extracts of cancer cells, for example, as described in Cohen, et al., Cancer Research, 54:1055 (1994), by partially purifying the antigens, by recombinant technology or by de novo synthesis of known antigens. Tumor antigens include antigens that are antigenic portions of or are a whole tumor or cancer polypeptide. Such antigens can be isolated or prepared recombinantly or by any other means known in the art. Cancers or tumors include, but are not limited to, biliary tract cancer; brain cancer; breast cancer; cervical cancer; choriocarcinoma; colon cancer; endometrial cancer; esophageal cancer; gastric cancer; intraepithelial neoplasms; lymphomas; liver cancer; lung cancer (e.g. small cell and non-small cell); melanoma; neuroblastomas; oral cancer; ovarian cancer; pancreas cancer; prostate cancer; rectal cancer; sarcomas; skin cancer; testicular cancer; thyroid cancer; and renal cancer, as well as other carcinomas and sarcomas.

“self antigen”: As used herein, the term “self antigen” refers, with respect to an animal, to proteins encoded by the DNA of said animal and products generated by proteins or RNA encoded by the DNA of said animal. Preferably, the term “self antigen”, as used herein, refers to proteins encoded by the human genome or DNA and products generated by proteins or RNA encoded by the human genome or DNA are defined as self. In one embodiment, self antigens are proteins that result from a combination of two or more self-molecules or fragments of self-molecules and proteins that have a sequence identity of at least 95%, preferably at least 97%, more preferably at least 99% are also considered to be self antigens.

“Allergens”: The term “allergen”, as used herein, also encompasses “allergen extracts” and “allergenic epitopes” which are capable of inducing an allergic reaction of the immune system of an animal. Preferred allergens are pollen (e.g. grass, ragweed, birch and mountain cedar); house dust and dust mites; mammalian epidermal allergens and animal danders; mold and fungus; insect bodies and insect venom; feathers; food; and drugs (e.g., penicillin).

“antigenic determinant”: As used herein, the term “antigenic determinant” is meant to refer to that portion of an antigen that is specifically recognized by B-lymphocytes. B-lymphocytes respond to foreign antigenic determinants by antibody production.

“specifically binding” (antibody/antigen): The specificity of an antibody relates to the antibody's capability of specifically binding an antigen. The specificity of this interaction between the antibody and the antigen (affinity) is characterized by a binding constant or, inversely, by a dissociation constant (Kd). It is to be understood that the apparent affinity of an antibody to an antigen in a multivalent interaction depends on the structure of the antibody and of the antigen, and on the actual assay conditions. The apparent affinity of an antibody to an antigen in a multivalent interaction may be significantly higher than in a monovalent interaction due to avidity. Thus, affinity is preferably determined under conditions favoring monovalent interactions. Kd can be determined by methods known in the art. Kd of a given combination of antibody and antigen is preferably determined by ELISA, most preferably by an ELISA essentially as described in Example 7, wherein a constant amount of immobilized antigen is contacted with a serial dilution of a known concentration of a purified antibody, preferably a monovalent antibody, for example scFv or Fab fragment. Kd is then determined as the concentration of the antibody where half-maximal binding is observed. Alternatively, Kd of a monovalent interaction of an antibody and an antigen is determined by Biacore analysis as the ratio of on rate (kₒₙ) and off rate (k_{off}.). Lower values of Kd indicate a stronger binding of the antibody to the antigen than higher values of Kd. Thus, in the context of the application, an antibody is considered to be “specifically binding an antigen (of interest)”, when the dissociation constant (Kd), preferably determined as described above, and further preferably determined in a monovalent interaction, is at most 1 mM (<=10⁻³ M), preferably at most 1 μM (<=10⁻⁶M), most preferably at most 1 nM (<=10⁻⁹M). Very preferred are antibodies capable of binding an antigen with a Kd of less than 1 nM (<10⁻⁹M, “subnanomolar”), wherein further preferably Kd is determined in a monovalent interaction. Further preferred antibodies are capable of binding an antigen with a Kd of 0.01 to 10 nM, more preferably of 0.01 to 5 nM, still more preferably of 0.01 to 3 nM, most preferably of 0.1 to 2 nM, wherein further preferably Kd is determined in a monovalent interaction. Still further preferred antibodies are capable of binding an antigen with a Kd of 0.1 to 50 nM, more preferably of 1.0 to 50 nM, still more preferably of 1.0 to 30 nM, most preferably of 0.1 to 2 nM, wherein further preferably Kd is determined in a monovalent interaction.

“specifically binding” (antibody displayed on a cell/antigen): With respect to an antibody displayed on a mammalian cell the specificity of the binding of an antigen is preferably determined in an fluorescence assay essentially as set forth herein in Example 4, wherein the intensity of a fluorescence signal is correlated with the amount of antigen bound by a cell displaying said antibody. Antibodies displayed on mammalian cells are regarded as specifically binding an antigen, when the intensity of the fluorescence signal is higher than the signal detected for control cells. Preferably, said signal is at least two times higher than that of control cells.

“B-cell”: As used herein, the term “B-cell” refers to a cell produced in the bone marrow of an animal expressing membrane-bound antibody specific for an antigen. Following interaction with the antigen it differentiates into a plasma cell producing antibodies specific for the antigen or into a memory B-cell.

“Antigen-specific B cell”: As used herein, the term “antigen-specific B cell” refers to a B cell which expresses antibodies that are able to distinguish between the antigen of interest and other antigens and which specifically bind to that antigen of interest with high or low affinity but which do not bind to other antigens.

“Memory B-cell”: As used herein, “memory B-cell” refers to a B-cell sub-type that is formed following a primary contact with the antigen of interest. When a B-cell is activated, by specifically recognizing the antigen of interest, it proliferates to form antibody producing plasma cells and long-lived memory B cells. These memory B cells are specific for the antigen of interest that stimulated their production. If this antigen of interest is encountered again, memory B cells can recognize it and quickly proliferate.

“immunizing”: As used herein the term immunizing means administering to an animal the antigen of interest, a fragment or antigenic determinant thereof, preferably together with an adjuvant in a dose capable of inducing a detectable immune response, preferably a B-cell response.

“Tag”: The term tag, preferably a purification or detection tag, refers to a polypeptide segment that can be attached to a second polypeptide to provide for purification or detection of the second polypeptide or provides sites for attachment of the second polypeptide to a substrate. In principle, any peptide or protein for which an antibody or other specific binding agent is available can be used as an affinity tag. Tags include haemagglutinin tag, myc tag, poly-histidine tag, protein A, glutathione S transferase, Glu-Glu affinity tag, substance P, FLAG peptide, streptavidine binding peptide, or other antigenic epitope or binding domain (mostly taken from U.S. Pat. No. 6,686,168).

“expression library”: The term expression library refers to a multitude of expression vectors of the same type, wherein individual expression vectors expresses a different polypeptide, e.g. a different antibody. Preferred expression libraries are viral expression libraries, most preferably alphaviral expression libraries. Alphaviral expression libraries are preferred because of their capability of self-replication. Furthermore, alphaviral expression libraries allow to display about one single antibody species per cell, wherein about each individual cell displays a distinct antibody species. Very preferred alphaviral expression libraries are Sindbis-based libraries as described, for example, in WO1999/025876A1 and Koller et al. 2001 (Nature Biotech 19:851-855), which are incorporated herein by reference.

“Multiplicity of infection (MOI)”: The term multiplicity of infection refers to the ratio between the number of infectious virus particles in a viral, preferably alphaviral, expression library and the number of cells exposed to the virus.

The application provides a method of generating, selecting and isolating a cell expressing an antibody of desired specificity. In more detail, the application provides a method of isolating a cell expressing an antibody specifically binding an antigen of interest, said method comprising the steps of: (a) selecting from a population of isolated B cells a sub-population of B cells by selecting B cells for their capability of specifically binding said antigen of interest; (b) generating an alphaviral expression library, wherein each member of said alphaviral expression library encodes an antibody comprising at least one variable region (VR), by (i) generating a multitude of DNA molecules, wherein said generating comprises the step of amplifying a pool of DNA molecules from said sub-population of B cells, wherein each of said DNA molecules of said pool of DNA molecules encodes one of said at least one variable region (VR); and (ii) cloning a specimen of said multitude of DNA molecules into an alphaviral expression vector; (c) introducing said alphaviral expression library into a first population of mammalian cells; (d) displaying antibodies of said alphaviral expression library on the surface of said mammalian cells; and (e) isolating from said first population of mammalian cells a cell, wherein said cell is selected for the capability of the antibody displayed on its surface of specifically binding said antigen of interest or a fragment or antigenic determinant thereof.

Furthermore, the application provides for a method of isolating a cell expressing an antibody specifically binding an antigen of interest, said method comprising the steps of: (a) selecting from a population of isolated B cells a sub-population of B cells by selecting B cells for their capability of specifically binding said antigen of interest; (b) generating an expression library, preferably an alphaviral expression library, said generating comprising the steps of: (i) generating a multitude of DNA molecules encoding antibodies, said generating a multitude of DNA molecules comprising the steps of: (1) amplifying from said sub-population of B cells a first pool of DNA molecules encoding HCVRs; (2) amplifying from said sub-population of B cells a second pool of DNA molecules encoding LCVRs; and (3) linking specimens of said first and of said second pool of DNA molecules to each other by a DNA encoding a linker region (LR); (ii) cloning said multitude of DNA molecules into an expression vector, preferably into an alphaviral expression vector; wherein each member of said expression library, preferably of said alphaviral expression library, encodes an antibody comprising a signal peptide, a HCVR, a LCVR and a transmembrane region, wherein said HCVR and said LCVR are linked to each other by said linker region; (c) introducing said expression library, preferably said alphaviral expression library, into a first population of cells, preferably mammalian cells; (d) displaying antibodies of said expression library, preferably of said alphaviral expression library, on the surface of said cells, preferably mammalian cells; and (e) isolating from said first population of cells, preferably mammalian cells, a cell, wherein said cell is selected for the capability of the antibody displayed on its surface of specifically binding said antigen of interest or a fragment or antigenic determinant thereof.

Moreover, the application provides for method of isolating a cell expressing an antibody specifically binding an antigen of interest, said method comprising the steps of (a) selecting from a population of B cells a sub-population of B cells by selecting B cells for their capability of specifically binding said antigen of interest; (b) generating an expression library, preferably an alphaviral expression library, said generating comprising the steps of: (i) generating a multitude of DNA molecules encoding antibodies, said generating comprising the steps of: (1) isolating RNA from said sub-population of B cells; (2) transcribing said RNA to cDNA; (3) amplifying from said cDNA said first pool of DNA molecules using a first mixture of oligonucleotides comprising at least two oligonucleotides capable of amplifying HCVR coding regions; (4) amplifying from said cDNA said second pool of DNA molecules using a second mixture of oligonucleotides comprising at least two oligonucleotides capable of amplifying LCVR coding regions; and (5) linking specimens of said first and said second pool of DNA molecules to each other by a DNA encoding said linker region; (ii) cloning said multitude of DNA molecules into an expression vector, preferably an alphaviral expression vector; wherein each member of said expression library, preferably of said alphaviral expression library encodes an antibody comprising a signal peptide, a HCVR, a LCVR and a transmembrane region, wherein said HCVR and said LCVR are linked to each other by said linker region; (c) introducing said expression library, preferably said alphaviral expression library, into a first population of cells, preferably mammalian cells; (d) displaying antibodies of said expression library, preferably of said alphaviral expression library, on the surface of said cells, preferably of said mammalian cells; and (e) isolating from said first population of cells, preferably of mammalian cells, a cell, wherein said cell is selected for the capability of the antibody displayed on its surface of specifically binding said antigen of interest or a fragment or antigenic determinant thereof.

In a preferred embodiment each antibody encoded by said expression library, preferably by said alphaviral expression library, further comprises a signal peptide and a transmembrane region.

In a further preferred embodiment said antibody specifically binding said antigen of interest is a humanized or human antibody, preferably a human antibody. In a further preferred embodiment said antibody specifically binding said antigen of interest is a single chain antibody, preferably a scFv. Thus, the antibody displayed on the surface of said cell is preferably expressed as a scFv comprising a transmembrane region. In a preferred embodiment said at least one VR comprised by said antibody is a heavy chain variable region (HCVR) and a light chain variable region (LCVR). Thus, in a further preferred embodiment each member of said expression library, preferably said alphaviral expression library, encodes an antibody, wherein said antibody is expressed as fusion protein consisting of a single polypeptide, wherein said polypeptide comprises a signal peptide, a HCVR, a LCVR, and a transmembrane region. Typically and preferably, cDNA encoding variable regions is synthesized from RNA obtained from said sub-population of antigen specific B cells, cloned and expressed in an expression vector, preferably an alphaviral expression vector, wherein the variability of antigen-specific antibodies is increased by randomly linking different light and heavy chain variable regions. This is achieved by separately amplifying DNA molecules encoding HCVRs and LCVRs and linking them together by a DNA encoding a linker region (LR). Therefore, in a preferred embodiment said generating an expression library, preferably an alphaviral expression library, comprises the steps of: (a) generating a multitude of DNA molecules encoding antibodies, said generating comprising the steps of: (i) amplifying from said sub-population of B cells a first pool of DNA molecules encoding HCVRs; (ii) amplifying from said sub-population of B cells a second pool of DNA molecules encoding LCVRs; and (iii) linking specimens of said first and of said second pool of DNA molecules to each other by a DNA encoding a linker region (LR); (b) cloning a specimen of said multitude of DNA molecules into an expression vector, preferably into an alphaviral expression vector; wherein each member of said expression library, preferably of said alphaviral expression library, encodes an antibody comprising a signal peptide, a HCVR, a LCVR and a transmembrane region, wherein said HCVR and said LCVR are linked to each other by said linker region.

In a further preferred embodiment said generating a multitude of DNA molecules comprises the steps of: (a) isolating RNA from said sub-population of B cells; (b) transcribing said RNA to cDNA; and (c) amplifying from said cDNA a pool of DNA molecules using a mixture of oligonucleotides comprising at least two oligonucleotides capable of amplifying VR coding regions.

In a further preferred embodiment said generating a multitude of DNA molecules comprises the steps of: (a) isolating RNA from said sub-population of B cells; (b) transcribing said RNA to cDNA; (c) amplifying from said cDNA said first pool of DNA molecules using a first mixture of oligonucleotides comprising at least two oligonucleotides capable of amplifying HCVR coding regions; (d) amplifying from said cDNA said second pool of DNA molecules using a second mixture of oligonucleotides comprising at least two oligonucleotides capable of amplifying LCVR coding regions; and (e) linking specimens of said first and said second pool of DNA molecules to each other by a DNA encoding said linker region (LR). In a preferred embodiment the order of these elements from N- to C-terminus of said antibody is LCVR-LR-HCVR or HCVR-LR-LCVR, most preferably said order is HCVR-LR-LCVR.

The cloning of variable regions is a standard procedure generally known in the art and has been described for various species, including humans, non-human primates, mouse, rabbit, and chicken. For review see Barbas III et al. (eds.), Phage Display—A Laboratory manual, Cold Spring Harbour Press, 2001, in particular the chapter Andris-Widhopf et al., Generation of Antibody Libraries: PCR Amplification and Assembly of Light- and Heavy-chain Coding Sequences, therein. Andris-Widhopf et al. discloses sequences of oligonucleotides capable of amplifying variable region coding regions (VR coding regions), preferably HCVR coding regions or LCVR coding regions, of the afore mentioned species which sequences arc incorporated herein by reference. Furthermore, oligonucleotides capable of amplifying HCVR coding regions or LCVR coding regions, preferably human HCVR coding regions or LCVR coding regions, can be designed by the artisan by comparing known sequences of antibody coding regions which are available from databases such as, for example, Immunogenetics (http://imgt.cines.fr/), Kabat (www.kabatdatabase.com), and Vbase (http://vbase.mrc-cpe.cam.ac.uk/), and by identifying consensus sequences suitable for primer design. Based on general knowledge in molecular biology, on the afore mentioned manual (Barbas III et al. (eds.) Phage Display—A Laboratory manual, Cold Spring Harbour Press, 2001) and the references cited therein, the artisan is able to design oligonucleotides capable of amplifying HCVR coding regions or LCVR coding regions, wherein preferably said primers comprise suitable restriction sites for the cloning of the amplified products and wherein preferably said oligonucleotides also encode said linker region. Further Strategies for amplifying and cloning VRs are described in Sblattero and Bradbury (1998) Immunotechnology 3:271-278 and Weitkamp et al. (2003), J. Immunol. Meth. 275:223-237.

Preferred oligonucleotides encode restriction sites (RS1 and RS2) to allow for cloning of the assembled coding regions in the orientation RS1-LCVR-LR-HCVR-RS2 or RS1-HCVR-LR-LCVR-RS2, preferably RS1-LCVR-LR-HCVR-RS2. In a preferred embodiment, said restriction sites are distinct from one another and at least one of them generates a single-stranded overhang (“sticky end”), thus allowing for directional cloning. More preferably, said RS are eight or more base pairs long and recognized by “rare cutting” restriction enzymes selected from but not limited to the list of Asc1, Fse1, Not1, Pac1, Pme1, Sfi1 and Swa1. Most preferably, the RS are recognition sequences for Sfi1 (which cuts the sequence 5′-GGCCNNNNNGGCC-3′), and the sequences of RS1 and RS2 are, respectively, 5′-GGCCCAGGCGGCC-3′ and 5′-GGCCAGGCCGGCC-3′. Primers suitable for the generation of libraries of scFv cDNAs of the format Sfi1-LCVR-GGSSRSSSSGGGGSGGGG-HCVR-Sfi1 have been described (Barbas, C. F., III, Burton, D. R., Scott, J. K. and Silverman, G. J. (2001) Phage Display. A Laboratory Manual. Cold Spring Harbor Laboratory Press, 9.24-9.26) and are listed below.

The human HCVR, human kappa LCVR and human lambda LCVR coding regions are amplified by PCR with mixtures of specific sense and antisense primers annealing in the framework 1 and 4 regions, respectively. The principal set of primers is described here: Sblattero D, Bradbury A. (1998) A definitive set of oligonucleotide primers for amplifying human V regions. Immunotechnology. 3, 271-278. As an alternative to the use of a specific mix of antisense primers for the amplification of HCVR, kappa LCVR and lambda LCVR coding sequences, one antisense primer annealing in the gamma, kappa and lambda constant region can be used, respectively.

It has surprisingly been found that the efficiency of the subsequent cloning of specific VR coding regions can be enhanced by pre-amplifying the transcriptome of said sub-population of B cells, preferably by using the template switch protocol as described by Zhu et al. 2001, Biotechniques 30(4):892-897, wherein single stranded cDNA is synthesized with the CDS oligonucleotide SEQ ID NO:32 and the SMART II oligonucleotide SEQ ID NO:33 as switch template. However, the pre-amplification of the transcriptome needs to be balanced against the possible loss of certain rare cDNA species and the possible accumulation of sequence errors.

Thus, in a preferred embodiment, said transcribing of said RNA to cDNA comprises the steps of pre-amplifying the transcriptome of said sub-population of B cells, wherein preferably said pre-amplifying comprises the steps of: (a) selectively transcribing polyadenylated mRNA contained in said RNA to single stranded cDNA; and (b) amplifying double stranded cDNA from said single stranded cDNA. In a further preferred embodiment said selectively transcribing is performed using the oligonucleotides of SEQ ID NO:32 and SEQ ID NO:33. In a further preferred embodiment said amplifying double stranded cDNA is performed using the oligonucleotides of SEQ ID NO:33 and SEQ ID NO:34, wherein preferably the number of PCR cycles is less than 20, more preferably less than 15, still more preferably 10 to 14, and most preferably 14.

In principle said linker region may consist of any polypeptide comprising suitable length and flexibility to accommodate appropriate folding and assembly of the heavy and light chain variable regions. In a preferred embodiment said linker region consists of 5 to 30, preferably 5 to 22, more preferably 5 to 20, and most preferably of 18 amino acid. It is known to the artisan, that the length of the linker regions influences the structure and, thus, the immunological characteristics of the resulting antibody, in particular of the resulting single chain antibody. Linker regions of less than 15 amino acids in length typically lead to the formation of so called “diabodies”, whereas linker regions comprising at least 15 amino acid residues typically lead to the formation of scFv (Huston et al. (1988), PNAS 85(16):587958-83; Holliger et al. (1993), PNAS 90(14):6444-6448, Hollinger & Hudson, 2005, Nature Biotechnology 23(9):1126-1136). Thus, in a further preferred embodiment said linker region consists of 15 to 20, most preferably of 18 amino acid residues. In a very preferred embodiment said linker region comprises or further preferably consists of SEQ ID NO:107.

In a further preferred embodiment said linker region is encoded by an oligonucleotide contained in said mixture of oligonucleotides, preferably in said first mixture of oligonucleotides, and/or in said second mixture of oligonucleotides.

Said linking specimens of said first and said second pool of DNA molecules to each other by a DNA encoding said linker region may be performed by ligating said DNA molecules with said DNA encoding said linker region. Typically and preferably, said linking is performed by PCR overlap extension using an overlap in the sequence of the oligonucleotides encoding said linker region. Thus, in a further preferred embodiment a first part of said linker region is encoded by an oligonucleotide contained in said first mixture of oligonucleotides and a second part of said linker region is encoded by an oligonucleotide contained in said second mixture of oligonucleotides, wherein preferably said oligonucleotide encoding said first part of said linker region and said oligonucleotide encoding said second part of said linker region comprise an overlap, wherein further preferably said overlap is at least 3, preferably at least 10, more preferably at least 20, and most preferably 24 nucleotides in length, wherein still further preferably said overlap is at most 50, preferably at most 40, more preferably at most 30, and most preferably at most 24 nucleotides in length.

In a further preferred embodiment said linking of said specimens of said first pool of DNA molecules and of said second pool of DNA molecules to each other is performed by PCR using the oligonucleotides depicted in SEQ ID NO:69 and SEQ ID NO:70 as primers.

Typically and preferably, the resulting multitude of DNA molecules encoding antibodies, preferably human single chain antibodies, most preferably human scFv, are about 750-800 by in length and further preferably flanked by two Sfi1 restriction sites.

In one embodiment said pool of DNA molecules, preferably said first and/or said second pool of DNA molecules is either generated by pooling DNA molecules obtained in independent PCR reactions, each reaction performed with a different pair of oligonucleotides capable of amplifying VR coding regions, wherein preferably the oligonucleotides contained in an individual reaction are in an equimolar ratio. Thus, said mixture of oligonucleotides, said first mixture of oligonucleotides and/or said second mixture of oligonucleotides comprises or preferably consists of exactly one pair of oligonucleotides capable of amplifying VR coding regions, preferably HCVR coding regions or LCVR coding regions. The artisan may consider to standardize the concentration of DNA molecules generated in different reactions and with different pairs of oligonucleotides in said pool of DNA molecules, preferably said first and/or said second pool of DNA molecules, to the same concentration. The artisan may further consider to adapt in said pool of DNA molecules, preferably said first and/or said second pool of DNA molecules the ratio of DNA molecules encoding certain VR to the frequency of the corresponding VR coding regions in the genome of said B cells.

Typically and preferably said generating of said pool of DNA molecules, preferably said first and/or said second pool of DNA molecules is performed in a single reaction using more than one pair of oligonucleotides in said reaction. In a preferred embodiment said mixture of oligonucleotides, preferably said first mixture of oligonucleotides, comprises at least two oligonucleotides capable of amplifying human HCVR coding regions. In a further preferred embodiment said mixture of oligonucleotides, preferably said first mixture of oligonucleotides, comprises at least two, preferably all, oligonucleotides selected from the group consisting of SEQ ID NO:42 to 48. In a further preferred embodiment said mixture of oligonucleotides, preferably said second mixture of oligonucleotides, comprises at least two oligonucleotides capable of amplifying kappa LCVR coding regions, preferably human LCVR coding regions. In a further preferred embodiment said mixture of oligonucleotides, preferably said second mixture of oligonucleotides, comprises at least two oligonucleotides capable of amplifying kappa LCVR coding regions, wherein preferably said mixture of oligonucleotides, preferably said second mixture of oligonucleotides, comprises at least two, preferably all, oligonucleotides selected from the group consisting of SEQ ID NO:49 to 56.

In a preferred embodiment said mixture of oligonucleotides, preferably said second mixture of oligonucleotides, comprises at least two oligonucleotides capable of amplifying lambda LCVR coding regions, preferably human lambda LCVR coding regions. In a preferred embodiment said mixture of oligonucleotides, preferably said second mixture of oligonucleotides, comprises at least two oligonucleotides capable of amplifying lambda LCVR coding regions, wherein further preferably said mixture of oligonucleotides, preferably said second mixture of oligonucleotides, comprises at least two, preferably all, oligonucleotides selected from the group consisting of SEQ ID NO:57 to 68.

In a further preferred embodiment said mixture of oligonucleotides, said first mixture of oligonucleotides or said second mixture of oligonucleotides comprise a total amount of primers capable of amplifying VR coding regions, wherein all forward primers and all reverse primers contained in said total amount are in an equimolar ratio.

In a further preferred embodiment said antibody encoded by said expression library, preferably by said alphaviral expression library, comprises exactly one VR and a transmembrane region, wherein preferably said exactly one VR is a HCVR.

In a further preferred embodiment said antibody encoded by said expression library, preferably by said alphaviral expression library, comprises said HCVR, said LCVR and said linker region (LR), in an order selected from: (a) LCVR-LR-HCVR; and (b) HCVR-LR-LCVR; wherein preferably said order is LCVR-LR-HCVR.

To ensure cell surface display of said antibody, said antibody is expressed with a signal peptide directing said antibody to the secretory pathway through the endoplasmic reticulum of said cell, preferably of said mammalian cell, wherein preferably said signal peptide is located at the N-terminus of said antibody, and wherein further preferably said signal peptide is cleaved off said antibody during the processing and transport in said cell, preferably in said mammalian cell. Furthermore, said antibody is expressed with a transmembrane region anchoring said antibody in the cell membrane. Very preferably, said transmembrane region is located at the C-terminus of said antibody and causes said antibody to remain attached to the outer surface of said cell. The anchoring of said antibody in the cell membrane can also be achieved, for example, by GPI-linking (Moran & Caras 1991, The Journal of Cell Biology 115(6):1595-1600).

Thus, in a preferred embodiment said cloning a specimen of said multitude of DNA molecules into an expression vector, preferably into an alphaviral expression vector, comprises the steps of: (a) generating a DNA construct encoding said antibody comprising a signal peptide, a HCVR, a LCVR and a transmembrane region, by linking a specimen of said multitude of DNA molecules to a first DNA element encoding said transmembrane region; and (b) functionally linking said DNA construct to a second DNA element encoding said signal peptide directing said antibody to the secretory pathway, wherein preferably said functionally linking is performed in such a way that said signal peptide is linked to the N-terminus of said antibody.

Signal peptides directing a protein to the secretory pathway of a eukaryotic cell are generally known in the art and are disclosed, for example, in Nielsen et al. (1997), Protein Engineering, 10:1-6. In one embodiment, the signal peptide is derived from a secretory or type I transmembrane protein. In a preferred embodiment, the signal peptide is derived from a secretory protein such as member of the serum protein family (albumin, transferrin, lipoproteins, immunoglobulins), an extracellular matrix protein (collagen, fibronectin, proteoglycans), a peptide hormone (insulin, glucagon, endorphins, enkephalins, ACTH), a digestive enzyme (trypsin, chymotrypsin, amylase, ribonuclease, deoxyribonuclease) or a milk protein (casein, lactalbumin). In a more preferred embodiment, the signal peptide is derived from an immunoglobulin, preferably a light chain variable region. In a further preferred embodiment said signal peptide is a mouse Ig kappa light chain signal peptide, and wherein preferably said signal peptide comprises or further preferably consists of SEQ ID NO:105.

In one embodiment, said transmembrane region is derived from an integral membrane protein. In a preferred embodiment, said transmembrane region is an internal stop-transfer membrane-anchor sequence derived from a type I transmembrane protein (Do et al. (1996), Cell 85:369-78; Mothes et al. (1997), Cell 89:523-533) such as a cell adhesion molecule (integrins, mucins, cadherins), a lectin (Sialoadhesin, CD22, CD33), or a receptor tyrosin kinase (insulin receptor, EGF receptor, FGF receptor, PDGF receptor). In a more preferred embodiment, said transmembrane region is derived from a receptor tyrosine kinase, more preferably from human platelet-derived growth factor receptor (hPDGFR), most preferably from hPDGFR B chain (accession number NP_{—}002600). In a very preferred embodiment said transmembrane region is derived from human PDGFR beta chain, wherein preferably said transmembrane region comprises or further preferably consists of SEQ ID NO:106.

It is advantageous to express said antibody as a polypeptide further comprising a tag allowing the detection of cells expressing said antibody and the quantification of the expression level. Thus, in a further preferred embodiment said antibody further comprises a detection tag, wherein preferably said detection tag is HA, and wherein further preferably said detection tag comprises or still further preferably consists of SEQ ID NO:108.

In a very preferred embodiment said antibody encoded by said expression library, preferably by said alphaviral expression library, comprises a signal peptide (SP), a HCVR, a LCVR, a linker region (LR) and a transmembrane region (TM), wherein the order of said elements from the N- to the C-terminus of said antibody is: SP-LCVR-LR-HCVR-TM. In a further preferred embodiment said antibody encoded by said expression library, preferably by said alphaviral expression library, comprises a signal peptide (SP), a HCVR, a LCVR, a linker region (LR), a transmembrane region (TM) and a detection tag (TAG), wherein the order of said elements from the N- to the C-terminus of said antibody is: SP-LCVR-LR-HCVR-TAG-TM.

The multiplicity of assembled VR coding regions, preferably in the format Sfi1-LCVR-GGSSRSSSSGGGGSGGGG-HCVR-Sfi1, is then cloned into an expression vector, preferably into a viral expression vector, most preferably into an alphaviral expression library, creating an antibody expression library. In a preferred embodiment said expression library is a viral expression library, preferably a viral expression library derived from an RNA virus, wherein further preferably said RNA virus is a member of the Togaviridae, wherein still further preferably said RNA virus is an alphavirus. In a more preferred embodiment said expression library is an alphaviral expression library, wherein preferably said alphaviral expression library is derived from an alphavirus selected from the group of: (a) Sindbis virus; (b) Semliki forest virus; and (c) Venezuelan equine encephalitis virus. In a very preferred embodiment said alphaviral expression library is derived from Sindbis virus.

Alphaviruses, including Sindbis virus, can function in a broad range of host cells, including mammalian, avian, amphibian, reptilian and insect cells. Their genome comprises elements capable of directing expression of proteins, including heterologous proteins, encoded by nucleic acids of said viral genome in large amounts.

In one embodiment, said expression library is based on a single Sindbis RNA replicon. However, expression of structural and non-structural viral proteins can also be separated, and the structural proteins can be provided either by a packaging cell line or by a helper virus replicon (Bredenbeek P J, Frolov I, Rice C M, Schlesinger S. (1993) Sindbis virus expression vectors: packaging of RNA replicons by using defective helper RNAs. J. Virol. 67, 6439-6446). In a preferred embodiment, said expression library is based on two separate Sindbis RNA replicons, one encoding the nonstructural proteins plus said antibody, the other encoding the structural proteins. A Sindbis based alphaviral expression systems useful in the context of the invention has been described in detail in WO1999/025876A1 which is incorporated herein by reference.

In one embodiment said expression library comprises an expression vector, wherein said expression vector is a viral expression vector, wherein preferably said viral expression vector is an alphaviral expression vector, wherein further preferably said alphaviral expression vector is derived from Sindbis virus. In a preferred embodiment said expression vector comprises DNA elements encoding said signal peptide, said transmembrane region and, optionally, said detection tag in the desired order and further comprises a restriction site allowing the cloning, preferably the orientation specific cloning, of said multitude of DNA molecules into said expression vector. In a preferred embodiment said expression vector, preferably said alphaviral expression vector, comprises a DNA encoding a signal peptide, preferably mouse Ig kappa light chain signal peptide and a transmembrane region, preferably a transmembrane region derived from human PDGFR beta chain. In a very preferred embodiment said expression vector comprises nucleotides 4 to 282 of SEQ ID NO:1. In a still more preferred embodiment said expression vector is an alphaviral expression vector derived from Sindbis virus, wherein said alphaviral expression vector comprises or preferably consists of pDel-SP-TM (SEQ ID NO:38).

In a further preferred embodiment said expression vector, preferably said alphaviral expression vector, comprises a DNA encoding a signal peptide, preferably mouse Ig kappa light chain signal peptide, a transmembrane region, preferably a transmembrane region derived from human PDGFR beta chain, and a detection tag, preferably HA. In a very preferred embodiment said expression vector, preferably said alphaviral expression vector, comprises 4 to 312 of SEQ ID NO:40. In a still further preferred embodiment said expression vector is an alphaviral expression vector derived from Sindbis virus, wherein said alphaviral expression vector comprises or preferably consists of pDel-SP-HA-TM (SEQ ID NO:39).

In a further preferred embodiment said population of isolated B cells is derived from an animal exhibiting an increased titer of antibodies specifically binding said antigen of interest. The titer of antibodies binding an antigen of interest in the blood of an animal can be determined by methods generally known in the art, e.g. by ELISA. Thus in a preferred embodiment said titer, preferably said titer in the blood of said animal, is at least 5 times, preferably at least 10 times, most preferably at least 20 times higher than in the average population of said animal, and wherein further preferably said titer can be competed away by said antigen of interest or fragment or antigenic determinant thereof.

In a further preferred embodiment said animal said animal is or has been exposed to said antigen of interest or to a fragment or antigenic determinant thereof, wherein preferably said exposure is by way of natural exposure, infection with a pathogen or immunization. In a further preferred embodiment said animal is or has been infected by a pathogen, wherein said pathogen comprises said antigen of interest or a fragment or antigenic determinant thereof.

In a further preferred embodiment said population of isolated B cells is derived from an animal immunized with an immunogenic composition, wherein said immunogenic composition comprises or alternatively consists of: (a) said antigen of interest; (b) a fragment of said antigen of interest; and (c) an antigenic determinant of said antigen of interest. Any immunogenic composition known in the art may be used in the context of the invention. Generally preferred are compositions generating a strong immune response. Preferred immunogenic compositions are compositions comprising a virus-like particle (VLP), preferably a VLP of a RNA bacteriophage, more preferably a VLP of RNA bacteriophages Qbeta, AP205 or fr, most preferably a VLP of RNA bacteriophage Qbeta, and said antigen of interest or an antigenic determinant thereof. Immunogenic compositions useful in the context of the invention are disclosed in WO2006/097530A2, WO2006/097530A2, WO2006/045796A2, WO2006/032674A1, WO2006/027300A2, WO2005/117963A1, WO2006/063974A2, WO2004/084939A2, WO2004/085635A1, WO2005/068639A2, WO2005/108425A1, WO2005/117983A2, WO2005/004907A1, WO2004/096272A2, WO2004/016282A1, WO2004/009124A2, WO2003/039225A2, WO2004/007538A2, WO2003/040164A2, WO2003/031466A2, WO2004/009116A2, and WO2003/024481A2, which arc incorporated herein by reference.

In a further preferred embodiment, said immunizing of said animal is performed with an immunogenic composition, wherein the immunogenicity of said immunogenic composition is enhanced by an immunostimulatory substance, preferably by an immunostimulatory oligonucleotide, most preferably by an unmethylated CpG-containing oligonucleotide as disclosed, for example, in WO2003/024481A2, WO2005/004907A1 and WO2004/084940A1, which are incorporated herein by reference. In a very preferred embodiment said unmethylated CpG-containing oligonucleotide is G10 (SEQ ID NO:54 of WO2005/004907A1) which is incorporated herein by reference.

It is within the skill of the artisan to find a dosage and a mode of administration of said immunogenic compositions resulting in high antibody titers. In a preferred embodiment said immunizing of said animal with said immunogenic composition is performed by administering said immunogenic compositions to said animal at least three times, preferably three to six times, in intervals of at least one week, preferably in intervals of two weeks up to three months. In a further preferred embodiment said immunizing of said animal is performed by administering at least 100 μg, preferably 200 to 1000 μg of said immunogenic composition to said animal per single administration. In a further preferred embodiment said immunogenic composition comprises an adjuvant, preferably Freund's complete or incomplete adjuvant or alum.

In a further preferred embodiment said population of isolated B cells is derived from a source selected from: (a) blood; (b) secondary lymphoid organs, preferably spleen or lymph node; (c) bone marrow; and (d) tissue comprising memory B cells. Most preferably said source is blood. In a further preferred embodiment said population of isolated B cells comprises or preferably consists of peripheral blood mononuclear cells (PBMCs).

In a preferred embodiment, said animal is a mammal or a bird. In a preferred embodiment, said animal is selected from the group consisting of: (a) human; (b) mouse; (c) rabbit; and (d) chicken. In a very preferred embodiment, said animal is a mammal, preferably a rat, a mouse or a human. In a further preferred embodiment said animal a humanized mouse or a human, most preferably a human.

The efficiency of the screening for and cloning of antigen specific antibodies can be significantly increased by enriching antigen specific B cells. Methods for selecting from said population of isolated B cells a sub-population of B cells by selecting B cells for their capability of specifically binding said antigen of interest are generally known in the art. These methods are based on the interaction of antigen-specific B cells contained in said population of isolated B cells with the antigen of interest. In a preferred embodiment said selecting from said population of isolated B cells a sub-population of B cells comprises the steps of: (a) contacting said population of isolated B cells with said antigen of interest or a fragment or antigenic determinant thereof; and (b) selecting B cells specifically binding said antigen of interest or fragment or antigenic determinant thereof.

Preferred methods for selecting from said population of isolated B cells a sub-population of B cells are the binding of B cells to an antigen-covered carrier and FACS sorting and as described in WO2004/102198A2, which is incorporated herein by reference. Thus, in one embodiment said selecting from said population of isolated B cells a sub-population of B cells comprises the steps of: (a) coating a carrier with said antigen of interest or fragment or antigenic determinant thereof; (b) contacting said population of isolated B cells with said carrier and allowing said B cells to bind to said carrier via said antigen of interest or fragment or antigenic determinant thereof; and (c) removing unbound B cells, wherein preferably said carrier comprises or further preferably consists of beads, wherein still further preferably said beads are paramagnetic beads.

In a preferred embodiment, said selecting from said population of isolated B cells a sub-population of B cells comprises is performed by FACS sorting, wherein preferably said selecting from said population of isolated B cells a sub-population of B cells comprises the steps of: (a) contacting said population of isolated B cells with said antigen of interest or fragment or antigenic determinant thereof, wherein said antigen of interest or fragment or antigenic determinant thereof is labeled with a fluorescence dye; and (b) separating B cells bound to said antigen of interest or fragment or antigenic determinant thereof by FACS sorting.

In a further preferred embodiment said fluorescence dye is selected from the group consisting of (a) PerCP, allophycocyanin (APC), (b) texas red, (c) rhodamine, (d) Cy3, (e) Cy5, (f) Cy5.5, (f) Cy7, (g) Alexa Fluor Dyes, preferably Alexa 647 nm or Alexa 546 nm (h) phycoerythrin (PE), (i) green fluorescent protein (GFP), (j) a tandem dye (e.g. PE-Cy5), and (k) fluorescein isothiocyanate (FITC). In a very preferred embodiment said fluorescence dye is Alexa 647 nm or Alexa 546 nm. In the context of the invention labeling of a compound, preferably of said antigen of interest or fragment or antigenic determinant thereof, with said fluorescence dye is performed by any method known in the art, preferably by direct labeling said compound by coupling said fluorescence dye to said compound, wherein said coupling may be effected via a covalent as well as a non-covalent bound. Alternatively, labeling of a compound, preferably of said antigen of interest or fragment or antigenic determinant thereof, with said fluorescence dye is performed indirectly by binding to said compound a second compound, preferably an antibody, wherein said second compound comprises said fluorescence dye.

In one preferred embodiment said antigen of interest or fragment or antigenic determinant thereof is coupled to a VLP, preferably to a VLP of a RNA bacteriophage, most preferably to a VLP of bacteriophage Qbeta, wherein said antigen of interest or fragment or antigenic determinant thereof is labeled with said fluorescence dye by binding an anti-VLP antibody to said VLP, wherein said anti-VLP antibody is labeled with said fluorescence dye, wherein preferably said anti-VLP antibody is directly labeled by said fluorescence dye or biotin/streptavidin-fluorescence-labeled.

In one preferred embodiment said antigen of interest or fragment or antigenic determinant thereof is coupled to a VLP, preferably to a VLP of a RNA bacteriophage, most preferably to a VLP of bacteriophage Qbeta, wherein said antigen of interest or fragment or antigenic determinant thereof is labeled with said fluorescence dye by binding an antibody directed against said antigen of interest or fragment or antigenic determinant thereof to said antigen of interest or fragment or antigenic determinant thereof, wherein said antibody directed against said antigen of interest or fragment or antigenic determinant thereof is labeled with said fluorescence dye, wherein preferably said antibody directed against said antigen of interest or fragment or antigenic determinant thereof is directly labeled by said fluorescence dye or biotin/streptavidin-fluorescence-labeled.

If the cloning of a certain type of immunoglobulin is intended, said sub-population of B cells may, besides the capability of said cells of specifically binding said antigen of interest, be further selected for additional markers which are specific for those types of B cells expressing immunoglobulins the cloning of which is intended. Alternatively, certain undesired types of B cells predominantly expressing undesired types of immunoglobulins may be excluded. Additionally, vitality markers such as, for example, PI (propidium iodide) oder 7-AAD (7-Amino-actinomycin) may be applied to select for vital cells. Further additionally or alternatively, cell death or apoptosis markers, such as, for example, YO-PRO-1 or Annexin V may be applied to sort out dead or apoptotic cells.

Furthermore, it is advantageous to include in said selecting from said population of isolated B cells a sub-population of B cells a positive selection for the presence of a B-cell specific marker, preferably for CD19 or B220.

In a further embodiment said selecting from said population of isolated B cells a sub-population of B cells comprises the steps of: (a) contacting said population of isolated B cells with said antigen of interest or a fragment or antigenic determinant thereof; (b) selecting B cells specifically binding said antigen of interest or fragment or antigenic determinant thereof; and (c) selecting said B cells for at least one additional parameter, wherein preferably said selection for said at least one additional parameter is (i) a positive selection for a parameter selected from presence of a B-cell specific marker, preferably CD19 or B220, and vitality of said B cells; and/or (ii) a negative selection for a parameter selected from: presence of IgM antibodies; presence of IgD antibodies, presence of cell death markers, and presence of apoptosis markers.

Typically and preferably, the cloning of immunoglobulins of the IgG class is intended and, thus, said selecting from said population of isolated B cells a sub-population of B cells further comprises the step of selecting for class switched B cells, preferably for IgM- and/or IgD-negative B cells, most preferably for IgM- and IgD-negative B cells.

In a preferred embodiment, said selecting from said population of isolated B cells a sub-population of B cells comprises the steps of: (a) contacting said population of isolated B cells with said antigen of interest or fragment or antigenic determinant thereof, wherein said antigen of interest or fragment or antigenic determinant thereof is labeled with a first fluorescence dye, wherein preferably said fluorescence dye is Alexa 647 nm, Alexa 488 or Alexa 546 nm; (b) contacting the cells of said population of isolated B cells with anti-IgM and/or anti-IgD antibodies, wherein said anti-IgM and/or anti-IgD antibodies are labeled with a second and/or a third fluorescence dye, wherein said second and/or said third fluorescence dye emits fluorescence at a wavelength which is different from the wavelength of the fluorescence emitted by said first fluorescence dye; and (c) separating B cells bound to said antigen of interest or fragment or antigenic determinant thereof but not bound to said anti-IgM and/or not bound to said anti-IgD antibodies by FACS sorting.

For the efficiency of the subsequent screening process it is very advantageous though not absolutely essential, that each cell expressing and displaying an antibody on its surface comprises about one, preferably exactly one, single antibody species, wherein preferably each cell comprises a different antibody species. This is scenario is generally referred to as “one antibody per cell format”.

A one antibody per cell format can be achieved, for example, by using a viral expression library, preferably an alphaviral expression library, and by choosing a low ratio of expression vectors per number of eukaryotic, preferably mammalian cells, when introducing said expression library into said first population of said cells. Thus, in a preferred embodiment said expression library is a viral expression library, preferably an alphaviral expression library, most preferably an alphaviral expression library derived from Sindbis virus, and said introducing said expression library into a first population of eukaryotic, preferably mammalian cells is performed by infecting said eukaryotic, preferably mammalian cell with said viral expression library, preferably with said alphaviral expression library, wherein further preferably said infecting is performed at a multiplicity of infection of at most 10, preferably at most 1, more preferably at most 0.2, and most preferably at most 0.1. In a very preferred embodiment said multiplicity of infection is 0.1.

Alternatively, a one antibody per cell format can be achieved by transfection of a plasmid library to said eukaryotic, preferably mammalian cells, wherein the transfection rate is maintained at a high level by co-transfecting a second plasmid which is not expressed in said cells. Thus, in a further embodiment said introducing said expression library, preferably a plasmid library, into a first population of eukaryotic, preferably mammalian cells is performed by transfecting said cells with said expression vectors, preferably with said expression plasmids, wherein the ration between the number of said expression vectors, preferably of said expression plasmids, and the number of said eukaryotic, preferably mammalian cells is chosen to result in approximately one expression vector, preferably one expression plasmid, per eukaryotic, preferably mammalian cell, wherein preferably the transfection rate is maintained at a high level by co-transfecting a second plasmid which is not expressed in said eukaryotic cell.

In a further embodiment said isolating of said cell is performed by FACS sorting. In a preferred embodiment said isolating of said cell comprises the steps of: (a) staining said first population of eukaryotic, preferably mammalian cells with said antigen of interest or fragment or antigenic determinant thereof, wherein said antigen of interest or fragment or antigenic determinant thereof is labeled with a fluorescence dye; and (b) separating an individual cell specifically binding said antigen of interest, or fragment or antigenic determinant thereof, by means of FACS sorting. The use of said detection tag as a component of said antibody displayed on the surface of said eukaryotic, preferably mammalian cells allows to further select only cells expressing and/or displaying an antibody. Thus, in a preferred embodiment said antibody further comprises a detection tag, wherein preferably said detection tag is HA, and said isolating of said individual cell comprises the steps of: (a) staining said first population of eukaryotic, preferably mammalian cells with a compound specifically binding to said detection tag, wherein said compound is labeled with a first fluorescence dye; (b) staining said first population of eukaryotic, preferably mammalian cells with said antigen of interest or fragment or antigenic determinant thereof, wherein said antigen of interest or fragment or antigenic determinant thereof is labeled with a second fluorescence dye, wherein said second fluorescence dye emits fluorescence at a wavelength which is different from the wavelength of the fluorescence emitted by said first fluorescence dye; and (c) separating an individual cell specifically binding said detection tag and said antigen of interest, or fragment or antigenic determinant thereof, by means of FACS sorting.

In a further embodiment said separating an individual cell specifically binding said antigen of interest, or fragment or antigenic determinant thereof, by means of FACS sorting comprises the step of further selecting said cell at least one additional parameter, wherein preferably said at least one additional parameter is selected from (i) a positive selection for vitality of said cell or the presence of a detection tag; and/or (ii) a negative selection for a parameter selected from: presence of IgM antibodies; presence of IgD antibodies, presence of cell death markers, and presence of apoptosis markers. Negative selection may also include negative selection for the binding of one or more, preferably one, undesired antigen(s). It is within the skill of the artisan to include undesired antigen(s), preferably in an unlabelled format, in the screen in order to out-compete cells expressing an antibody binding said undesired antigen(s).

In a further preferred embodiment said method further comprises the steps of: (a) cultivating at least one, preferably exactly one, of said individual cells in the presence of a second population of eukaryotic, preferably mammalian cells; (b) verifying the capability of said second population of eukaryotic, preferably mammalian cells of specifically binding said antigen of interest, or fragment or antigenic determinant thereof. In a further preferred embodiment said verifying comprises the steps of: (a) staining said second population of eukaryotic, preferably mammalian cells with said antigen of interest, or fragment or antigenic determinant thereof, wherein said antigen of interest, or fragment or antigenic determinant thereof, is labeled with a fluorescence dye; and (b) detecting cells specifically binding said antigen of interest, or fragment or antigenic determinant thereof, by FACS analysis.

In a further preferred embodiment said first population of eukaryotic, preferably mammalian cells and/or, preferably and, said second population of eukaryotic, preferably mammalian cells comprises or preferably consists of cells selected from: (a) BHK 21 cells, preferably ATCC No. CCL-10; (b) Neuro-2a cells; and (c) HEK-293T cells, preferably ATCC No. CRL-11268. In a very preferred embodiment said first population of eukaryotic, preferably mammalian cells and/or, preferably and, said second population of eukaryotic, preferably mammalian cells comprises or preferably consists of BHK 21 cells, wherein further preferably said expression library is an alphaviral expression library, wherein still further preferably said alphaviral expression library is derived from Sindbis virus.

The method of the invention is by no means limited to the nature of the antigen of interest. Therefore said antigen of interest used in the method of the invention may be any antigen of known or yet unknown provenance. In one embodiment, the antigen of interest is a recombinant antigen or a synthetic peptide. In another embodiment, the antigen or antigenic determinant is isolated from a natural source. Preferred antigens of interest used in the present invention can be synthesized or recombinantly expressed and coupled to VLPs, or fused to VLPs using recombinant DNA techniques. Exemplary procedures describing the attachment of antigens to virus-like particles are disclosed in WO00/32227, in WO01/85208 and in WO02/056905, the disclosures of which are herewith incorporated by reference in its entirety.

In a preferred embodiment said antigen of interest is selected from the group consisting of: (a) allergen; (b) self-antigen; (c) tumor antigen; (d) antigen of a pathogen; and (e) hapten.

In a further preferred embodiment said antigen of interest is an allergen, preferably an allergen selected from the group consisting of: (a) pollen allergen, preferably Bet v I (birch pollen allergen); (b) house dust allergen, preferably Der p I (House dust mite allergen); (c) cat allergen, preferably Fel d1; (d) bee venom phospholipase A2; (e) 5 Dol m V (white-faced hornet venom allergen); (f) and an immunogenic fragments of (a) to (e).

In a further preferred embodiment said antigen of interest is a self-antigen, preferably a self-antigen selected from the group consisting of: (a) IL-6; (b) granulocyte macrophages colony stimulating factor (GMCSF); (c) IL-1 alpha; (d) IL-1 beta; (e) IL-5; (f) IL-15; (g) IL-23; (h) tumor necrosis factor (TNF) alpha; (i) receptor activator of nuclear factor kappaB ligand (RANKL); (j) Ghrelin; (k) GIP; (1) adiponectin receptor; (m) amyloid beta, preferably amyloid beta peptide (Aβ1-42); (n) lymphotoxins, preferably Lymphotoxin α (LT α), or Lymphotoxin β (LT β); (o) vascular endothelial growth factor (VEGF) and vascular endothelial growth factor receptor (VEGF-R); (p) MIF; (q) MCP-1; (r) SDF-1; (s) Rank-L; (t) M-CSF; (u) Angiotensin II; (v) Endoglin; (w) Eotaxin; (x) BLC; (y) CCL21; (z) IL-13; (aa) IL-17; (bb) IL-8; (cc) Bradykinin; (dd) Resistin; (ee) LHRH; (ff) GHRH; (gg) GIH; (hh) CRH; (ii) TRH; (jj) Gastrin; (kk) Interferon α; (11) Interferon γ; (mm) EGF-R; and (nn) fragments of (a) to (mm) which can be used to elicit immunological responses.

In a further preferred embodiment said antigen of interest is a tumor antigen, wherein preferably said tumor antigen is selected from the group consisting of: (a) MelanA; (b) HER2/ErbB-2 (breast cancer); (c) GD2 (neuroblastoma); (d) EGF-R (malignant glioblastoma); (e) CEA (medullary thyroid cancer); (0 CD52 (leukemia); (g) human melanoma protein gp100; (h) tyrosinase and tyrosinase related proteins, preferably TRP-1 and TRP-2; (i) NA17-A nt protein; (j) MAGE-3 protein; and (k) NY-ESO-1.

In a further preferred embodiment said antigen of interest is an antigen of a pathogen, wherein preferably said pathogen is selected from the group consisting of: (a) hepatitis B virus; (b) influenza A virus; (c) HIV; (d) Hepatitis C virus; (e) rotavirus; (f) polio virus; (g) encephalitis virus; (h) West-Nile virus; (i) SARS virus; (j) Ebola virus; (k) Measles virus; (1) RSV; (m) Toxoplasma; (n) Plasmodium falciparum; (o) Plasmodium ovate; (p) Plasmodium malariae; and (q) Chlamydia.

In a further preferred embodiment said antigen of interest is an antigen of a pathogen, wherein preferably said antigen of interest is selected from the group consisting of: (a) hepatitis B virus preS1 protein; (b) influenza A virus M2 protein; and (b) influenza A virus HA protein.

In a further preferred embodiment said antigen of interest is a hapten, preferably a hapten selected from the group consisting of haptens of: (a) opio ids; (b) morphine derivatives, preferably selected from codeine, fentanyl, heroin, morphium and opium; (c) stimulants, preferably selected from amphetamine, cocaine, MDMA (methylenedioxymethamphetamine), methamphetamine, methylphenidate and nicotine; (d) hallucinogens, preferably LSD, mescaline, psilocybin, and cannabinoids. In a very preferred embodiment said antigen of interest is a hapten of nicotine or of a nicotine derivative.

Said individual cell displaying said antibody of interest can then be used to clone and to recombinantly express antibodies comprising the variable regions of said antibody displayed on said cell using methods generally known in the art (see for example Weitkamp et al., 2003, J. Immunol. Meth. 275, 223-237). In principle, it is possible to express said antibodies in any know form (for different forms of antibodies see Hollinger & Hudson (2005), Nature Biotechnology 23(9)), preferably as IgG, most preferably as fully human IgG.

One possibility of producing recombinant antibodies specifically binding said antigen of interest is to express said antibody as a fusion product comprising a purification tag. For example, the expression of single chain antibodies as an Fc-fusion has been described in Ray et al. (2001), Clin. Exp. Immunol. 125(1):94-101 and Ono et al. (2003), J. Biosci. Bioeng. 95(3):231-238). The invention therefore provides for a method of producing an antibody specifically binding an antigen of interest said method comprising the steps of: (a) isolating a cell expressing an antibody according to the method described above; (b) obtaining RNA from said isolated cell; (c) synthesizing cDNA encoding said antibody from said RNA; (d) cloning said cDNA into an expression vector; (e) generating a fusion construct encoding a fusion product comprising said antibody and said purification tag; (f) expressing said fusion product in a cell; and (g) purifying said fusion product. In a further preferred embodiment said antibody comprises at least one VR, preferably a LCVR and a HCVR, and a purification tag, wherein preferably said at least one VR, more preferably said LCVR and said LCVR, are derived from the same of said individual cell. In a preferred embodiment said synthesizing of said cDNA comprises the step of synthesizing single stranded cDNA from said RNA, wherein preferably said single stranded cDNA is synthesized using SEQ ID NO:35 as a primer. In a further preferred embodiment said synthesizing of said cDNA further comprises the step of amplifying said cDNA from said single stranded cDNA, wherein preferably said amplifying is performed using the oligonucleotides of SEQ ID NO:35 and SEQ ID NO:36 as primers. In a still further preferred embodiment said purification tag is Fc, preferably human Fc, and wherein further preferably said purification tag comprises or still further preferably consists of SEQ ID NO:109. In a very preferred embodiment said expression vector is pCEP-SP-Sfi-Fc (SEQ ID NO:37). In a further preferred embodiment said expressing of said fusion product is performed in mammalian cells, preferably in HEK-293T cells. Antibodies comprising a purification tag can be expressed an purified using standard procedures and are preferably used to test the specificity of said antibody for said antigen of interest of fragment or antigenic determinant thereof by determining the binding constant of said antibody to said antigen of interest or fragment or antigenic determinant thereof, wherein said testing is preferably performed by ELISA, most preferably by ELISA essentially as described in Example 7.

The invention further provides a method of producing an antibody specifically binding an antigen of interest by expressing said antibody as an immunoglobulin, preferably as a species specific immunoglobulin, most preferably as a mouse, rat, rabbit chicken or human immunoglobulin, most preferably as a fully human immunoglobulin. One embodiment of the invention is a method of producing an antibody specifically binding an antigen of interest, said method comprising the steps of (a) isolating a cell expressing an antibody according to the method described above; (b) obtaining RNA from said cell; (c) synthesizing cDNA form said RNA; (d) amplifying from said cDNA a DNA encoding VRs of said antibody expressed by said cell; (e) generating an expression construct comprising said DNA, wherein said expression construct is encoding at least one VR of said antibody expressed by said cell; (f) expressing said expression construct in a cell. In a preferred embodiment, said method comprising the steps of: (a) isolating a cell expressing an antibody according to the method described above; (b) obtaining RNA from said cell; (c) synthesizing cDNA form said RNA; (d) amplifying from said cDNA a first DNA encoding a HCVR of said antibody expressed by said cell; (e) generating a first expression construct comprising said first DNA, wherein said first expression construct is encoding a heavy chain immunoglobulin comprising a heavy chain constant region (HCCR) and said HCVR; (f) amplifying from said cDNA a second DNA encoding a LCVR of said antibody expressed by said cell; (g) generating a second expression construct comprising said second DNA, wherein said second expression construct is encoding a light chain immunoglobulin comprising a light chain constant region (LCCR) and said LCVR; (h) expressing said first expression construct and said second expression construct in a cell. In a further preferred embodiment said HCCR, said HCVR, said LCCR and said LCVR are derived from human.

In a further preferred embodiment said expression construct, said first expression construct and/or said second expression construct are further encoding a hydrophobic leader sequence, preferably a species specific hydrophobic leader sequence, most preferably a human hydrophobic leader sequence. In a further preferred embodiment said first expression construct is further encoding a human heavy chain hydrophobic leader sequence. In a further preferred embodiment said second expression construct is further encoding a human light chain hydrophobic leader sequence, wherein said human light chain hydrophobic leader sequence is selected from the group consisting of (a) human kappa light chain hydrophobic leader sequence; and (b) human lambda light chain hydrophobic leader sequence.

In a further preferred embodiment said synthesizing of said cDNA comprises the step of synthesizing single stranded cDNA from said RNA, wherein preferably said single stranded cDNA is synthesized using SEQ ID NO:35 as a primer. In a further preferred embodiment said synthesizing of said cDNA further comprises the step of amplifying said cDNA from said single stranded cDNA, wherein preferably said amplifying is performed using the oligonucleotides of SEQ ID NO:35 and SEQ ID NO:36 as primers.

In a further preferred embodiment said HCCR is a human HCCR, preferably a human HCCR selected from the group consisting of: (a) human gamma 1 HCCR; (b) human gamma 2 HCCR; (c) human gamma 4 HCCR; and (d) human heavy chain Fd regions, preferably gamma 2 Fd region. In a further preferred embodiment said LCCR is a human LCCR, preferably a human LCCR selected from the group consisting of: (a) human kappa LCCR; and (b) human lambda LCCR.

In a further preferred embodiment said amplifying of said first DNA is performed with HCVR specific primers, wherein preferably said HCVR specific primers are SEQ ID NO:102 and SEQ ID NO:103.

In a further preferred embodiment said amplifying of said second DNA is performed with LCVR specific primers, wherein preferably said LCVR specific primers are selected from kappa LCVR specific primers and lambda LCVR specific primers. In a further preferred embodiment said LCVR specific primers are kappa LCVR specific primers, wherein preferably said kappa LCVR specific primers are a combination of any one selected from SEQ ID NO:92 or 93 with SEQ ID NO:94. In a further preferred embodiment said LCVR specific primers are lambda LCVR specific primers, wherein preferably said lambda LCVR specific primers are a combination of any one selected from SEQ ID NO:95 to 99 with any one of SEQ ID NO:100 or 101.

In a further preferred embodiment said LCCR is a human kappa LCCR and wherein said LCVR is a human kappa LCVR. In a further preferred embodiment said LCCR is a human lambda LCCR and wherein said LCVR is a human lambda LCVR.

In principle, immunoglobulins comprising a heavy and a light chain can be recombinantly produced by expressing two different expression vectors in the same cell. Alternatively, expression constructs encoding said light chain and said heavy chain can be cloned into a single expression vector. Thus, in one embodiment said expressing of said first expression construct and of said second expression construct comprises expressing said first expression construct as part of a first expression vector and expressing said second expression construct as part of a second expression vector, wherein said first expression vector and said second expression vector are co-transfected to said cell. In a preferred embodiment said expressing of said first expression construct and of said second expression construct comprises expressing said first expression construct and said second expression construct as part of the same expression vector, wherein preferably said expression vector is pCB15 (SEQ ID NO:104).

For the expression of species specific, preferably human, antibodies expression cassettes are produced encoding HCCRs or LCCRs of said species, preferably of humans, and the corresponding leader sequences and comprising a restriction site allowing to insert the corresponding VR coding regions. In a preferred embodiment said generating said first expression construct comprises the step of cloning said first DNA into a first expression cassette, wherein said first expression cassette is encoding said HCCR, and, preferably, said HCCR hydrophobic leader sequence, wherein further preferably said first expression cassette comprises or still more preferably consists of a sequence selected from SEQ ID NO:117 to 120. In a further preferred embodiment said generating said second expression construct comprises the step of cloning said second DNA into a second expression cassette, wherein said second expression cassette is encoding said LCCR, and, preferably, said LCCR hydrophobic leader sequence, and wherein further preferably said second expression cassette comprises or still more preferably consists of a sequence selected from SEQ ID NO:121 or 122.

In one embodiment said antibody is expressed in a form selected from: (a) single chain antibody, preferably scFv; (b) diabody; (c) Fab fragment; (d) F(ab′)2 fragment; and (e) whole antibody, preferably selected from IgG, IgA, IgE, IgM, and IgD; wherein preferably said antibody is a human antibody, most preferably a fully human antibody.

In a preferred embodiment said antibody is a Fab fragment, wherein preferably said first expression cassette comprises or preferably consists of SEQ ID NO:120 and wherein further preferably said second expression cassette comprises or preferably consists of SEQ ID NO:121. In a further preferred embodiment said antibody is a Fab fragment, wherein said first expression vector comprises or preferably consists of SEQ ID NO:85 and wherein said second expression vector comprises or preferably consists of said SEQ ID NO:71.

In a further preferred embodiment said antibody is a Fab fragment, wherein preferably said first expression cassette comprises or preferably consists of SEQ ID NO:120 and wherein further preferably said second expression cassette comprises or preferably consists of SEQ ID NO:122. In a further preferred embodiment said antibody is a Fab fragment and said first expression vector comprises or preferably consists of SEQ ID NO:85 and said second expression vector comprises or preferably consists of said SEQ ID NO:110.

In another embodiment said antibody is expressed as a whole antibody of the IgG class, preferably as IgG1, IgG2, IgG3, or IgG4; wherein preferably said antibody is a human antibody, most preferably a fully human antibody.

In a preferred embodiment said antibody is a IgG1, and wherein preferably said first expression cassette comprises or preferably consists of SEQ ID NO:118 and wherein further preferably said second expression cassette comprises or preferably consists of SEQ ID NO:121. In a further preferred embodiment said first expression vector comprises or preferably consists of SEQ ID NO:88 and wherein said second expression vector comprises or preferably consists of said SEQ ID NO:71. In a further preferred embodiment said antibody is a IgG1, and wherein preferably said first expression cassette comprises or preferably consists of SEQ ID NO:118 and wherein further preferably said second expression cassette comprises or preferably consists of SEQ ID NO:122. In a further embodiment said first expression vector comprises or preferably consists of SEQ ID NO:88 and wherein said second expression vector comprises or preferably consists of said SEQ ID NO:110.

In a further preferred embodiment said antibody is a IgG2, and wherein preferably said first expression cassette comprises or preferably consists of SEQ ID NO:117 and wherein further preferably said second expression cassette comprises or preferably consists of SEQ ID NO:121. In a further preferred embodiment said first expression vector comprises or preferably consists of SEQ ID NO:78 and wherein said second expression vector comprises or preferably consists of said SEQ ID NO:71. In a further preferred embodiment said antibody is a IgG2, and wherein preferably said first expression cassette comprises or preferably consists of SEQ ID NO:117 and wherein further preferably said second expression cassette comprises or preferably consists of SEQ ID NO:122. In a further preferred embodiment said first expression vector comprises or preferably consists of SEQ ID NO:78 and wherein said second expression vector comprises or preferably consists of said SEQ ID NO:110.

In a further preferred embodiment said antibody is a IgG4, and wherein preferably said first expression cassette comprises or preferably consists of SEQ ID NO:119 and wherein further preferably said second expression cassette comprises or preferably consists of SEQ ID NO:121. In a further preferred embodiment said first expression vector comprises or preferably consists of SEQ ID NO:90 and wherein said second expression vector comprises or preferably consists of said SEQ ID NO:71. In a further preferred embodiment said antibody is a IgG4, and wherein preferably said first expression cassette comprises or preferably consists of SEQ ID NO:119 and wherein further preferably said second expression cassette comprises or preferably consists of SEQ ID NO:122. In a further preferred embodiment said first expression vector comprises or preferably consists of SEQ ID NO:90 and wherein said second expression vector comprises or preferably consists of said SEQ ID NO:71.

Said expressing of said antibody may be performed in any eukaryotic expression system known in the art. Typically and preferably, said expressing of said antibody is performed in eukaryotic cells, wherein further preferably said eukaryotic cells are selected from yeast cells, insect cells and mammalian cells. In a preferred embodiment said expressing of said antibody is performed in mammalian cells, wherein preferably said mammalian cells are selected from HEK-293T cells, CHO cells, COS cells. Very preferably said mammalian cells are HEK-293T cells.

The invention further relates to an expression vector for displaying polypeptides, preferably antibodies, most preferably single chain antibodies, on the surface of a eukaryotic, preferably mammalian cell. The invention thus relates to an expression vector, preferably a viral expression vector, more preferably alphaviral expression vector, most preferably an expression vector derived from Sindbis virus, wherein said expression vector comprises DNA elements encoding a signal peptide, a transmembrane region and, preferably, a detection tag, and wherein further preferably said expression vector comprises a restriction site allowing the cloning, preferably the orientation specific cloning, of DNA molecules encoding said polypeptides, preferably said antibody variable regions, into said expression vector. In a further preferred embodiment said expression vector comprises said DNA elements and said restriction site in an orientation allowing the expression of a fusion protein comprising from the N- to the C-terminus said signal peptide, said polypeptide, preferably said detection tag, and said transmembrane region.

In a preferred embodiment said signal peptide is mouse Ig kappa light chain signal peptide. In a further preferred embodiment said transmembrane region is derived from human PDGFR beta chain. In a further preferred embodiment said signal peptide is mouse Ig kappa light chain signal peptide and said transmembrane region is derived from human PDGFR beta chain. In a very preferred embodiment said expression vector comprises nucleotides 4 to 282 of SEQ ID NO:1. In a still more preferred embodiment said expression vector is an alphaviral expression vector derived from Sindbis virus, wherein said alphaviral expression vector comprises or preferably consists of pDel-SP-TM (SEQ ID NO:38).

In a further preferred embodiment said detection tag is HA. In a further preferred embodiment said signal peptide is mouse Ig kappa light chain signal peptide, said transmembrane region is derived from human PDGFR beta chain and said detection tag is HA. In a very preferred embodiment said expression vector comprises nucleotides 4 to 312 of SEQ ID NO:40. In a still further preferred embodiment said expression vector is an alphaviral expression vector derived from Sindbis virus, wherein said alphaviral expression vector comprises or preferably consists of pDel-SP-HA-TM (SEQ ID NO:39).

The invention further relates to an expression library, preferably to an expression library expressing antibodies, wherein further preferably said antibodies are single chain antibodies, wherein still further preferably said single chain antibodies are human single chain antibodies, said expression library comprising said expression vector. In a preferred embodiment, said expression library comprises nucleotides 4 to 282 of SEQ ID NO:1 or, further preferably, said expression library comprises SEQ ID NO:38. In a further preferred embodiment, said expression library comprises nucleotides 4 to 312 of SEQ ID NO:40 or, further preferably, said expression library comprises SEQ ID NO:39.

The invention further relates to an eukaryotic, preferably mammalian cell comprising said expression vector or comprising at least one specimen of said expression library.

### EXAMPLES

### Example 1

### Construction of pDel-SP-TM, a Sindbis-Based Viral Vector Allowing Cell Surface Display of Single-Chain Antibodies

A DNA fragment (SEQ ID NO:1) encoding a mouse Ig kappa signal peptide (SEQ ID NO:105), two SfiI restriction sites and the transmembrane region of the human platelet-derived growth factor receptor beta chain (PDGFR, SEQ ID NO:106) was assembled from six overlapping oligonucleotides. Briefly, the oligonucleotides SPTM-2 (5′-CCT GCT ATG GGT ACT GCT GCT CTG GGT TCC AGG TTC CAC TGG TGA CTA TGA GGC CCA GGC GGC CGG TAC-3′, SEQ ID NO:26), SPTM-3 (5′-CCT CCT GCG TGT CCT GGC CCA CAG CAT TGC GGC CGG CCT GGC CGC TAG CGG TAC CGG CCG CCT GGG CCT C-3′, SEQ ID NO:27), SPTM-4 (5′-GGC CAG GAC ACG CAG GAG GTC ATC GTG GTG CCA CAC TCC TTG CCC TTT AAG GTG GTG GTG ATC TCA GCC-3′, SEQ ID NO:28) and SPTM-5 (5′-CAT GAT GAG GAT GAT AAG GGA GAT GAT GGT GAG CAC CAC CAG GGC CAG GAT GGC TGA GAT CAC CAC CAC C-3′ SEQ ID NO:29) were mixed at a final concentration of 0.1 μM each in a 100 μl polymerase chain reaction (PCR) and cycled 20 times (20 sec at 94° C.; 20 sec at 60° C.; 40 sec at 72° C.) in the presence of 2.5 units Taq DNA polymerase (Invitrogen) under the manufacturer's recommended reaction conditions. 1 μl of this reaction was then mixed with the oligonucleotides SPTM-1 (5′-GAG TCT AGA GCC ACC ATG GAG ACA GAC ACA CTC CTG CTA TGG GTA CTG CT GCT C-3′, SEQ ID NO:30) and SPTM-6 (5′-CTC GGG CCC CTA ACG TGG CTT CTT CTG CCA AAG CAT GAT GAG GAT GAT AAG GGA G-3′, SEQ ID NO:31) at a final concentration of 0.1 μM each in a second 100 μl PCR reaction and cycled for another 20 cycles as above. The resulting 285 by DNA fragment was digested with the restriction endonucleases XbaI and ApaI, purified by agarose gel electrophoresis, and ligated into the XbaI/ApaI digested Sindbis virus expression vector pDelSfi, yielding the scFv display vector pDcl-SP-TM (SEQ ID NO:38).

For the construction of pDel-SP-HA-TM (SEQ ID NO:39), a 315 by DNA fragment (SP-HA-TM Linker, SEQ ID NO:40), which in addition encodes a haemagglutinin (HA) tag between the SfiI sites and the TM region, was assembled and cloned. The whole procedure was identical to the one for pDel-SP-TM (SEQ ID NO:38), except that the oligo SPTM-3 (SEQ ID NO:27) was replaced by the oligo SPTM-3HA (5′-CCT CCT GCG TGT CCT GGC CCA CAG CAT TAG AGG CAT AAT CTG GCA CGT CGT AAG GAT AGC GGC CGG CCT GGC CGC TAG CGG TAC CGG CCG CCT GGG CCT C-3′, SEQ ID NO:41).

### Example 2

Isolation of Qβ-Specific Human Memory B Cells from Peripheral Blood Mononuclear Cells

Peripheral blood mononuclear cells (PBMC) were isolated from 20 ml of heparinized blood of a Qβ-vaccinated volunteer by a standard Ficoll-Hypaque™ Plus (Amersham Biosciences) gradient method. PBMC were stained with Alexa 647 nm-labeled Qβ (4 μg/ml), FITC-labeled mouse anti-human IgM (1.5 μg/ml) (Jackson ImmunoResearch Laboratories), FITC-labeled mouse anti-human IgD (diluted 1:50) (BD Biosciences Pharmingen), and PE-labeled mouse anti-human CD19 (diluted 1:100) (BD Biosciences Pharmingen). After 30 min cells were washed, filtered and stained with propidium iodide (PI) to exclude dead cells. 230% I-specific memory B cells (Qβ-, CD19-positive, IgM-, IgD-, PI-negative) were sorted on a FACSVantage SE flow cytometer (Becton Dickinson) and used for library construction.

### Example 3

### Construction of a Single-Chain Antibody Cell Surface Display Library from Qβ-Specific Human Memory B Cells

Total RNA was isolated from 230 Qβ-specific human memory B cells using TRI reagent (Molecular Research, Inc.). Single-stranded cDNA was produced with PowerScript™ reverse transcriptase (Clontech) using the template switch protocol (Zhu et al. 2001 Biotechniques 30(4):892-7), with the CDS oligonucleotide (5′-AAG CAG TGG TAA CAA CGC AGA GTA CTT TTT TTT TTT TTT TTT TTT TTT TTT TTT TVN-3′, SEQ ID NO:32) as primer, and the SMART II oligonucleotide (5′-d[AAG CAG TGG TAA CAA CGC AGA GTA CGC] r[GGG]-3′, SEQ ID NO:33) as switch template. The cDNA was bulk-amplified by 14 cycles of PCR, using the Advantage2 polymerase mix (Clontech) and an anchor primer (5′-AAG CAG TGG TAT CAA CGC AGA GT-3′, SEQ ID NO:34) in a total volume of 200 μl. Double-stranded cDNA was purified with the Qiaquick PCR purification kit (Qiagen).

A single-chain antibody library was then produced essentially as described (Phage Display: A Laboratory Manual, Cold Spring Harbor Laboratory Press, 2001) using the pre-amplified ds-cDNA as template. Briefly, heavy chain variable region coding sequences were amplified with an equimolar mix of 6 sense primers (HSCVH1-FL, SEQ ID NO:42; HSCVH2-FL, SEQ ID NO:43; HSCVH3a-FL, SEQ ID NO:44; HSCVH4a-FL, SEQ ID NO:45; HSCVH4-FL, SEQ ID NO:46; and HSCVH35-FL, SEQ ID NO:47) plus an antisense constant region primer (HSCG1234-B; SEQ ID NO:48); the κ light chain variable region coding sequences were amplified with an equimolar mix of 4 sense primers (HSCK1-F, SEQ ID NO:49; HSCK24-F, SEQ ID NO:50; HSCK3-F, SEQ ID NO:51; and HSCK5-F, SEQ ID NO:52) plus an equimolar mix of 4 antisense primers (HSCJK14o-B, SEQ ID NO:53; HSCJK2o-B, SEQ ID NO:54; HSCJK3o-B SEQ ID NO:55; and HSCJK50-B, SEQ ID NO:56); and the λ light chain variable region coding sequences were amplified with an equimolar mix of 9 sense primers (HSCLam1a, SEQ ID NO:57; HSCLam1b, SEQ ID NO:58; HSCLam2, SEQ ID NO:59; HSCLam3, SEQ ID NO:60; HSCLam4, SEQ ID NO:61; HSCLam6, SEQ ID NO:62; HSCLam78, SEQ ID NO:63; HSCLam9, SEQ ID NO:64; and HSCLam10 SEQ ID NO:65) plus an equimolar mix of 3 antisense primers (HSCJLam1236, SEQ ID NO:66; HSCJLam4, SEQ ID NO:67 and HSCJLam57, SEQ ID NO:68).

The scFv coding regions were assembled by PCR overlap extension of the VH PCR product with either the Vκ PCR product or the Vλ PCR product using the primers RSC-F (SEQ ID NO:69) and RSC-B (SEQ ID NO:70). The resulting ˜750-800 by PCR products encoded a 5′ light chain variable region (either κ or λ) and a 3′ heavy chain variable region, linked by an 18 amino acid flexible linker, and flanked by two SfiI restriction sites. The κ- and λ-containing scFv fragments were pooled in equimolar ratio, digested with the restriction endonuclease SfiI, purified by agarose gel electrophoresis and cloned into SfiI-digested pDel-SP-TM (SEQ ID NO:38). The resulting library consisted of approximately 106 independent transformands. DNA was isolated from pooled colonies using the HiSpeed Plasmid Maxi Kit (Qiagen).

As a measure of library quality, individual clones were sequenced to ascertain diversity and overall structural organization of the single-chain antibodies, as well as their in frame fusion to the N-terminal Ig κ signal peptide and C-terminal PDGFR transmembrane region. Of the six scFv clones that were sequenced each corresponded to a different scFv, indicating that the library is diverse (SEQ ID NOs:2-7). Further, all six clones were fused in-frame to both signal peptide and transmembrane region. In addition, most of the clones displayed an intact open reading frame, with only one clone having an in-frame stop codon in the heavy chain variable region as a result of a point mutation. This is likely to be a PCR mutation resulting from the extensive amplification during library construction. In conclusion, the scFv cell surface display library was diverse and predominantly consisted of functional antibodies that can be expected to be displayed on the cell surface.

The plasmid library was converted into a Sindbis virus library as follows. For in vitro transcription, 5 μg of the library plasmid was linearized, half with the restriction endonuclease NotI (Roche), the other half with Pad (New England Bio labs). 5 μg of the helper plasmid pDHEB (Bredenbeek et al. 1993 J. Virol. 67(11):6439-6446), encoding the Sindbis virus structural proteins, was linearized with the restriction endonuclease EcoRI. All restriction digests were then extracted with phenol-chloroform, ethanol precipitated, and resuspended in RNase-free H₂O at a concentration of 0.5 μg/μl. 1 μg of the linearized library and of the helper plasmid were subjected to SP6 RNA polymerase-mediated in vitro transcription in a volume of 20 μl, using the mMessage mMachine™ kit (Ambion). The transcribed library RNA was co-electroporated with an equimolar amount of helper RNA into 10⁷ BHK cells. 18 hours post transfection, cell supernatant was harvested and the viral titer determined to be approximately 10⁷ per ml. This Sindbis virus based cell surface display library was then used to isolate Qβ-specific single-chain antibodies.

### Example 4

### Identification of Cells Displaying Qβ-Specific Single-Chain Antibodies by Fluorescence-Activated Cell Sorting

Sixty million subconfluent (80%) baby hamster kidney (BHK) cells were infected with the single-chain antibody library derived from Qβ-specific variable domains or an empty viral vector as a negative control at a multiplicity of infection (MOI) of 0.2. After 5 hours, cells were detached with cell dissociation buffer (Sigma), washed and stained. Half of the cells were stained with Alexa 647 nm-labeled Qβ (4 μg/ml) for 30 min. The remaining cells were stained with Alexa 546 nm-labeled Qβ (4 μg/ml) and an anti-sindbis serum from rabbit (diluted 1:6000) for 30 min, followed by staining with Cy5-labeled donkey anti-rabbit IgG (1 μg/ml) (Jackson ImmunoResearch Laboratories) for 20 min. All cells were then washed, filtered and stained with propidium iodide (PI) to exclude dead cells. Single cell sorting was performed on a FACS Vantage SE flow cytometer (Becton Dickinson) for, respectively, Alexa 647 nm-positive, PI-negative and, Alexa 546 nm-positive, sindbis-positive, PI-negative cells. In total, 480 cells were sorted, 264 from the Alexa 647 nm sorting, and 216 from the Alexa 546 nm sorting.

Each cell was sorted into a well of a 24-well plate containing 50% confluent BHK feeder cells. Upon virus spread (2-3 days post sorting), the infected cells were tested by FACS analysis for Qβ binding. On day 2 post sorting, 228 wells showed typical signs of viral infection, 199 of which bound Qβ. On day 3 post sorting, another 48 wells showed clear viral infection with 39 of them binding Qβ.

### Example 5

### Rescue of cDNA Encoding Qβ-Specific Single-Chain Antibodies

To obtain cDNAs encoding Qβ-specific single-chain antibodies, RT-PCR was performed using supernatants from BHK cells, each containing monoclonal recombinant Sindbis virus. For the viral RNA isolation, 140 μl of viral supernatant and the QIAamp Viral RNA Kit (Qiagen) were used. The procedure was performed according to manufacturer's protocol and the RNA was dissolved in 30 μl RNase-free H₂O. For the cDNA synthesis 8 μl of the viral RNA were used per reaction. The 1st strand cDNA was synthesized in a 20 μl reaction containing 20 pmoles LPP2 primer (5′-ACA AAT TGG ACT AAT CGA TGG C-3′, SEQ ID NO:35), using PowerScript™ reverse transcriptase (Clontech) according to the manufacturer's recommendations.

Single-chain antibody cDNAs were PCR amplified from 2 μl 1st strand cDNA in 100 μl reactions with the primers pDel-seq (5′-GAG CAA AAG AGC ATT CCA AG-3′, SEQ ID NO:36) and LPP2 (SEQ ID NO:35), using the Advantage 2 Polymerase mix (Clontech) according to the manufacturer's recommendations. The PCR reaction was performed with one cycle of 1 min at 95° C. followed by 30 cycles of 20 sec at 95° C., 20 sec at 56° C., 90 sec at 72° C. The resulting PCR products were analyzed on an agarose gel and the ˜750-800 by bands isolated using the QIAquick gel extraction Kit (Qiagen) according to manufacturer's protocol. Each gel-purified PCR product was then subjected to sequencing using the primers pDel-seq and LPP2 (˜100-200 ng per sequencing reaction).

A total of 14 PCR products were sequenced, the scFv coding regions assembled and the sequences predicted for the displayed scFvs determined (SEQ ID NOs:8-21). With the exception of one clone, each of the single-chain antibodies had an open reading frame and was fused in-frame to both signal peptide and transmembrane region, as was to be expected. ScFv-Qb#18 (SEQ ID NO:18) had a frame shift at the beginning of the heavy chain variable region followed by an early termination, leading to a protein lacking not only most of the heavy chain V region, but also the transmembrane region. Such a protein is expected to be secreted and should not be selected by our cell surface display strategy. Thus, it seems likely that the mutation was introduced during the gene rescue PCR amplification.

The sequence diversity was significantly reduced compared to prior to the screen. While there were no two scFvs with identical sequence, many were clearly closely related. Significantly, there were several scFvs where one of the two variable regions were identical. For instance, scFv-Qb#2 (SEQ ID NO:8), scFv-Qb#3 (SEQ ID NO:9), scFv-Qb#4 (SEQ ID NO:10) and scFv-Qb#6 (SEQ ID NO:12) share the same heavy chain variable region. Similarly, the light chain variable regions of scFv-Qb#2 (SEQ ID NO:8), scFv-Qb#5 (SEQ ID NO:11) and scFv-Qb#7 (SEQ ID NO:13) are almost identical and differ by only one or a few amino acids.

### Example 6

Construction, Expression, and Purification of the Qβ-Specific scFv-Fc Fusion Proteins

Synthetic constructs were produced allowing for the eukaryotic expression of fusion proteins carrying an N-terminal human scFv fused to a C-terminal human Fc-γ1 domain. Thus, PCR products corresponding to scFv-Qb#2 (SEQ ID NO:8), scFv-Qb#3 (SEQ ID NO:9), scFv-Qb#5 (SEQ ID NO:11) and scFv-Qb#8 (SEQ ID NO:14) were digested with the restriction endonuclease SfiI (New England Biolabs) and cloned into the expression vector pCEP-SP-Sfi-Fc (SEQ ID NO:37). This vector is a derivative of the episomal mammalian expression vector pCEP4 (Invitrogen, cat. no. V044-50), carrying the Epstein-Barr Virus replication origin (oriP) and nuclear antigen (encoded by the EBNA-1 gene) to permit extrachromosomal replication, and contains a puromycin selection marker in place of the original hygromycin B resistance gene. The resulting plasmids, pCEP/scFvQb#2-Fc, pCEP/scFvQb#3-Fc, pCEP/scFvQb#5-Fc and pCEP/scFvQb#8-Fc drive expression of scFv-Fc domain fusion proteins (SEQ ID NOs:22-25) under the control of a CMV promoter.

Expression of the fusion constructs was done in HEK-293T cells. One day before transfection, 10⁷ HEK-293T cells were plated onto a 14 cm tissue culture plate for each protein to be expressed. Cells were then transfected with the respective scFv-Fc fusion construct using Lipofectamin Plus (Invitrogen) according to the manufacturer's recommendations, incubated one day, and replated on three 14 cm dishes in the presence of 1 μg/ml puromycin. After 3 days of selection, puromycin-resistant cells were transferred to six Poly-L-Lysine coated 14 cm plates and grown to confluency. Medium was then replaced by serum-free medium and supernatants containing the respective scFv-Fc fusion protein was collected every 3 days and filtered through a 0.22 μM Millex GV sterile filter (Millipore).

For each of the scFv-Fc fusion proteins, the consecutive harvests were pooled and applied to a protein A-sepharose column. The column was washed with 10 column volumes of phosphate-buffered saline (PBS), and bound protein eluted with 0.1 M Glycine pH 3.6. 1 ml fractions were collected in tubes containing 0.1 ml of 1 M Tris pH 7.5 for neutralization. Protein-containing fractions were analyzed by SDS-PAGE and pooled. The buffer was exchanged with PBS by dialysis using 10′000 MWCO Slide-A-Lyzer dialysis cassettes (Pierce). The purified proteins in PBS were then filtered through 0.22 μM Millex GV sterile filters (Millipore) and aliquotted. Working stocks were kept at 4° C., whereas aliquots for long-term storage were flash-frozen in liquid nitrogen and kept −80° C.

### Example 7

### Verification of Qβ-Specific Binding of scFv-Fc Fusion Proteins by ELISA

ELISA plates (96 well MAXIsorb, NUNC immuno plate 442404) were coated with Qβ at a concentration of 2 μg/ml in coating buffer (0.1 M NaHCO₃, pH 9.6), over night at 4° C. Alternatively, ELISA plates were coated with 2 μg/ml of an irrelevant control protein. The plates were then washed with wash buffer (PBS/0.05% Tween) and blocked for 1 h at 37° C. with 3% BSA in wash buffer. The plates were then washed again and incubated with serially diluted scFv-Qb#2-Fc (SEQ ID NO:8), scFv-Qb#3-Fc (SEQ ID NO:9), scFv-Qb#5-Fc (SEQ ID NO:11) and scFv-Qb#8-Fc (SEQ ID NO:14) (either serum-free tissue culture supernatant or purified scFv-Fc fusion proteins). Plates were incubated at 37° C. for 1 h and then extensively washed with wash buffer. Bound specific scFv-Fc fusion proteins were then detected by a 30 minute incubation with a HRPO-labeled, Fcγ-specific, goat anti-human IgG antibody (Jackson ImmunoResearch Laboratories 109-035-098). After extensive washing with wash buffer, plates were developed with OPD solution (1 OPD tablet, 25 μl OPD buffer and 8 ul H2O2) for 5 to 10 minutes and the reaction was stopped with 5% H₂SO₄ solution. Plates were then read at OD 450 nm on an ELISA reader (Biorad Benchmark). Half-maximal binding of purified scFv-Fc fusion proteins was observed at picomolar concentrations (scFv-Qb#2-Fc, 51 pM; scFv-Qb#3-Fc, 35 pM; scFv-Qb#5-Fc, 52 pM; scFv-Qb#8-Fc, 163 pM), suggesting that the antibodies are of very high affinity.

### Example 8

### Construction of Vectors Allowing for Expression of Human Antibodies as Whole IgG or Fab

pCMV-LC (SEQ ID NO:71), a vector allowing for the expression of natural human antibody κ light chains, was generated as follows. First, a DNA segment encoding an Ig κ light chain signal peptide was assembled from the 4 oligonucleotides SP-kappa-1 (5′-GGC TAG CGC CAC CAT GGA CAT GAG GGT CCC CGC TCA GCT CCT GGG GCT C-3′, SEQ ID NO:72), SP-kappa-2 (5′-CAG GAG CTG AGC GGG GAC CCT CAT GTC CAT GGT GGC GCT AGC CAG CT-3′, SEQ ID NO:73), SP-kappa-3 (5′-CTG CTA CTC TGG CTC CGA GGT GCC AGA TGT GAC ATC GAG CTC CTG CA-3′, SEQ ID NO:74) and SP-kappa-4 (5′-GGA GCT CGA TGT CAC ATC TGG CAC CTC GGA GCC AGA GTA GCA GGA GCC C-3′, SEQ ID NO:75), by annealing the complementary oligonucleotides SP-kappa-1 and -2, and SP-kappa-3 and -4, respectively. The two resulting double stranded DNA fragments SP-kappa-1/2 and SP-kappa-3/4 were cloned into the vector pCMV-Script (Stratagene) digested with the restriction endonucleases SacI and PstI, yielding pCMV-kappa-leader. Second, the human x light chain constant region was amplified from human spleen cDNA using the primers C-kappa-F (5′-GAG GAG GAT ATC AAA CGA ACT GTG GCT GCA CCA TC-3′, SEQ ID NO:76) and C-kappa-B (5′-GAG GAG GGT ACC GTT TAA ACC TAA CAC TCT CCC CTG TTG AAG CTC TTT GTG ACG GGC GAA CTC AGG CC-3′, SEQ ID NO:77). The resulting 359 by PCR product was digested with the restriction endonucleases EcoRV and KpnI and cloned into the vector pCMV-Script, yielding pCMV-C-kappa. Third, after the correct sequence of both plasmids was verified, pCMV-kappa-leader and pCMV-C-kappa were digested with the restriction endonucleases EcoRV and KpnI. The 343 by fragment excised from pCMV-C-kappa, corresponding to the x light chain constant region, was then ligated into the 4282 by pCMV-kappa-leader vector fragment, yielding the light chain expression vector pCMV-LC (SEQ ID NO:71). DNA fragments encoding light chain variable regions can be cloned into pCMV-LC via the restriction endonucleases Sad and EcoRV and expressed as part of natural κ light chains.

pCMV-LC-lambda (SEQ ID NO:110), a vector allowing for the expression of natural human antibody λ light chains, was generated as follows. First, a DNA segment encoding an Ig λ light chain signal peptide was assembled from the 4 oligonucleotides SP-lambda-1 (5′-GGC TAG CGC CAC CAT GGC CTG GGC TCT GCT CCT CCT CAC CCT CCT-3′, SEQ ID NO:111), SP-lambda-2 (5′-GTG AGG AGG AGC AGA GCC CAG GCC ATG GTG GCG CTA GCC AGC T-3′, SEQ ID NO:112), SP-lambda-3 (5′-CAC TCA GGG CAC AGG GTC CTG GGC CCA GTC TGA GCT CCT GCA-3′, SEQ ID NO:113) and SP-lambda-4 (5′-GGA GCT CAG ACT GGG CCC AGG ACC CTG TGC CCT GAG TGA GGA GG-3′, SEQ ID NO:114), by annealing the complementary oligonucleotides SP-lambda-1 and -2, and SP-lambda-3 and -4, respectively. The two resulting double stranded DNA fragments SP-lambda-1/2 and SP-lambda-3/4 were cloned into the vector pCMV-Script (Stratagene) digested with the restriction endonucleases SacI and PstI, yielding pCMV-lambda-leader. Second, the human λ light chain constant region was amplified from human spleen cDNA using the primers C-lambda-F (5′-GAG GAG GAT ATC CTA GGT CAG CCC AAG GCT GCC CC-3′, SEQ ID NO:115) and C-lambda-B (5′-GAG GAG GGT ACC MT TAA ACC TAT GAA CAT TCT GTA GGG GC-3′, SEQ ID NO:116). The resulting 356 by PCR product was digested with the restriction endonucleases EcoRV and KpnI and cloned into the vector pCMV-Script, yielding pCMV-C-lambda. Third, after the correct sequence of both plasmids was verified, pCMV-lambda-leader and pCMV-C-lambda were digested with the restriction endonucleases EcoRV and KpnI. The 340 by fragment excised from pCMV-C-lambda, corresponding to the λ light chain constant region, was then ligated into the 4273 by pCMV-lambda-leader vector fragment, yielding the light chain expression vector pCMV-LC-lambda. DNA fragments encoding lambda light chain variable regions can be cloned into pCMV-LC-lambda via the restriction endonucleases SacI and EcoRV and expressed as part of natural λ light chains.

pCMV-HC (SEQ ID NO:78), a vector allowing for the expression of natural human antibody γ2 heavy chains, was generated as follows. First, a DNA segment encoding an Ig heavy chain signal peptide was assembled from the 4 oligonucleotides SP-heavy-1 (5′-CGG CGC GCC ACC ATG GAC TGG ACC TGG AGG ATC CTC TF-3′ SEQ ID NO:79), SP-heavy-2 (5′-ACC AAG AAG AGG ATC CTC CAG GTC CAG TCC ATG GTG GCG CGC CGA GCT-3′ SEQ ID NO:80), SP-heavy-3 (5′-CTT GGT GGC AGC AGC CAC AGG AGC CCA CTC CCA GAT GCA ACT GC-3′ SEQ ID NO:81) and SP-heavy-4 (5′-TCG AGC AGT TGC ATC TGG GAG TGG GCT CCT GTG GCT GCT GCC-3′ SEQ ID NO:82), by annealing the complementary oligonucleotides SP-heavy-1 and -2, and SP-heavy-3 and -4, respectively. The two resulting double stranded DNA fragments SP-heavy-1/2 and SP-heavy-3/4 were cloned into the vector pCMV-Script (Stratagene) digested with the restriction endonucleases Sad and XhoI, yielding pCMV-heavy-leader. Second, the human γ2 heavy chain constant region was amplified from human spleen cDNA using the primers C-gamma2-FL (5′-GAG GAG CTC GAG GCC TCC ACC AAG GGC CCA TCG GTC TTC CCC CTG GCG CCC TGC TCC AGG AGC ACC TCC-3′ SEQ ID NO:83) and C-gamma2-B (5′-GAG GAG GGT ACC TTA ATT AAT CAT TTA CCC GGA GAC AGG GAG-3′ SEQ ID NO:84). The resulting 1013 by PCR product was digested with the restriction endonucleases XhoI and KpnI and cloned into the vector pCMV-Script, yielding pCMV-C-gamma2. Third, after the correct sequence of both plasmids was verified, pCMV-heavy-leader and pCMV-C-gamma2 were digested with the restriction endonucleases XhoI and KpnI. The 999 by fragment excised from pCMV-C-gamma2, corresponding to the γ2 heavy chain constant region, was then ligated into the 4258 by pCMV-gamma2-leader vector fragment, yielding the heavy chain expression vector pCMV-HC. DNA fragments encoding heavy chain variable regions can be cloned into pCMV-HC via the restriction endonucleases XhoI and ApaI and expressed as part of natural γ2 heavy chains. Cotransfection of a pCMV-LC (SEQ ID NO:71) with a pCMV-HC (SEQ ID NO:78) expression construct will allow for the production of whole IgG2.

pCMV-Fd (SEQ ID NO:85), a vector allowing for the expression of human γ2 heavy chain Fd regions, was generated as follows. The human γ2 heavy chain Fd region was amplified from the plasmid pCMV-C-gamma2 using the primers C-gamma2-F (5′-GAG GAG CTC GAG GCC TCC ACC AAG GGC CCA TCG-3′, SEQ ID NO:86) and Fd-gamma2-B (5′-GAG GAG GGT ACC TTA ATT AAT CAT TTG CGC TCA ACT GTC TTG TC-3′, SEQ ID NO:87). The resulting 338 by PCR product was digested with the restriction endonucleases XhoI and KpnI and cloned into the vector pCMV-gamma2-leader, yielding pCMV-Fd (SEQ ID NO:85). DNA fragments encoding heavy chain variable regions can be cloned into pCMV-Fd via the restriction endonucleases XhoI and ApaI and expressed as part of γ2 heavy chain Fd regions. Cotransfection of a pCMV-LC (SEQ ID NO:71) with a pCMV-Fd (SEQ ID NO:85) expression construct will allow for the production of Fab fragments.

pCMV-HC-g1 (SEQ ID NO:88), a vector allowing for the expression of natural human antibody γ1 heavy chains, was generated as follows. The human γ1 heavy chain constant region was amplified from human bone marrow cDNA using the primers C-gamma1 1-F (5′-CAA GGG CCC ATC GGT CTT CCC CCT GGC ACC CTC-3′, SEQ ID NO:89) and C-gamma2-B (SEQ ID NO:84). The resulting 1005 by PCR product was digested with the restriction endonucleases ApaI and KpnI and used to replace the Fd coding region in pCMV-Fd (SEQ ID NO:85), yielding pCMV-HC-g1 (SEQ ID NO:88). DNA fragments encoding heavy chain variable regions can be cloned into pCMV-HC-g1 (SEQ ID NO:88) via the restriction endonucleases XhoI and ApaI and expressed as part of natural γ1 heavy chains. Cotransfection of a pCMV-LC (SEQ ID NO:71) with a pCMV-HC-g1 (SEQ ID NO:88) expression construct will allow for the production of whole IgG1.

pCMV-HC-g4 (SEQ ID NO:90), a vector allowing for the expression of natural human antibody γ4 heavy chains, was generated by nested PCR as follows. The human γ4 heavy chain constant region was pre-amplified from human spleen cDNA using the primers C-gamma2-F (SEQ ID NO:86) and C-gamma4-B2 (5′-AGC GGG GGC TTG CCG GCC CTG-3′, SEQ ID NO:123). The resulting 1021 bp PCR product was then reamplified with the primers C-gamma2-FL (SEQ ID NO:83) and C-gamma4-B (5′-GAG GAG GGT ACC TTA ATT AAC CGG CCC TGG CAC TCA TTT ACC CA-3′, SEQ ID NO:91). The resulting 1029 bp PCR product was digested with the restriction endonucleases XhoI and PacI and used to replace the Fd coding region in pCMV-Fd (SEQ ID NO:85), yielding pCMV-HC-g4 (SEQ ID NO:90). DNA fragments encoding heavy chain variable regions can be cloned into pCMV-HC-g4 (SEQ ID NO:90) via the restriction endonucleases XhoI and ApaI and expressed as part of natural γ4 heavy chains. Cotransfection of a pCMV-LC (SEQ ID NO:71) or pCMV-LC-lambda (SEQ ID NO:110) with a pCMV-HC-g4 (SEQ ID NO:90) expression construct will allow for the production of whole IgG4.

### Example 9

### Construction, Expression, and Purification of Fully Human Qβ-Specific IgG and Fab

The heavy and light chain variable region coding segments of scFv-Qb#2 (SEQ TD NO:8), scFv-Qb#3 (SEQ ID NO:9), scFv-Qb#5 (SEQ ID NO:11) and scFv-Qb#8 (SEQ ID NO:14) were amplified by PCR using variable region-specific transfer primers (SEQ ID NO:92-103). Specifically, the light chain variable regions were amplified as follows, wherein VL stands for lambda light chain variable region, VK stands for kappa light chain variable region, and VH stands for heavy chain variable region: VL-Qb#2 was amplified with the primers VL-SacI-F (SEQ ID NO:95) and VL-EcoR5-B1 (SEQ ID NO:100); VK-Qb#3 with the primers VK-SacI-F (SEQ ID NO:92) and VK-EcoR5-B2 (SEQ ID NO:94); VL-Qb#5 with the primers VL-SacI-F (SEQ ID NO:95) and VL-EcoR5-B2 (SEQ ID NO:101); VL-Qb#8 with the primers VL-SacI-F3 (SEQ ID NO:98) and VL-EcoR5-B2 (SEQ ID NO:101). The heavy chain variable region coding segments VH-Qb#2, VH-Qb#3, VH-Qb#5 and VH-Qb#8 were all amplified with the primers VH-XhoI-F (SEQ ID NO:102) and VH-ApaI-B (SEQ ID NO:103).

The resulting light chain variable region PCR products were digested with the restriction enzymes Sad and EcoR5, purified by agarose gel electrophoresis, and ligated into SacI-EcoR5 digested pCMV-LC (SEQ ID NO:71), yielding the light chain expression vectors pCMV-Qb#2-LC, pCMV-Qb#3-LC, pCMV-Qb#5-LC and pCMV-Qb#8-LC. Similarly, the heavy chain variable region PCR products were digested with the restriction enzymes XhoI and ApaI, gel purified, and ligated into XhoI-ApaI digested pCMV-HC (SEQ ID NO:78), yielding the γ2 heavy chain expression vectors pCMV-Qb#2-HC, pCMV-Qb#3-HC, pCMV-Qb#5-HC and pCMV-Qb#8-HC, as well as into XhoI-ApaI digested pCMV-Fd (SEQ ID NO:85), yielding the γ2 Fd region expression vectors pCMV-Qb#2-Fd, pCMV-Qb#3-Fd, pCMV-Qb#5-Fd and pCMV-Qb#8-Fd.

As demonstrated in Example 8, co-expression of each of the pCMV-LC expression constructs with the corresponding pCMV-HC or pCMV-Fd expression construct in principle allows for the production of, respectively, whole IgG or Fab fragments. However, to increase yields and facilitate large-scale production of antibodies, heavy and light chain coding regions were first combined into a single, EBNA-based expression vector, pCB15 (SEQ ID NO:104). For instance, for expression of antibody Qb#2 as a whole IgG, the light chain coding region was excised from pCMV-Qb#2-LC by digestion with the restriction enzymes NheI and PmeI, the resulting 735 by fragment purified by agarose gel electrophoresis, and then ligated into NheI-PmeI digested pCB15, yielding pCB15-Qb#2-LC. The Qb#2 heavy chain coding region was then excised from pCMV-Qb#2-HC by digestion with AscI and PacI, the resulting 1433 by fragment gel-purified, and then ligated into AscI-PacI digested pCB15-Qb#2-LC, yielding the whole IgG expression vector pCB15-Qb#2-IgG2.

For expression as a Fab fragment, the Qb#2 Fd coding region was excised from pCMV-Qb#2-Fd by digestion with AscI and PacI, the resulting 758 by fragment gel-purified, and then ligated into AscI-PacI digested pCB15-Qb#2-LC, yielding the Fab expression vector pCB15-Qb#2-Fab. The whole IgG expression vectors pCB15-Qb#3-IgG2, pCB15-Qb#5-IgG2 and pCB15-Qb#8-IgG2, and the Fab expression vectors pCB15-Qb#3-Fab, pCB15-Qb#5-Fab and pCB15-Qb#8-Fab were generated in exactly the same way as the Qb#2 expression vectors.

Expression of whole IgG and Fab fragments was done in HEK-293T cells, exactly as described for the scFv-Fc fusion proteins (Example 6), with expression levels in the range of 20 to 50 mg/L. Both whole IgG and Fab fragments were purified by applying protein-containing cell supernatants to affinity columns (IgG: protein G; Fab: goat anti-human F(ab′)2). The columns were washed with 10 column volumes of phosphate-buffered saline (PBS), and bound protein eluted with 0.1 M Glycine pH 3.6. 1 ml fractions were collected in tubes containing 0.1 ml of 1 M Tris pH 7.5 for neutralization. Protein-containing fractions were analyzed by SDS-PAGE and pooled. The buffer was exchanged with PBS by dialysis using 10′000 MWCO Slide-A-Lyzer dialysis cassettes (Pierce). The purified proteins in PBS were then filtered through 0.22 μM Millex GV sterile filters (Millipore) and aliquoted. Working stocks were kept at 4° C., whereas aliquots for long-term storage were flash-frozen in liquid nitrogen and kept -80° C.

The binding properties of purified Qβ-specific IgG2 and Fab immunoglobulins were analyzed by ELISA essentially as described in Example 7. For most of the immunoglobulins, half-maximal binding was observed at picomolar concentrations, suggesting that they are of very high affinity (see Table 1).

TABLE 1
Range of concentrations of half-maximal binding to Qβ.

| | |
|---|---|
| IgG2 | Fab |

| | | | | |
|---|---|---|---|---|
| Qβ#2 | 25-56 | pM | 261-454 | pM |
| Qβ#3 | 15-37 | pM | 77-239 | pM |
| Qβ#5 | 21-54 | pM | 82-236 | pM |
| Qβ#8 | 456-1′097 | pM | >10′000 | pM |

### Example 10

### Isolation of Human Pathogen-Specific Human Monoclonal Antibodies

### Anti-preS1 Antibodies

Peripheral blood mononuclear cells (PBMC) were isolated from 20 ml of heparinized blood of a fr-preS1 (21-47) (SEQ ID NO:124) vaccinated volunteer by a standard Ficoll-Hypaque™ Plus (Amersham Biosciences) gradient method. PBMC were stained with: (1) Qβ-preS1 (21-47) (1 μg/ml) in combination with a Alexa 488 nm-labeled Qβ-specific mouse mAb; (2) Alexa 647 nm-labeled Qβ (3 μg/ml); (3) PE-labeled mouse anti-human IgM (diluted 1:50; BD Biosciences Pharmingen), mouse anti-human IgD (diluted 1:100; BD Biosciences Pharmingen), mouse anti-human CD14 (diluted 1:50; BD Biosciences Pharmingen), and mouse anti-human CD3 (diluted 1:50; BD Biosciences Pharmingen) antibodies; and (4) PE-TexasRed-labeled mouse anti-human CD19 antibody (diluted 1:50; Caltag Laboratories). After staining, cells were washed, filtered and preS1 (21-47)-specific B cells (FL1-positive, FL2-negative, FL3-positive, FL4-negative) were sorted on a FACSVantage SE flow cytometer (Becton Dickinson).

Construction of a Sindbis-based scFv cell surface display library was done exactly as described in Example 3. Cells displaying preS1 (21-47)-specific scFv antibodies were isolated essentially as described in Example 4, using Qβ-preS1 (21-47) as a bait. A total of six preS1 (21-47)-specific antibodies were identified: A124, C032, E040, J058, L023 and L025. ScFv-Fc fusion proteins were cloned, expressed and purified as described in Examples 5 and 6. The binding properties of purified scFv-Fc fusion proteins were analyzed by ELISA essentially as described in Example 7. Half-maximal binding was observed at concentrations in the low nanomolar range (A124, 6.9 nM; CO32, 5.6 nM; E040, 1.2-1.9 nM; J058, 7.5 nM; L023, 2.2 nM; and L025, 1.0 nM), suggesting that the antibodies are of high affinity. Antibodies A124, E040, J058, L023, and L025 were converted to whole human IgG2, and expressed and purified as described in Example 9.

### Example 11

### Isolation of Hapten-Specific Human Monoclonal Antibodies

### Anti-Nicotin Antibodies

Peripheral blood mononuclear cells (PBMC) are isolated from 20 ml of heparinized blood of a Qβ-Nicotin-vaccinated volunteer by a standard Ficoll-Hypaque™ Plus (Amersham Biosciences) gradient method. PBMC are stained with: (1) Qβ-Nicotin (4 μg/ml) in combination with a Nicotin-specific mouse mAb and FITC-labeled goat anti-mouse antibody (Jackson ImmunoResearch Laboratories); (2) Alexa 647 nm-labeled Qβ (4 μg/ml); (3) PE-labeled mouse anti-human IgM, IgD, CD14 and CD3 antibodies as described in Example 10; and (4) PE-TexasRed-labeled mouse anti-human CD19 antibody as described in Example 10. After staining, cells are washed, filtered and Nicotin-specific B cells (FL1-positive, FL2-negative, FL3-positive, FL4-negative) are sorted on a FACSVantage SE flow cytometer (Becton Dickinson).

Construction of a Sindbis-based scFv cell surface display library is done exactly as described in Example 3. Cells displaying Nicotin-specific scFv antibodies are isolated essentially as described in Example 4, using Qβ-Nicotin as a bait. Nicotin-specific antibodies are cloned, expressed and purified as described in Examples 5, 6 and 9.

### Example 12

### Isolation of Self Antigen-Specific Human Monoclonal Antibodies

### Anti-Ghrelin Antibodies

Peripheral blood mononuclear cells (PBMC) are isolated from 20 ml of heparinized blood of a Qβ-ghrelin (24-31)-vaccinated volunteer by a standard Ficoll-Hypaque™ Plus (Amersham Biosciences) gradient method. PBMC are stained with: (1) Qβ-ghrelin (24-31) (4 μg/ml) in combination with a Alexa 488 nm-labeled Qβ-specific mouse mAb; (2) Alexa 647 nm-labeled Qβ (4 μg/ml); (3) PE-labeled mouse anti-human IgM, IgD, CD14 and CD3 antibodies as described in Example 10; and (4) PE-TexasRed-labeled mouse anti-human CD19 antibody as described in Example 10. After staining, cells are washed, filtered and ghrelin (24-31)-specific B cells (FL1-positive, FL2-negative, FL3-positive, FL4-negative) are sorted on a FACSVantage SE flow cytometer (Becton Dickinson).

Construction of a Sindbis-based scFv cell surface display library is done exactly as described in Example 3. Cells displaying ghrelin (24-31)-specific scFv antibodies are isolated essentially as described in Example 4, using Qβ-ghrelin (24-31) as a bait. Ghrelin (24-31)-specific antibodies are cloned, expressed and purified as described in Examples 5, 6 and 9.

### Example 13

### Isolation of Allergen-Specific Human Monoclonal Antibodies

### Anti-Fel d1 Antibodies

In principle, Fel d1-specific B cells can be isolated from a cat-allergic individual. Alternatively, Fel d1-specific B cells are isolated from a Fel d1-vaccinated volunteer. Thus, peripheral blood mononuclear cells (PBMC) are isolated from 20 ml of heparinized blood by a standard Ficoll-Hypaque™ Plus (Amersham Biosciences) gradient method. PBMC are stained with: (1) Qβ-Fel d1 (4 μg/ml) in combination with a Alexa 488 nm-labeled Qβ-specific mouse mAb; (2) Alexa 647 nm-labeled Qβ (3 μg/ml); (3) PE-labeled mouse anti-human IgM, IgD, CD14 and CD3 antibodies as described in Example 10; and (4) PE-TexasRed-labeled mouse anti-human CD19 antibody as described in Example 10. After staining, cells arc washed, filtered and Fel d1-specific B cells (FL1-positive, FL2-negative, FL3-positive, FL4-negative) are sorted on a FACSVantage SE flow cytometer (Becton Dickinson).

Construction of a Sindbis-based scFv cell surface display library is done exactly as described in Example 3. Cells displaying Fel d1-specific scFv antibodies are isolated essentially as described in Example 4, using Qβ-Fel d1 as a bait. Fel d1-specific antibodies are cloned, expressed and purified as described in Examples 5, 6 and 9.

1. A method of isolating a cell expressing an antibody specifically binding an antigen of interest, said method comprising the steps of:
(a) selecting from a population of isolated B cells a sub-population of B cells capable of specifically binding said antigen of interest;
(b) generating an alphaviral expression library, wherein each member of said alphaviral expression library encodes an antibody comprising at least one variable region (VR), by
(i) preparing a pool of DNA molecules from said sub-population of B cells, wherein each of said DNA molecules of said pool of DNA molecules encodes one of said at least one variable region (VR); and
(ii) cloning a specimen of said multitude of DNA molecules into an alphaviral expression vector;
(c) introducing said alphaviral expression library into a first population of mammalian cells;
(d) displaying antibodies of said alphaviral expression library on the surface of said mammalian cells; and
(e) isolating from said first population of mammalian cells a cell, capable of specifically binding said antigen of interest or a fragment or antigenic determinant thereof.

2. The method of claim 1, wherein each antibody encoded by said alphaviral expression library further comprises a signal peptide and a transmembrane region.

3. The method of claim 1, wherein said antibody comprises a heavy chain variable region (HCVR) and a light chain variable region (LCVR).

4. The method of claim 1, wherein said generating an alphaviral expression library comprises the steps of:
(a) generating a multitude of DNA molecules encoding antibodies, said generating comprising the steps of:
(i) amplifying from said sub-population of B cells a first pool of DNA molecules encoding HCVRs;
(ii) amplifying from said sub-population of B cells a second pool of DNA molecules encoding LCVRs; and
(iii) linking specimens of said first and of said second pool of DNA molecules to each other by a DNA encoding a linker region (LR);
(b) cloning a specimen of said multitude of DNA molecules into an alphaviral expression vector;
wherein each member of said alphaviral expression library encodes an antibody comprising a signal peptide, a HCVR, a LCVR and a transmembrane region, wherein said HCVR and said LCVR are linked to each other by said linker region.

5. The method of claim 1, wherein said antibody specifically binding said antigen of interest is a single chain antibody.

6. (canceled)

7. The method of claim 1, wherein said preparing a pool of DNA molecules comprises the steps of:
(a) isolating RNA from said sub-population of B cells;
(b) transcribing said RNA to cDNA; and
(c) amplifying from said cDNA a pool of DNA molecules using a mixture of oligonucleotides comprising at least two oligonucleotides capable of amplifying VR coding regions.

8. The method of claim 1, wherein said preparing a pool of DNA molecules comprises the steps of:
(a) isolating RNA from said sub-population of B cells;
(b) transcribing said RNA to cDNA;
(c) amplifying from said cDNA said first pool of DNA molecules using a first mixture of oligonucleotides comprising at least two oligonucleotides capable of amplifying HCVR coding regions;
(d) amplifying from said cDNA said second pool of DNA molecules using a second mixture of oligonucleotides comprising at least two oligonucleotides capable of amplifying LCVR coding regions; and
(e) linking specimens of said first and said second pool of DNA molecules to each other by a DNA encoding said linker region.

9. The method of claim 8 wherein a first part of said linker region is encoded by an oligonucleotide contained in said first mixture of oligonucleotides and wherein a second part of said linker region is encoded by an oligonucleotide contained in said second mixture of oligonucleotides, wherein said oligonucleotide encoding said first part of said linker region and said oligonucleotide encoding said second part of said linker region comprise an overlap to facilitate the linking of members of said first and second pool of DNA molecules.

10. (canceled)

11. (canceled)

12. The method of claim 4, wherein said linker region consists of 5 to 30.

13. The method of claim 4, wherein said linker region comprises SEQ ID NO:107.

14. (canceled)

15. The method of claim 8, wherein said second mixture of oligonucleotides comprises at least two oligonucleotides capable of amplifying kappa LCVR coding regions.

16. The method of claim 8, wherein said second mixture of oligonucleotides comprises at least two oligonucleotides capable of amplifying lambda LCVR coding regions.

17. (canceled)

18. The method of claim 1, wherein each member of said alphaviral expression library encodes an antibody comprising exactly one VR and a transmembrane region.

19. The method of claim 1, wherein said antibody encoded by said alphaviral expression library comprises said HCVR, said LCVR, and said linker region (LR) in the order
LCVR-LR-HCVR.

20. (canceled)

21. The method of claim 1, wherein said cloning a specimen of said multitude of DNA molecules into an alphaviral expression vector comprises the steps of:
(a) generating a DNA construct encoding said antibody comprising a HCVR, a LCVR and a transmembrane region by linking a specimen of said multitude of DNA molecules to a first DNA element encoding said transmembrane region; and
(b) functionally linking said DNA construct to a second DNA element encoding a signal peptide directing said antibody to the secretory pathway.

22. The method of claim 1, wherein said transmembrane region is derived from human PDGFR beta chain.

23. The method of claim 21, wherein said signal peptide is a mouse Ig kappa light chain signal peptide.

24. (canceled)

25. The method of claim 1, wherein said alphaviral expression library is derived from an alphavirus selected from the group of:
(a) Sindbis virus;
(b) Semliki forest virus; and
(c) Venezuelan equine encephalitis virus.

26. The method of claim 1, wherein said alphaviral expression library is derived from Sindbis virus.

27-37. (canceled)

38. The method of claim 1, wherein said selecting from said population of isolated B cells a sub-population of B cells comprises the steps of:
(a) contacting said population of isolated B cells with said antigen of interest or fragment or antigenic determinant thereof, wherein said antigen of interest or fragment or antigenic determinant thereof is labeled with a fluorescence dye; and
(b) separating B cells bound to said antigen of interest or fragment or antigenic determinant thereof by FACS sorting.

39-84. (canceled)
